(19) United States
(12) Patent Application Publication
(10) Pub. No.: US 2007/0239488 A1
(43) Pub. Date: Oct. 11, 2007

(54) Computerized dental patient record

(76) Inventor: Robert DeRosso, Ridgewood, NJ (US)

Correspondence Address: Mr. Walter J. Tencza Jr.;Suite 3, 10 Station Place, Metuchen, NJ, 08840, US

(21) Appl. No.: 11/524,995

(22) Filed: Sep. 21, 2006

Related U.S. Application Data
(60) Provisional application No. 60/744,335, filed on Apr. 5, 2006.

(51) Int. Cl. G06F 19/00

(52) U.S. Cl. 705/3

(57) ABSTRACT

A processor is programmed with computer software that allows an individual to enter dental information for a patient into an interactive device and to store the dental information for the patient in computer memory. A plurality of teeth images, corresponding to a plurality of teeth of the patient, are displayed on a monitor. Status information regarding each of the plurality of teeth images can be entered and can be displayed simultaneously with the teeth images.

### CROSS REFERENCE TO RELATED APPLICATION(S)

The present application claims the priority of U.S. provisional patent application Ser. No. 60/744,335, filing date Apr. 5, 2006, applicant Robert DeRosso.

### FIELD OF THE INVENTION

This invention relates to improved methods and apparatus concerning keeping data for dental patients.

### BACKGROUND OF THE INVENTION

There are various devices known in the prior art for keeping data for dental patients.

### SUMMARY OF THE INVENTION

One embodiment of the present invention, provides an apparatus comprising a processor, a computer memory, a monitor, and an interactive device. The processor is programmed with computer software that allows an individual to enter dental information for a patient into the interactive device and to store the dental information for the patient in the computer memory. The computer software causes the processor to cause the monitor to display a plurality of teeth images corresponding to a plurality of teeth of the patient. The computer software causes the processor to cause the monitor to display status information regarding each of the plurality of teeth images.

In one embodiment, the computer software causes the processor to display a plurality of forms which can be filled out by the patient using the interactive device. The interactive device may include the monitor and a stylus. The processor may be programmed so that the dental information for the patient can be entered by using the stylus in close proximity to the monitor. The status information regarding a particular tooth of the plurality of teeth of the patient can be entered by using the stylus in close proximity to an image of the particular tooth. In one embodiment the computer software causes the processor to cause the monitor to display a plurality of different perspective views of each tooth of a plurality of teeth of the patient.

The present invention, in one embodiment also includes a method comprising entering dental information for a patient into a computer memory by use of an interactive device, using the dental information to display a plurality of teeth images corresponding to a plurality of teeth of the patient, and using the dental information to display status information regarding each of the plurality of teeth images. The status information may be displayed simultaneously with the plurality of teeth images.

One or more embodiments of the present invention provide a computerized dental patient record which allows a user to input notes into a computer memory in script (handwritten form), text and voice. A tablet personal computer can be used to implement the present invention in one or more embodiments.

One embodiment may include a computer program which may be configured as server-client based, web based, web enabled or in any configuration which would facilitate an enterprise (multiple location) configuration. Secure wireless transmission from client to server is enabled.

One or more embodiments of the present invention allow a user to record, organize and archive patient(s) data and images in a simple and reliable manner in a computer memory, while increasing patient safety and a dental clinician's workflow. One or more embodiments provide many protective features for both the dental clinician and a dental patient. The dental clinician may typically include a dentist or a dental hygienist. There may be other users of embodiments of the present invention such as front desk personnel, however, typically they would not have access to entering clinical data. With the use of one or more embodiments of the present invention, the dental clinician is able to enjoy a higher level of confidence while practicing.

Computer software in accordance with one or more embodiments of the present invention can be used for dentistry. The computer software may use the benefits of the tablet personal computer, including Microsoft (trademarked) “ink” or script (handwriting) technology (with a stylus), voice activation, portability and secure wireless transmission. Known as “ink” technology allows writing in script.

Use of one or more embodiments of the present invention results in a decrease in the incidence of malpractice due to unparalleled protection against human error and negligence. An improvement in workflow is also provided as a result of instantaneous creation of accurate and comprehensive casenote entries in ink or text. Easy and editable, accurate recording and display of existing, planned and completed dental work is also provided.

A case note, or casenote, is a written (handwritten or type written) account of a patient visit (in the present application, typically to a dentist's office), a phone conversation, or anything else pertaining to a patient case. With paper charts of the prior art, the dental clinician needs to write each account manually with an actual ink pen. With a processor programmed with computer software (called “Casenote Software”) in accordance with embodiments of the present invention, the user is enabled to input casenotes manually typically on a tablet personal computer with a stylus (in “ink”) or by inputting into a keyboard (“text”) into a status note or “STATNOTE” template system. Typically, a manual case note is where a user enters an entire case note from “scratch”. Status notes or “STATNOTES” in accordance with embodiments of the present invention, are “templated”.

At least three types of status notes or “STATNOTES” may be provided in embodiments of the present invention: (a) a text template, where any additions can be added only in text, (b) an “Ink” template (handwritten or script) (where any additions can be added only by hand directly onto a computer screen or monitor, typically of a tablet personal computer with a stylus using Microsoft's (trademark) “ink” technology, and (c) an “Inkable Note”. An inkable note is a text template where any additions can be added only using “ink” technology with a stylus. Any of the above types of status notes or “STATNOTES” (or case note templates) can be written for the following categories: procedures (typically dental procedures including existing treatment, planned treatment, and completed treatment), anesthesia, prescriptions, and general.

Also please note that there can be many status notes (“STATNOTES”) under any category. To cut down on a “crowding” of STATNOTE titles under a single category (such as the “general” category which are used, for among other reasons, to document a visit when there is no code(s) entered as completed), there is an interface which will allow the user to create their own “category title bars” like the general, prescription and anesthesia title bars, where individual STATNOTE title entries may be categorized. This will serve to organize STATNOTE headers under their respective heading and reduce the crowded appearance which would be seen if all STATNOTE titles were visible at all times.

One or more embodiments of the present invention also provide a means to easily compose multiple treatment plans. A “clone treatment” feature allows the user to “copy” treatment which was present on one or more treatment plans (and will remain the same) to a (new or subsequent) treatment plan which the dental clinician may add different treatment than exists on those previous plans. A means is also provided, in this feature, to “swap” the entry of planned amalgam restorations to composite restorations which occupy the same tooth/teeth and surface(s). A means is also provided to instantly match dentitions/existing dental work entered with that of an individual for purposes of forensic identification. All existing patients in a computer memory or database can be searched.

Access and ease of transfer from any location of all patient information (by authorized personnel) is also provided. One or more embodiments of the present invention also provide the ability to accurately represent permanent, deciduous, mixed, fractured, missing, partially erupted, and impacted dentitions. The user or dental clinician is easily able to convey the previous and pathologies, conditions, defects, injuries and abnormalities of the oral and peri-oral regions via clinical notations/templates and/or draw pathologies directly onto the dentition images (using “ink” technology) or onto any of nine pre-rendered images of the oral and peri-oral anatomy, patient photographs or radiographs. Information may be entered and saved in computer memory prior to a patient visit, during a patient visit, and for the next visit.

The present invention in one or more embodiment also provides the ability to maximize provider (such as a dentist) productivity by allowing users to view a report which shows the provider's future scheduled appointments. This report shows the provider, the procedure, the amount of time and production. If there is a cancellation, this report will automatically display all appointments of that time length (and less) scheduled for a later date, so the clerical personnel can fill in the time slot, in the hopes that the later appointment date will be filled.

The present invention, in one or more embodiments, allows the dental clinician to “paste” an image (such as a radiograph, digital photograph, etc) in-line with a case note. This is extremely advantageous as the user or dental clinician does not have to locate the radiograph in another program or location. This also protects the radiograph/photo from loss or damage.

One or more embodiments of the present invention allow a user to instantly send completed work, including patient/tooth (teeth)/treatment code/provider information, directly to an insurance company for payment. This “transmission” of data occurs as a result of the dental clinician's entry of the treatment as “completed”, directly from the clinic (chairside), thus eliminating the necessity for the (clerical/front desk) extra staff needed to re-enter and send this information. This shall be facilitated as the insurance company, the dental practice, the patient and the provider will be assigned codes which will enable this precise processing.

One or more embodiments of the present invention allow a user to transfer content of a proposed plan to an electronic treatment plan acceptance form for the patient sign and date (using the stylus directly on the screen, which is referred to as using “ink”, but is not “ink” in the conventional sense) to verify their acceptance of the treatment plan and financial obligations. Patients can fill out all health history/HIPAA (Health Insurance Portability and Accountability Act) regulatory forms from a form function of computer software in accordance with the present invention. These forms are then saved in read only format. The user will be able to create any type of form and categorize them under any categories (or titles) they wish. These forms will be located and accessible via a “forms” button, tab or field displayed on a computer monitor.

One or more embodiments of the present invention allow a user to use voice commands and/or dictation to set up patient dentition (all stages and conditions), enter existing and planned dental work, and enter periodontal exam measurements and pathologies. The voice commands and/or dictation can also be used to launch or start computer software for implementing embodiments of the present invention, to navigate through all of the tabs in the computer software, and to select to enter a text note and dictate the contents.

The present invention also allows the user to enter a treatment plan while in another computer software application (such as a digital radiography application) with a super-imposable form of the treatment entry ledger/modules/note pad.

One or more embodiments of the present invention allow the user to customize a dental procedure entry module to streamline treatment entry, to display slanting, rotated and partially erupted dentition, and to view a scheduled amount (in dollars) of work for a provider. A computer software fee association procedure may be provided which automatically displays a cumulative fee total of all scheduled procedures on that provider's schedule, as well as a main schedule. In addition, a memo function may be provided which may remind the user of any important dates at any time in the future such as, a vaccination date, a C.P.R. (Cardio Pulmonary Resuscitation) training re-examination, continuing education credits etc.

A computer software program in accordance with the present invention, may also provide automatic calculation of a dental associate's compensation based upon production. This may be calculated from a pre-associated table where the user will be able to enter the rate of percent of production at which the associate is compensated. This report will be available to the administrator and may also be available to the associate if the administrator chooses.

A computer software program, in accordance with one or more embodiments of the present invention, may also demonstrate “out of order” case note entries when an attempt is made to incorrectly modify the computer server in an attempt to falsify the date of an entry of a case note or notes.

One or more embodiments of the present invention allow the user to easily enter any status of treatment from “Casenote” software into other software applications (without the existence of a formal software code bridge) by means of a super imposable treatment browser.

One or more embodiments of the present invention allow the user to easily enter any treatment into “Casenote” software while viewing other software applications (without the existence of a formal software code bridge) by means of a super imposable treatment entry module.

### BRIEF DESCRIPTION OF THE DRAWINGS

FIG. 1 shows a diagram of an apparatus in accordance with an embodiment of the present invention;

FIG. 2A shows a first image which can be displayed on a monitor of the apparatus of FIG. 1;

FIG. 2B shows a second image which can be displayed on the monitor of the apparatus of FIG. 1;

FIG. 2C shows a third image which can be displayed on the monitor of the apparatus of FIG. 1;

FIG. 2D shows a fourth image which can be displayed on the monitor of the apparatus of FIG. 1;

FIG. 2E shows a fifth image which can be displayed on the monitor of the apparatus of FIG. 1;

FIG. 2F shows a sixth image which can be displayed on the monitor of the apparatus of FIG. 1;

FIG. 2G shows a seventh image which can be displayed on the monitor of the apparatus of FIG. 1;

FIG. 2H shows an eighth image which can be displayed on the monitor of the apparatus of FIG. 1;

FIG. 3A shows a ninth image which can be displayed on a monitor of the apparatus of FIG. 1;

FIG. 3B shows a tenth image which can be displayed on the monitor of the apparatus of FIG. 1;

FIG. 3C shows an eleventh image which can be displayed on the monitor of the apparatus of FIG. 1;

FIG. 3D shows a twelfth image which can be displayed on the monitor of the apparatus of FIG. 1;

FIG. 3E shows a thirteenth image which can be displayed on the monitor of the apparatus of FIG. 1;

FIG. 3F shows a fourteenth image which can be displayed on the monitor of the apparatus of FIG. 1;

FIG. 4A shows a fifteenth image which can be displayed on the monitor of the apparatus of FIG. 1;

FIG. 4B shows an sixteenth image which can be displayed on the monitor of the apparatus of FIG. 1;

FIG. 4C shows a seventeenth image which can be displayed on the monitor of the apparatus of FIG. 1;

FIG. 4D shows an eighteenth image which can be displayed on the monitor of the apparatus of FIG. 1;

FIG. 4E shows a nineteenth image which can be displayed on the monitor of the apparatus of FIG. 1;

FIG. 4F shows an twentieth image which can be displayed on the monitor of the apparatus of FIG. 1;

FIG. 4G shows a twenty-first image which can be displayed on the monitor of the apparatus of FIG. 1;

FIG. 4H shows a twenty-second image which can be displayed on the monitor of the apparatus of FIG. 1;

FIG. 5A shows a twenty-third image which can be displayed on the monitor of the apparatus of FIG. 1;

FIG. 5B shows a twenty-fourth image which can be displayed on the monitor of the apparatus of FIG. 1;

FIG. 5C shows a twenty-fifth image which can be displayed on the monitor of the apparatus of FIG. 1;

FIG. 5D shows a twenty-sixth image which can be displayed on the monitor of the apparatus of FIG. 1;

FIG. 6 shows a flow chart of a method in accordance with an embodiment of the present invention;

FIG. 7A shows a twenty-seventh image which can be displayed on the monitor of the apparatus of FIG. 1;

FIG. 7B shows a twenty-eighth image which can be displayed on the monitor of the apparatus of FIG. 1;

FIG. 7C shows a twenty-ninth image which can be displayed on the monitor of the apparatus of FIG. 1;

FIG. 7D shows a thirtieth image which can be displayed on the monitor of the apparatus of FIG. 1;

FIG. 7E shows a thirty-first image which can be displayed on the monitor of the apparatus of FIG. 1;

FIG. 7F shows a thirty-second image which can be displayed on the monitor of the apparatus of FIG. 1;

FIG. 7G shows a thirty-third image which can be displayed on the monitor of the apparatus of FIG. 1;

FIG. 8A shows a thirty-fourth image which can be displayed on the monitor of the apparatus of FIG. 1;

FIG. 8B shows a thirty-fifth image which can be displayed on the monitor of the apparatus of FIG. 1;

FIG. 8C shows a thirty-sixth image which can be displayed on the monitor of the apparatus of FIG. 1;

FIG. 8D shows a thirty-seventh image which can be displayed on the monitor of the apparatus of FIG. 1;

FIG. 8E shows a thirty-eighth image which can be displayed on the monitor of the apparatus of FIG. 1;

FIG. 9A shows a thirty-ninth image which can be displayed on the monitor of the apparatus of FIG. 1;

FIG. 9B shows a fortieth image which can be displayed on the monitor of the apparatus of FIG. 1;

FIG. 9C shows a forty-first image which can be displayed on the monitor of the apparatus of FIG. 1;

FIG. 9D shows a forty-second image which can be displayed on the monitor of the apparatus of FIG. 1;

FIG. 10A shows part of a flow chart of a method in accordance with an embodiment of the present invention;

FIG. 10B shows part of a flow chart of a method in accordance with an embodiment of the present invention;

FIG. 10C shows part of a flow chart of a method in accordance with an embodiment of the present invention;

FIG. 10D shows part of a flow chart of a method in accordance with an embodiment of the present invention;

FIG. 11A shows a forty-third image which can be displayed on the monitor of the apparatus of FIG. 1;

FIG. 11B shows a forty-forth image which can be displayed on the monitor of the apparatus of FIG. 1;

FIG. 11C shows a forty-fifth image which can be displayed on the monitor of the apparatus of FIG. 1;

FIG. 11D shows a forty-sixth image which can be displayed on the monitor of the apparatus of FIG. 1;

FIG. 11E shows a forty-seventh image which can be displayed on the monitor of the apparatus of FIG. 1;

FIG. 11F shows a forty-eighth image which can be displayed on the monitor of the apparatus of FIG. 1;

FIG. 11G shows a forty-ninth image which can be displayed on the monitor of the apparatus of FIG. 1;

FIG. 11H shows a fiftieth image which can be displayed on the monitor of the apparatus of FIG. 1;

FIG. 11I shows a fifty-first image which can be displayed on the monitor of the apparatus of FIG. 1;

FIG. 12A shows a fifty-second image which can be displayed on the monitor of the apparatus of FIG. 1; and

FIG. 12B shows a fifty-third image which can be displayed on the monitor of the apparatus of FIG. 1.

### DETAILED DESCRIPTION OF THE DRAWINGS

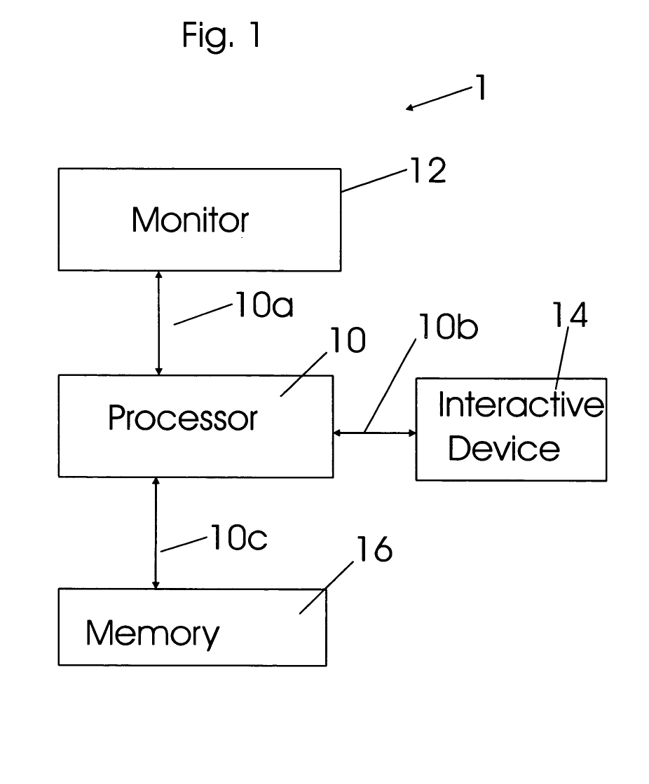

FIG. 1 shows a diagram of an apparatus 1 in accordance with an embodiment of the present invention. The apparatus 1 includes a processor 10, a monitor or display 12, an interactive device 14, and a memory 16. The monitor 12, interactive device 14, and the memory 16 are connected by communications lines 10a, 10b, and 10c to the processor 10.

The processor 10 may be a personal computer such as a tablet personal computer. The memory 16 may be computer memory which may be part of the personal computer. The monitor or display 12 may be a monitor for the personal computer. The monitor 12 may include a screen for displaying information. The interactive device 14 may include a keyboard, computer mouse, a stylus, a computer screen, or any other interactive device for inputting data into a computer. The interactive device 14 may include the monitor 12, such as a monitor of a tablet personal computer.

The processor 10 may be comprised of a plurality of processors such as a plurality of personal computers connected in a network. The monitor 12 may be comprised of a plurality of monitors. The interactive device 14 may be comprised of a plurality of interactive devices. The memory 16 may be comprised of a plurality of computer memories.

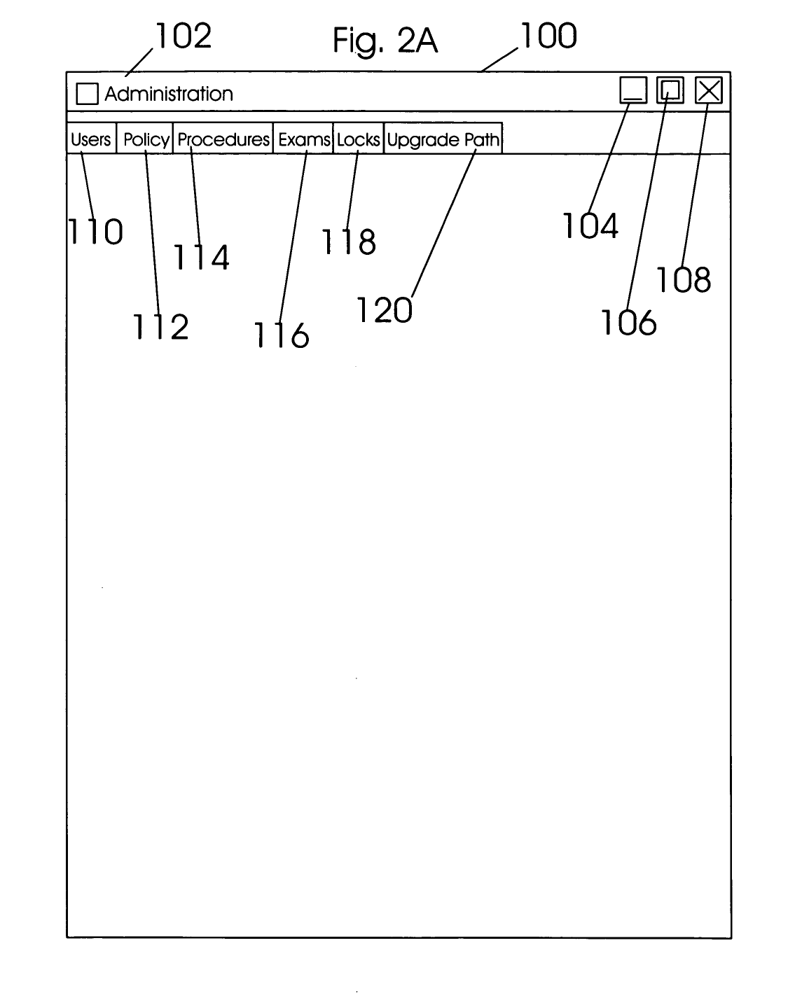

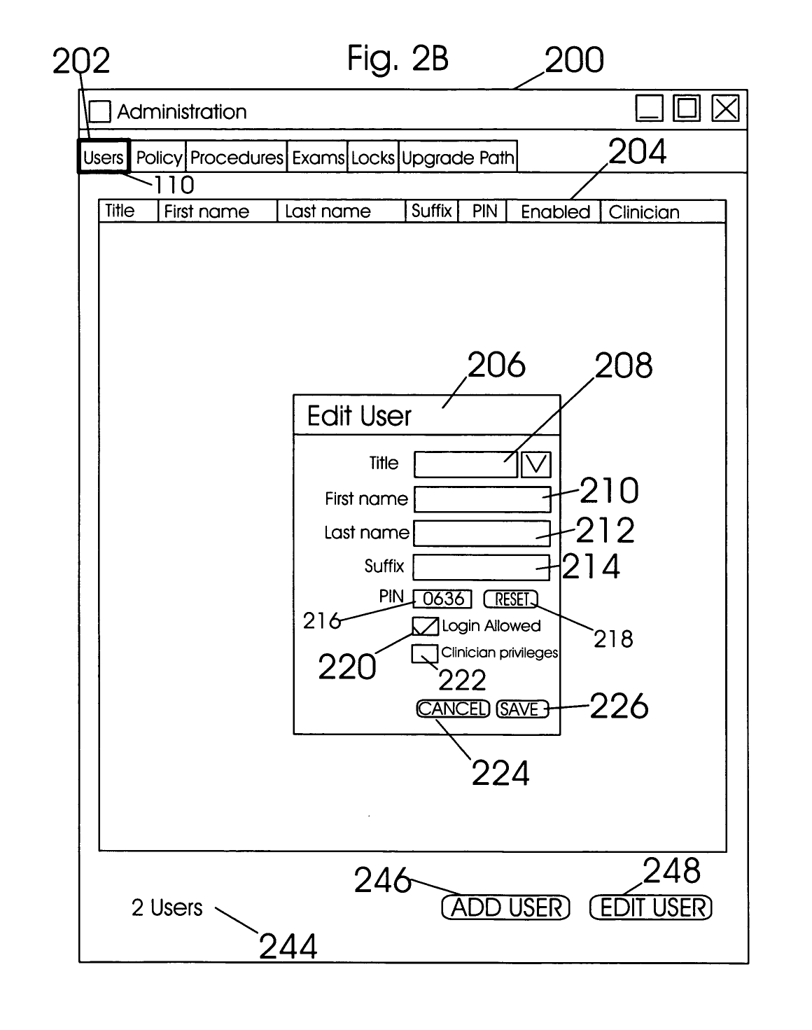

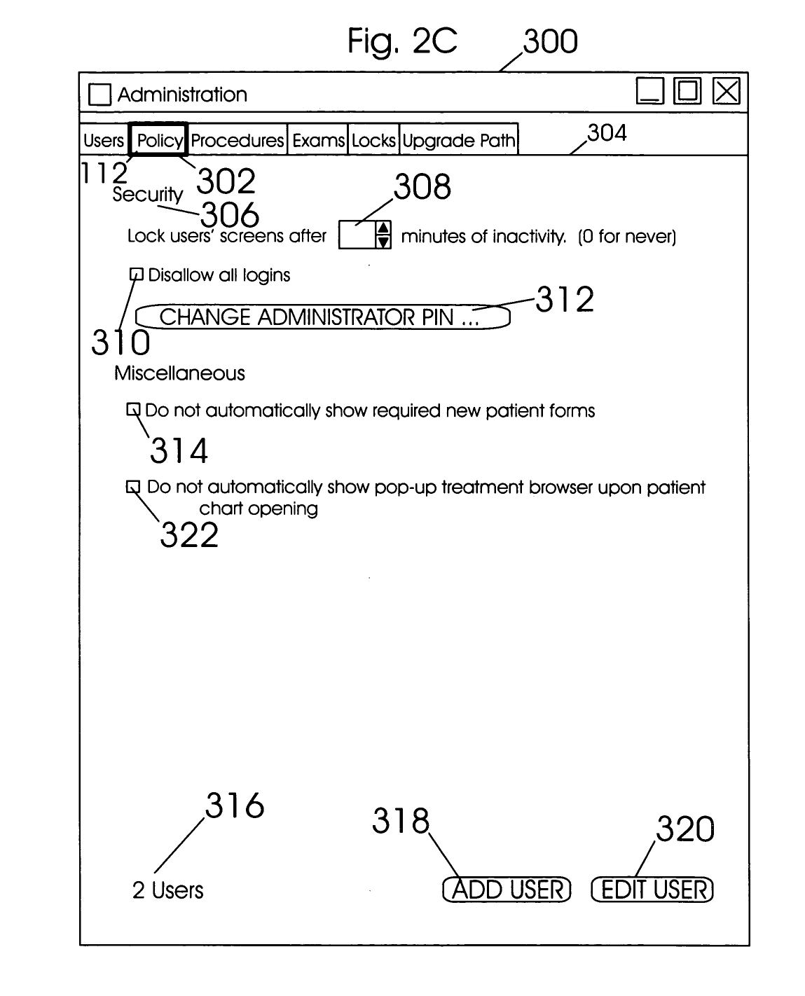

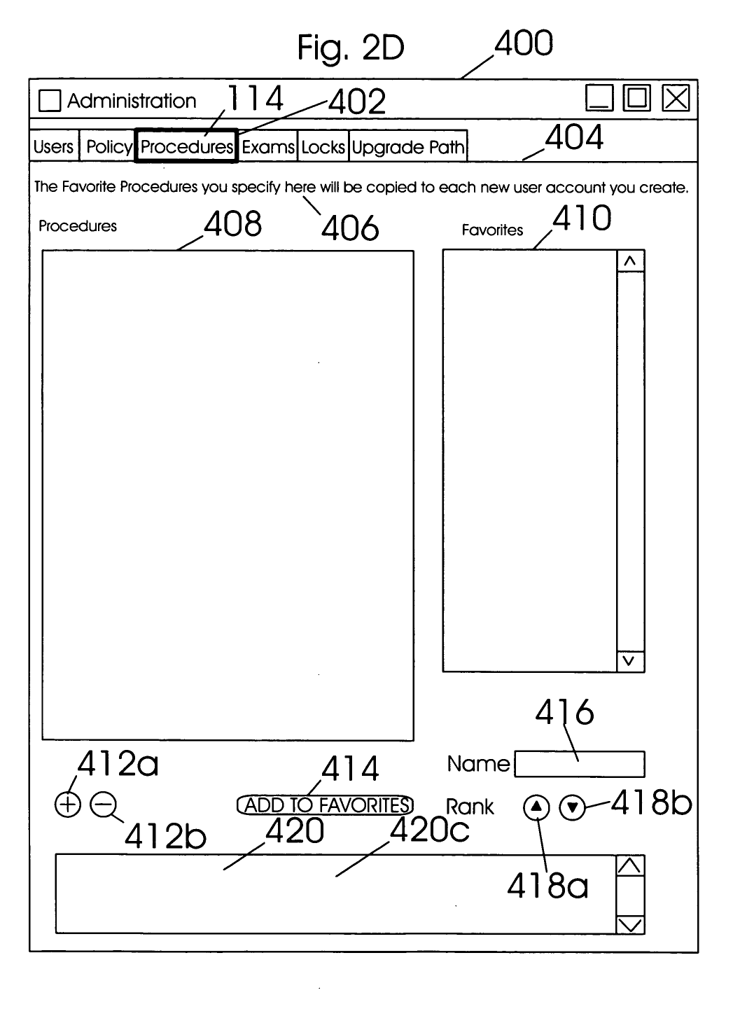

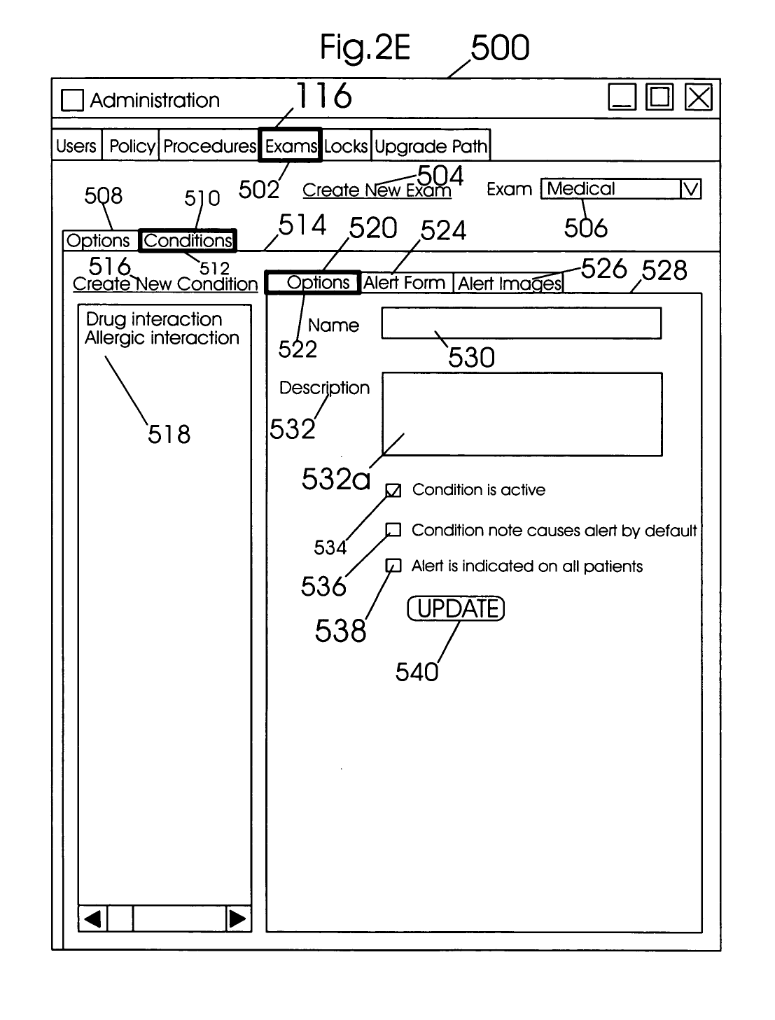

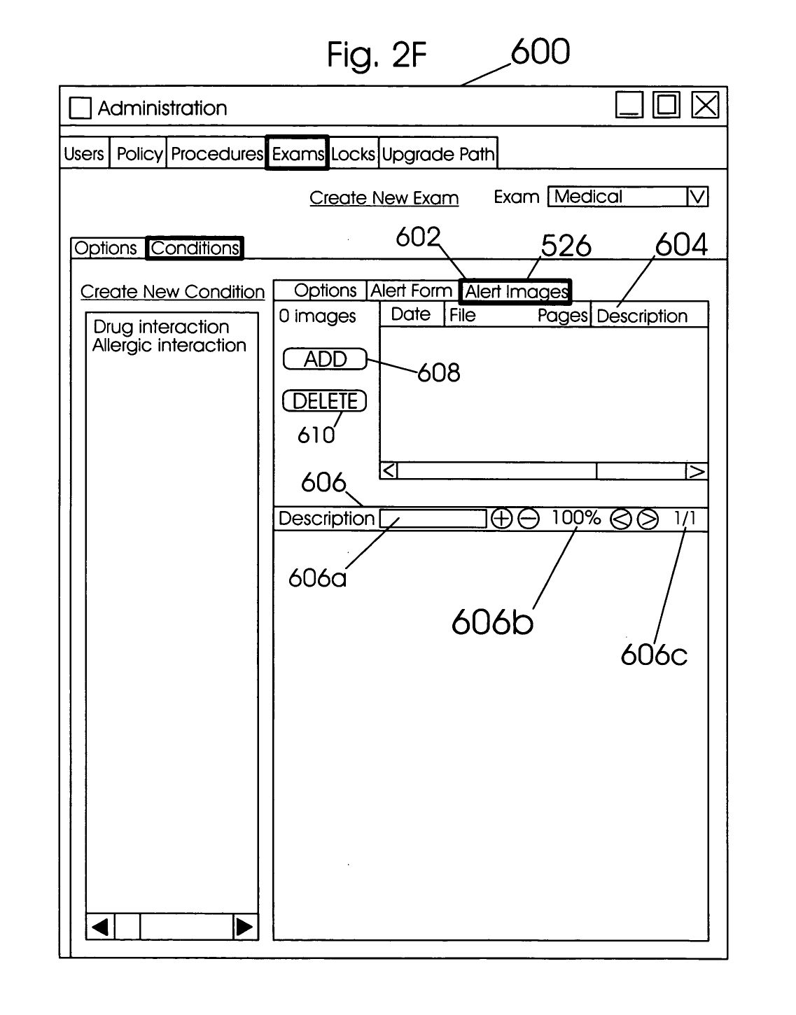

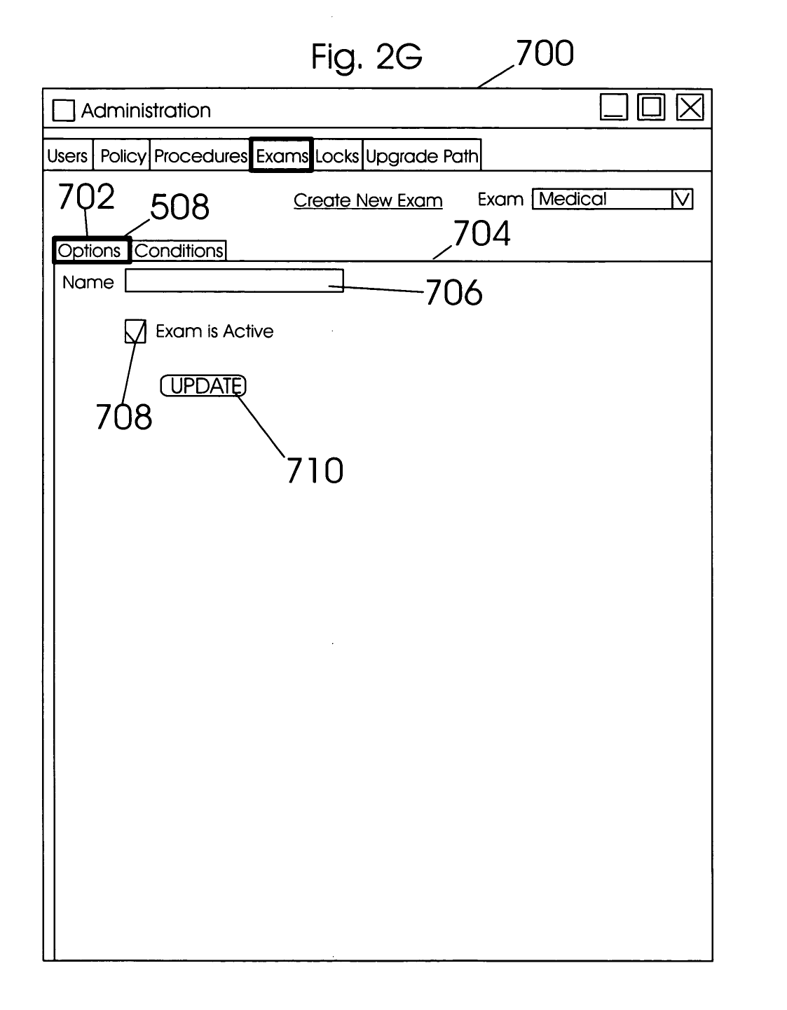

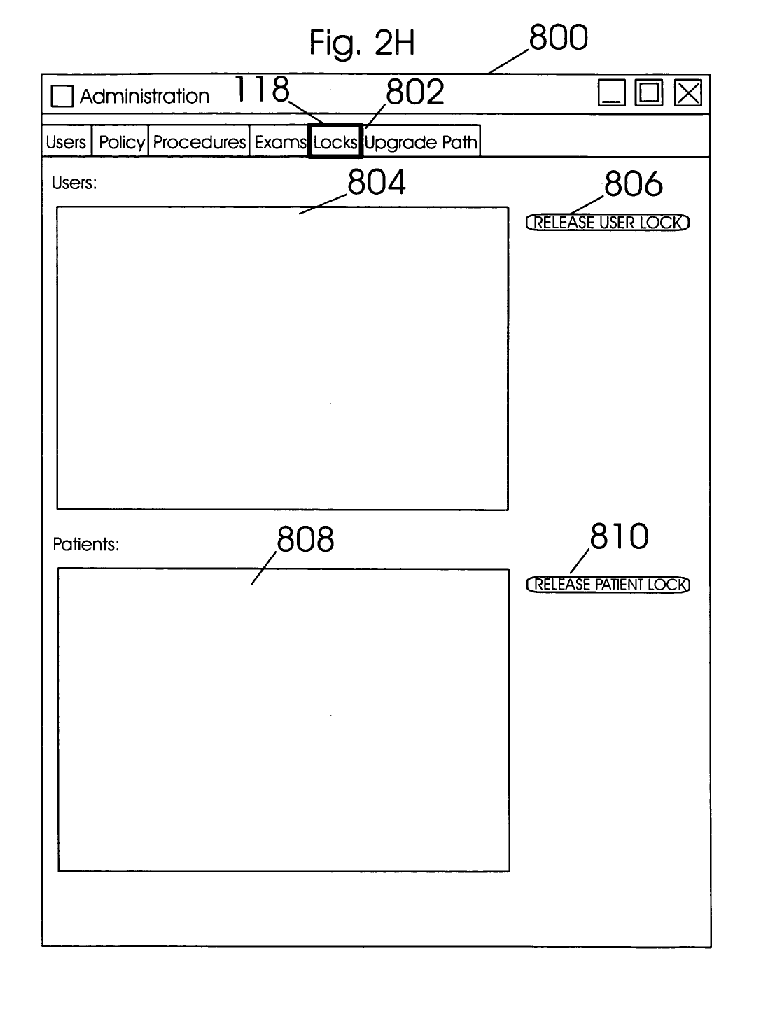

FIGS. 2A-2H show images which can be displayed on a computer screen of the monitor 12 of the apparatus 1 of FIG. 1. The images of FIGS. 2A-2H are displayed by a dental computer software program typically running on the processor 10. The images shown in FIGS. 2A-2H relate to administration of a dental computer software program in accordance with an embodiment of the present invention.

FIG. 2A shows an image 100 which includes text 102 specifying that this screen or image relates to “Administration”. The image 100 also includes fields 104, 106, and 108 which are typically Windows (trademarked) fields allowing a user to minimize, maximize and close, respectively, the image or window 100. The image 100 also includes fields or tabs 110, 112, 114, 116, 118, and 120 in accordance with the dental computer software program of an embodiment of the present invention.

Fields 110, 112, 114, 116, 118, and 120 relate to “Users”, “Policy”, “Procedures”, “Exams”, “Locks”, and “Upgrade Path” (an Audit Tracker which allows the administrator to track all users' log-ins, log-outs and every request in between). Each action will be supplemented by the time requested and the amount of time in that destination, respectively. The purposes of fields 110, 112, 114, 116, 118, and 120 will be described more fully below.

An individual operator can use the interactive device 14 of FIG. 1, to pull up the administration image 100 shown in FIG. 2A. The operator or user may then select one of the fields 110, 112, 114, 116, 118, or 120. For example, the operator may select field 110 “Users”. FIG. 2B shows an image 200. The image 200 includes a thick, dark outer periphery, or highlight 202, surrounding the field 110 “Users” to show that the field 110 has been selected. Upon selection of the field 110, the processor 10 causes a window 204, text 244, and buttons 246 and 248 to appear on the screen of the monitor 12.

The window 204 includes headings for title, first name, last name, suffix, PIN (personal identification number), and clinician. The clinician may be a dentist, dental hygienist, dental assistant, or clerical front desk staff member. Clinician or user data will typically appear underneath the headings after the data has been entered into an “Edit User” window 206. The window 206 includes field or drop down menu 208 for entering a title or clicking on a title via a drop-down menu, field 210 for entering a first name, field 212 for entering a last name, field 214 for entering a suffix (or the suffix can be entered via a drop down menu), and a field 216 to display a randomly assigned PIN (personal identification number). The window 206 also includes button 218 for resetting the P.I.N. number), button 224 for canceling the creation of the new user, and button 226 for saving the new user creation and settings. Buttons 218, 224, and 226 can be clicked on using a computer mouse of the interactive device 14 or tapped on with a stylus of a tablet personal computer.

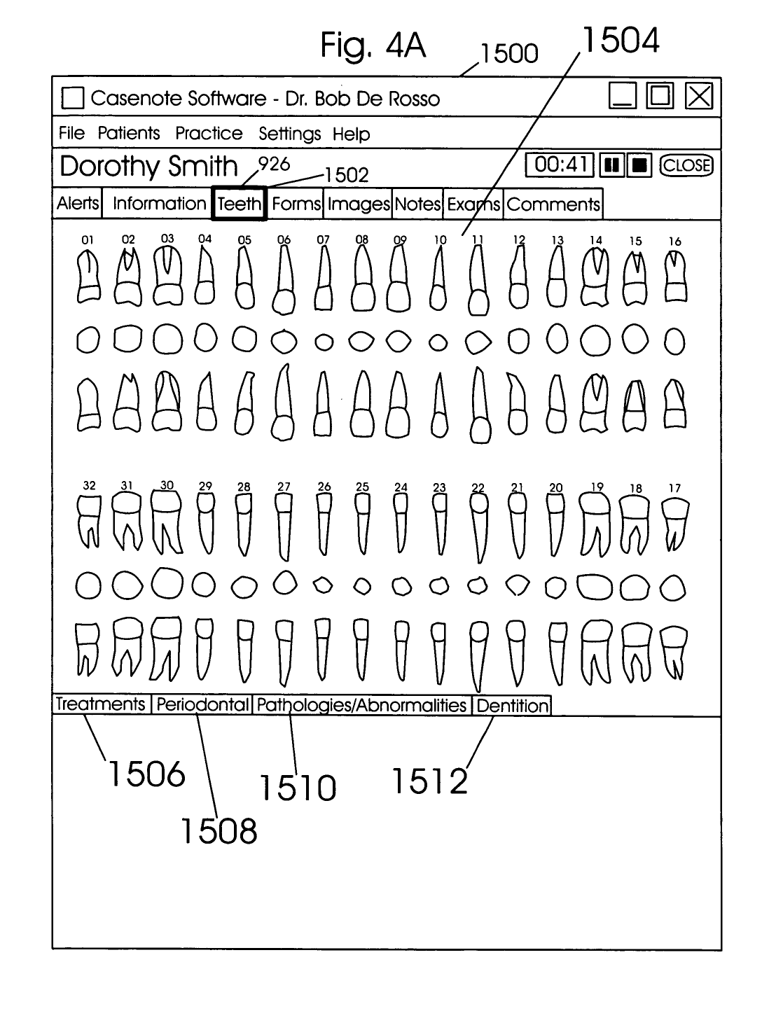

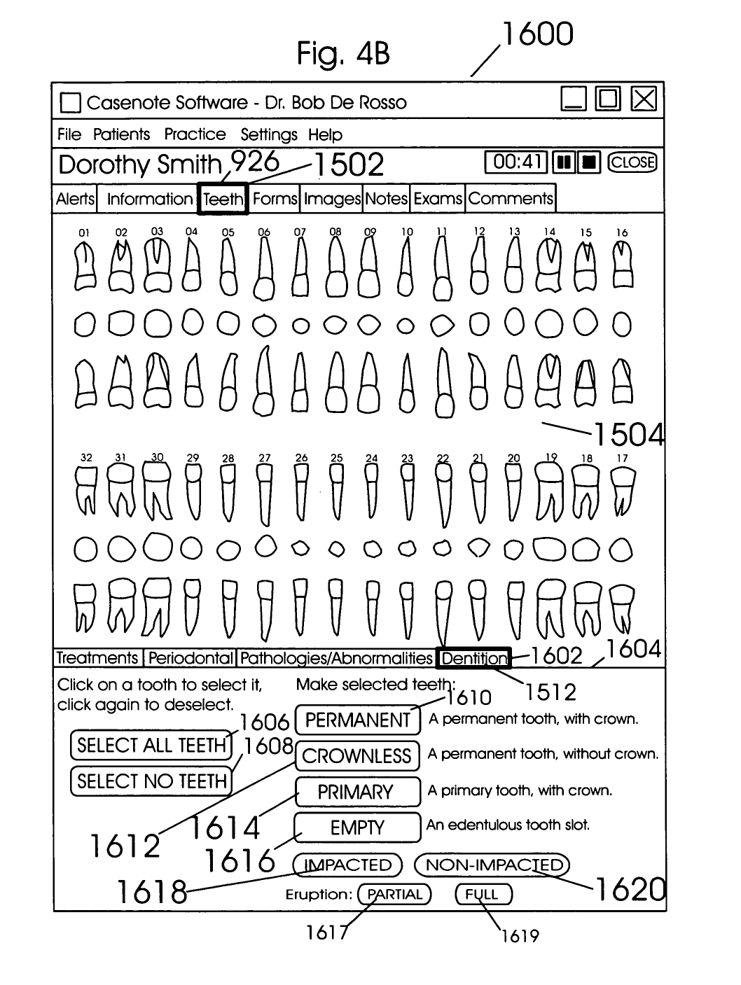

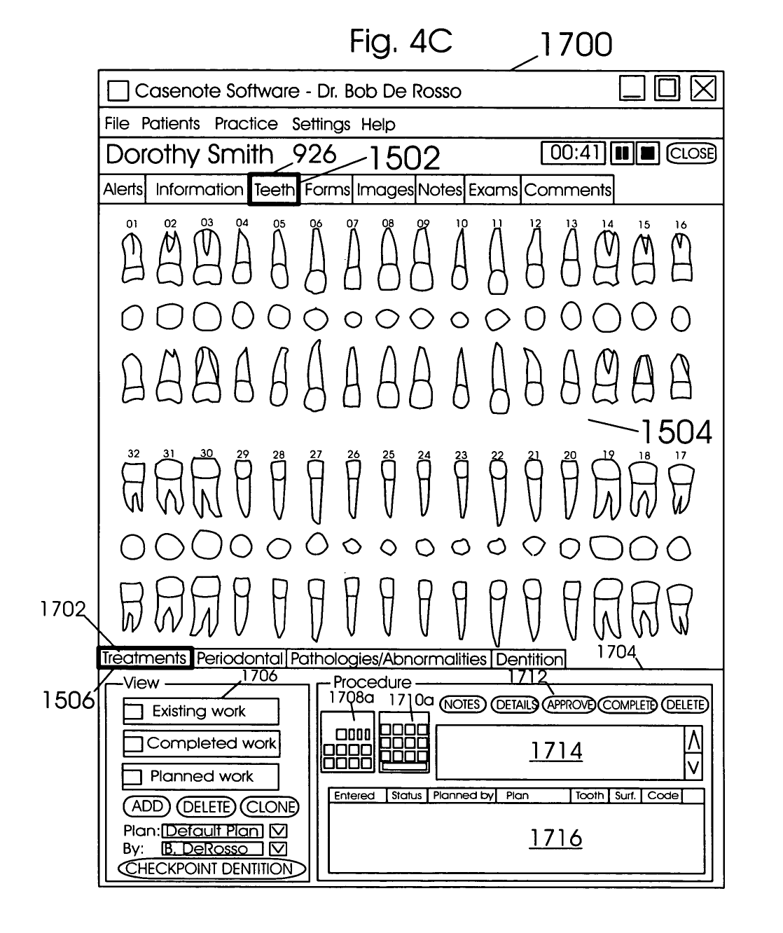

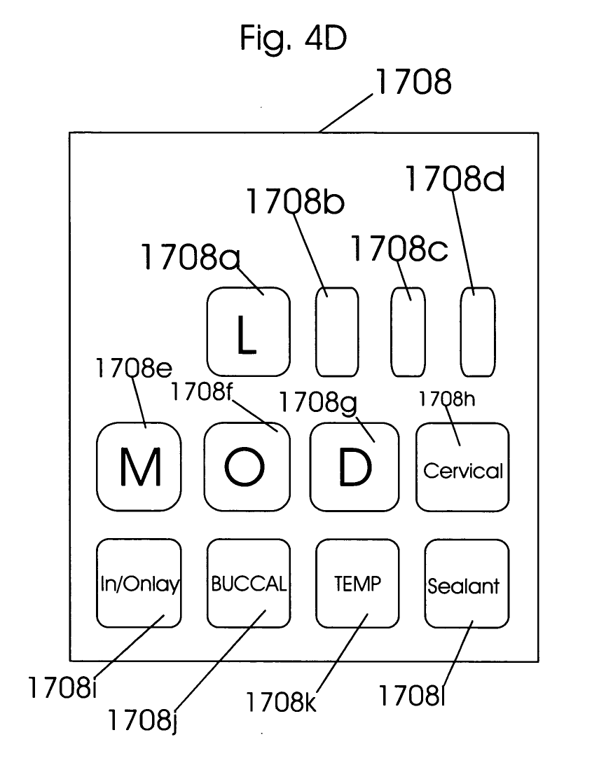

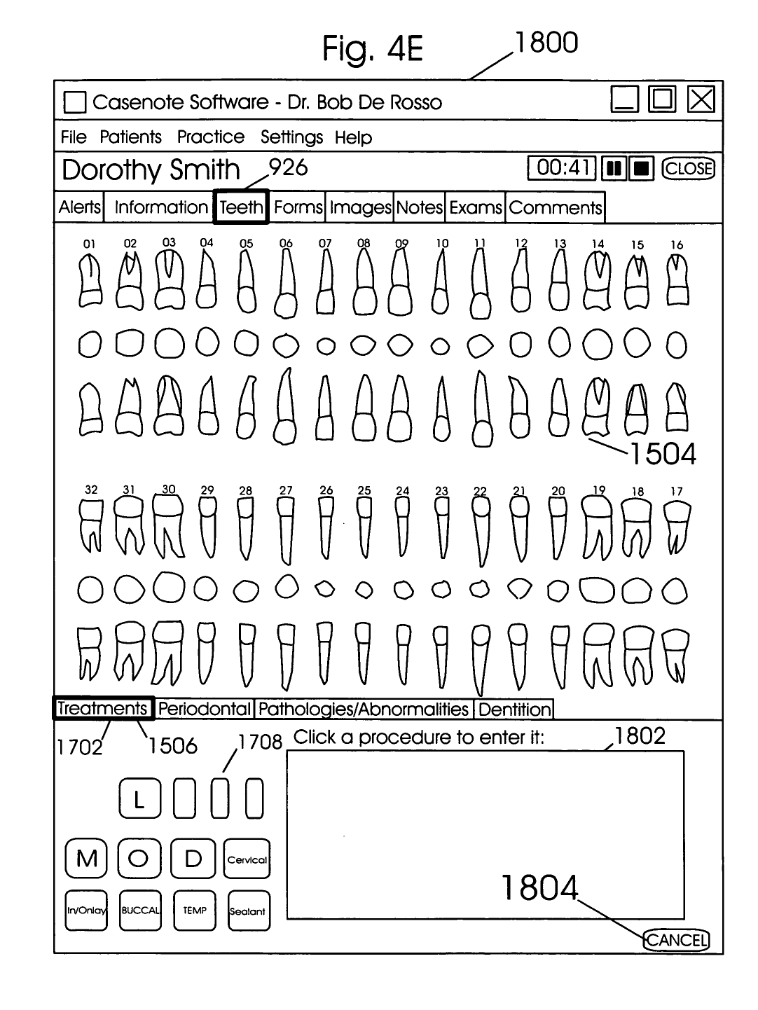

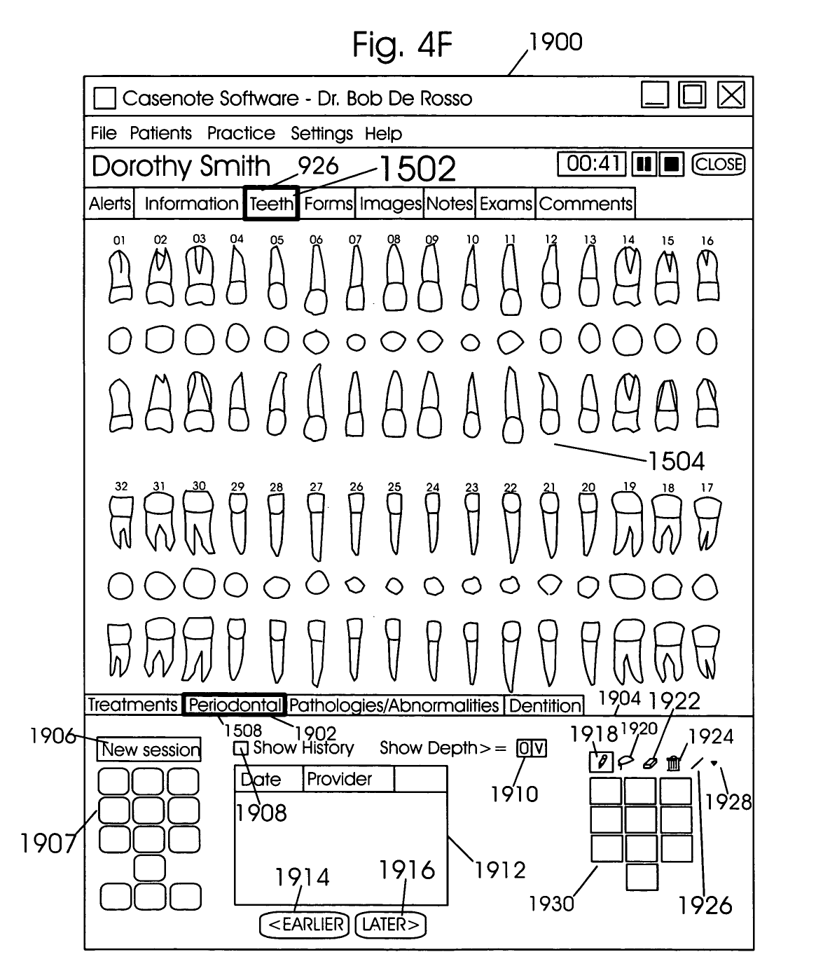

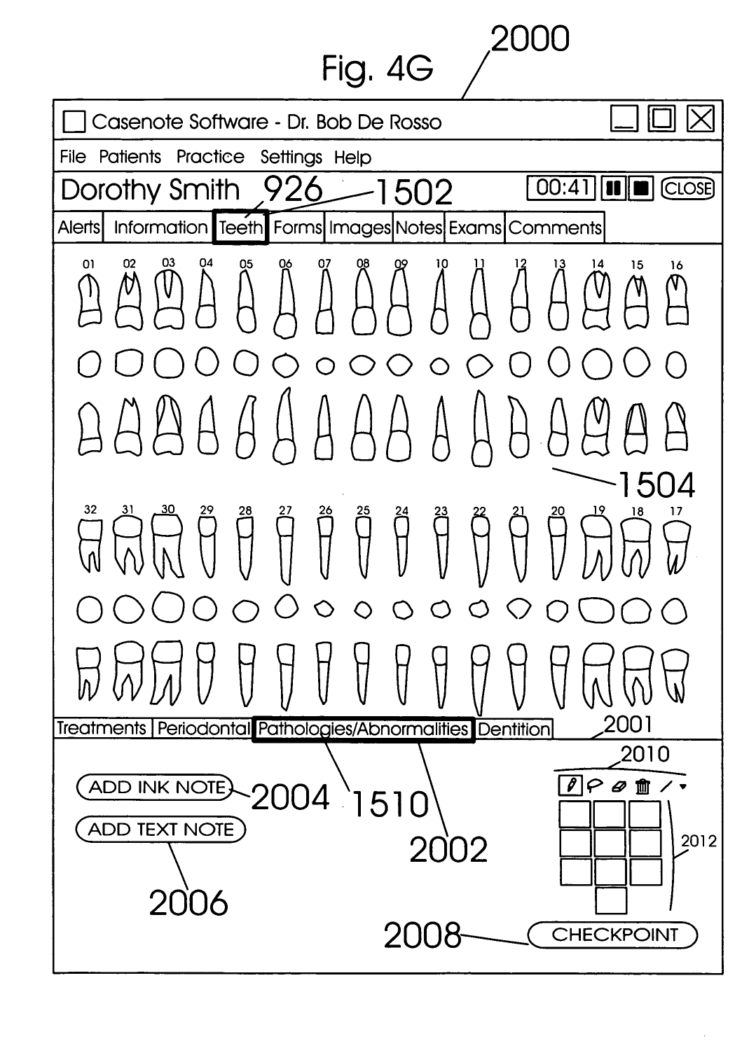

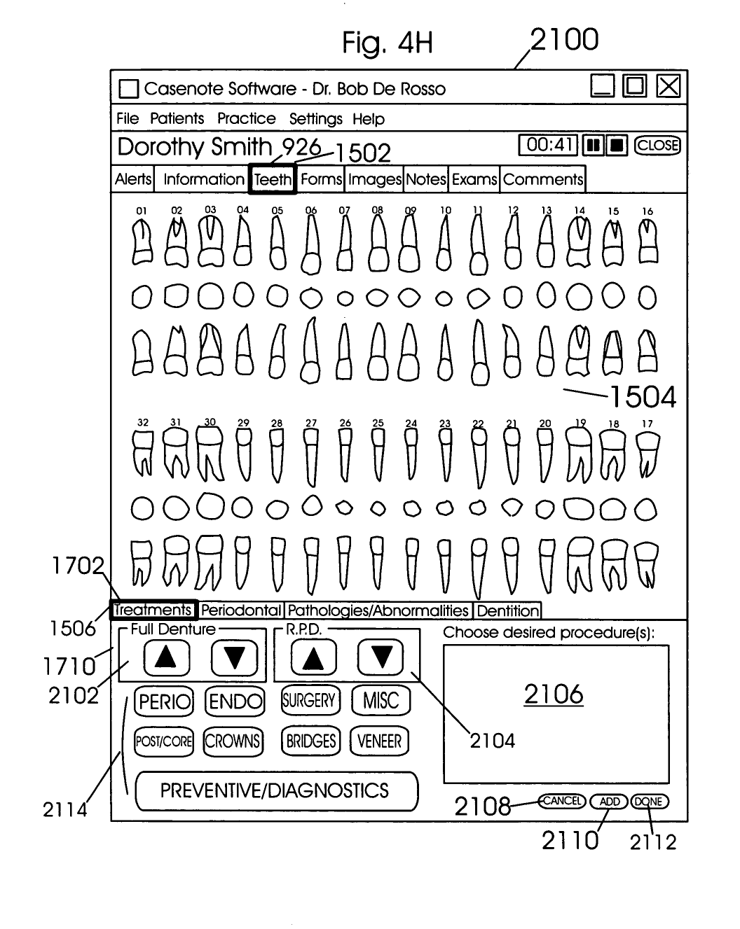

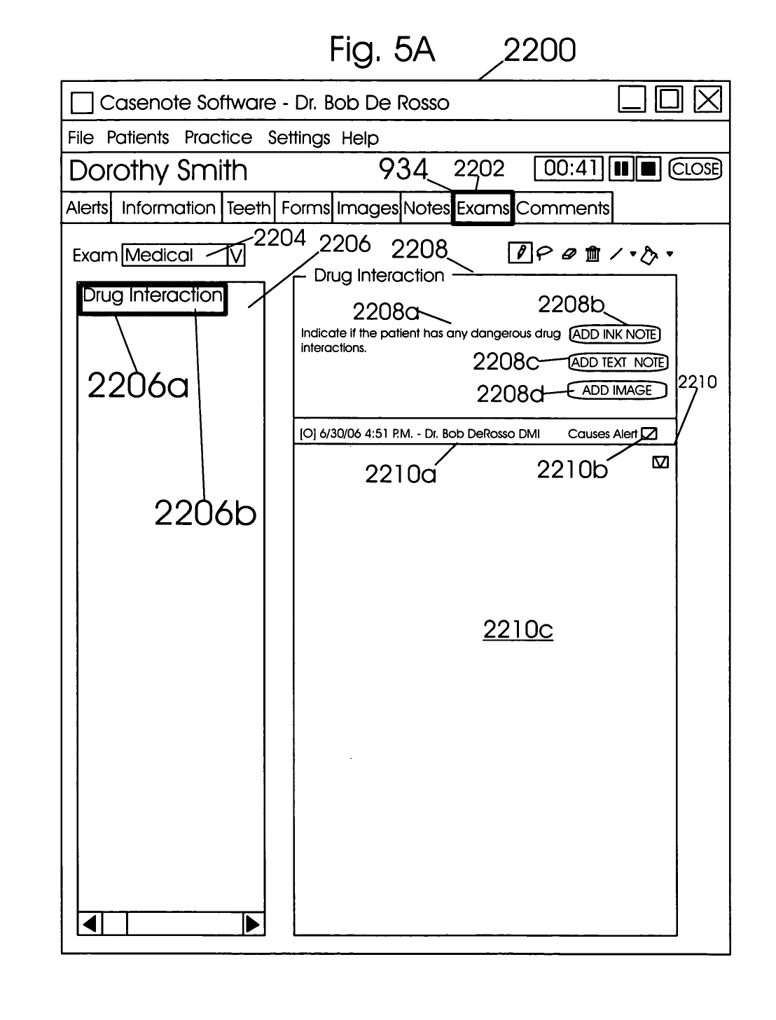

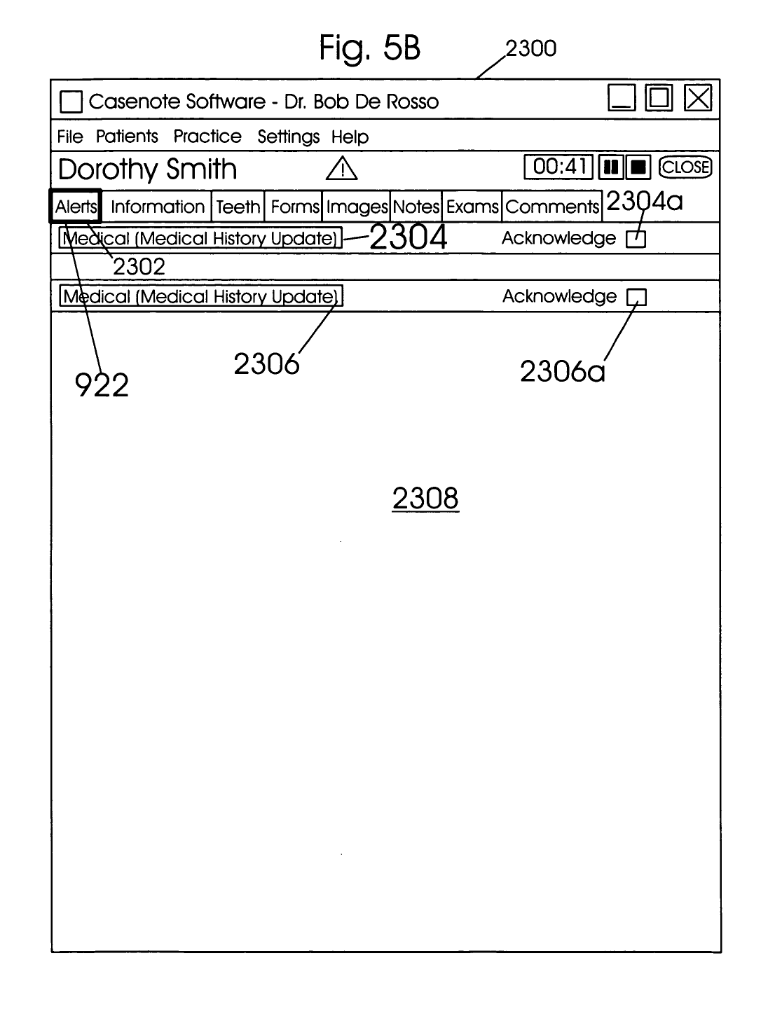

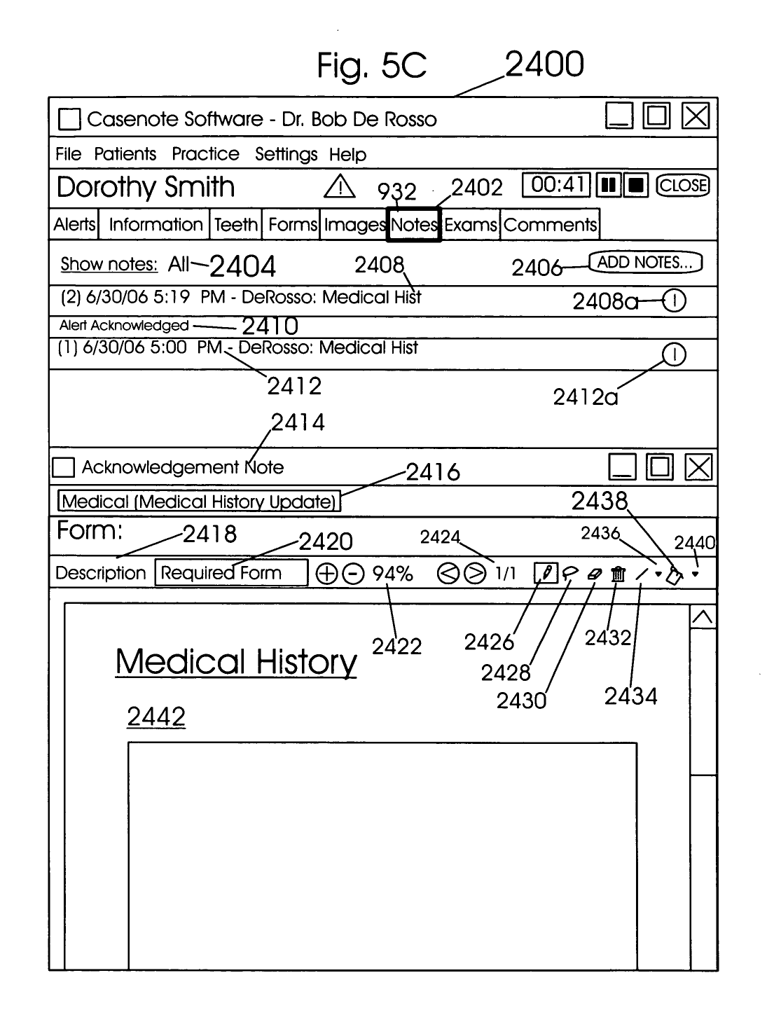

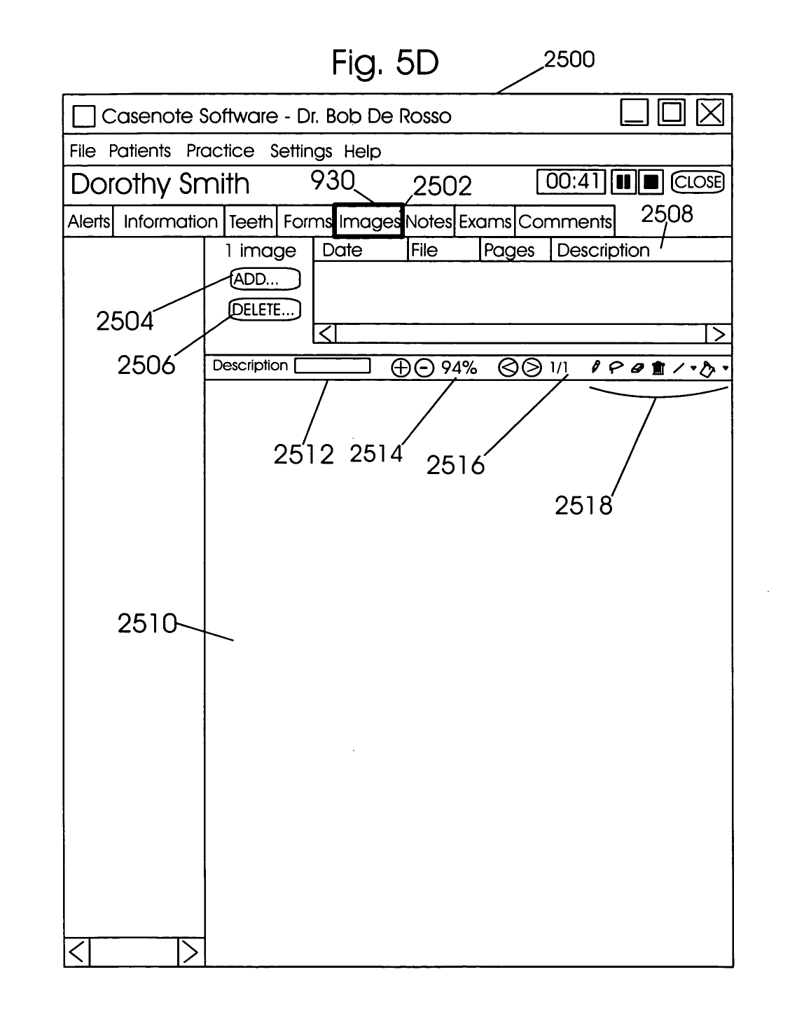

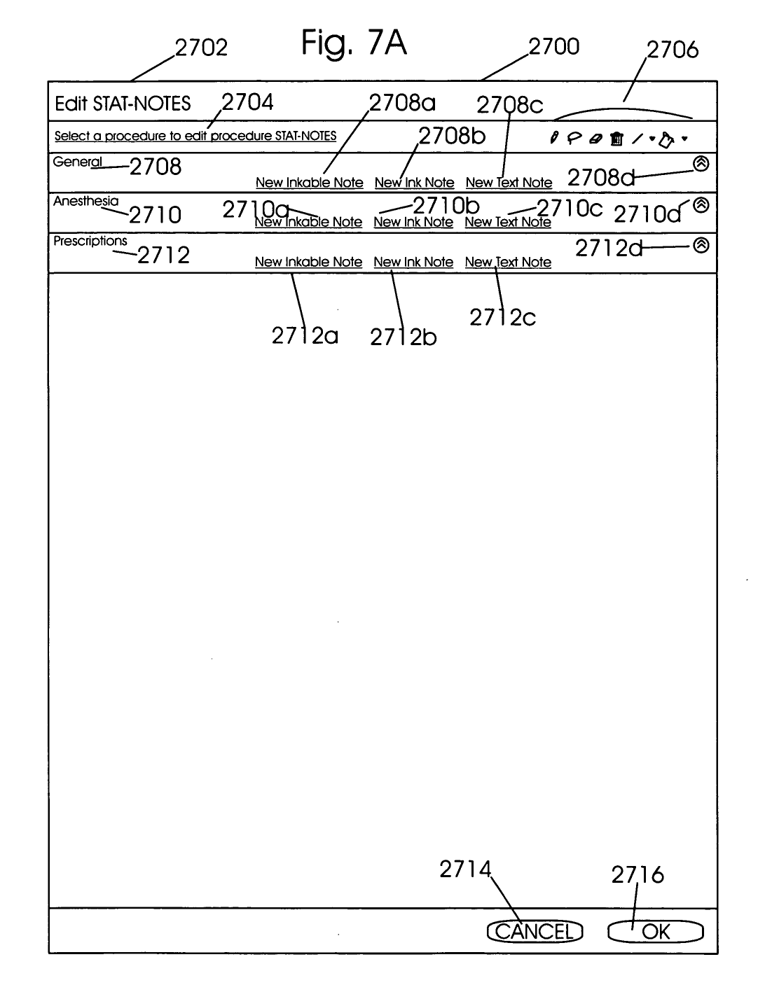

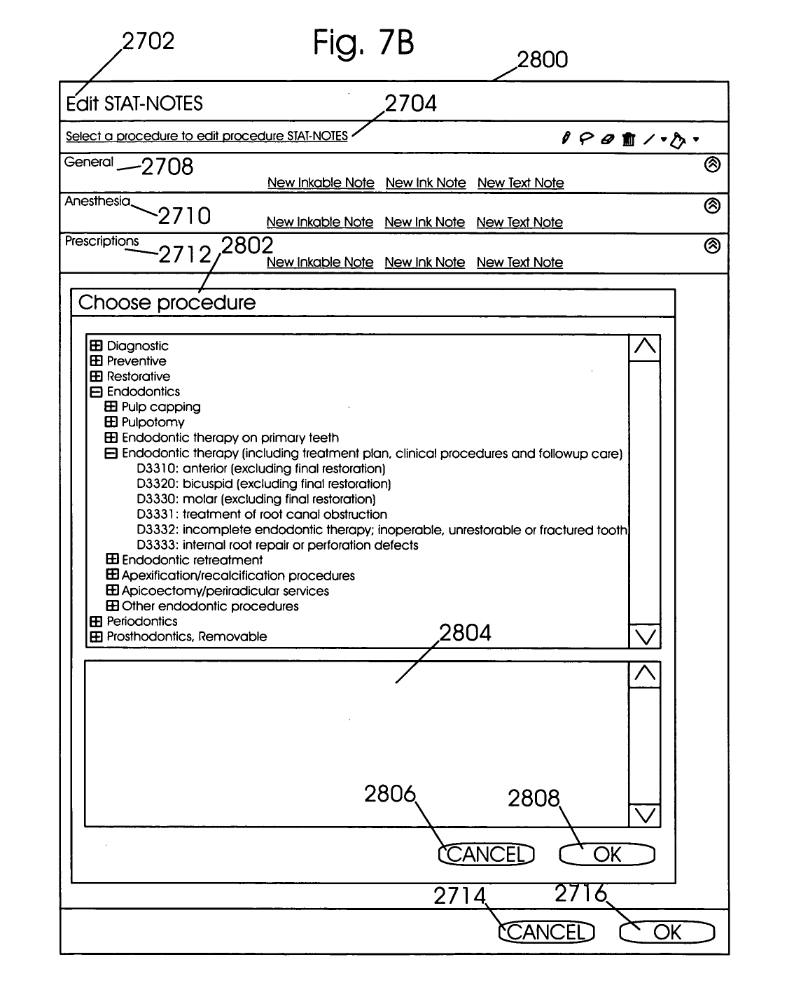

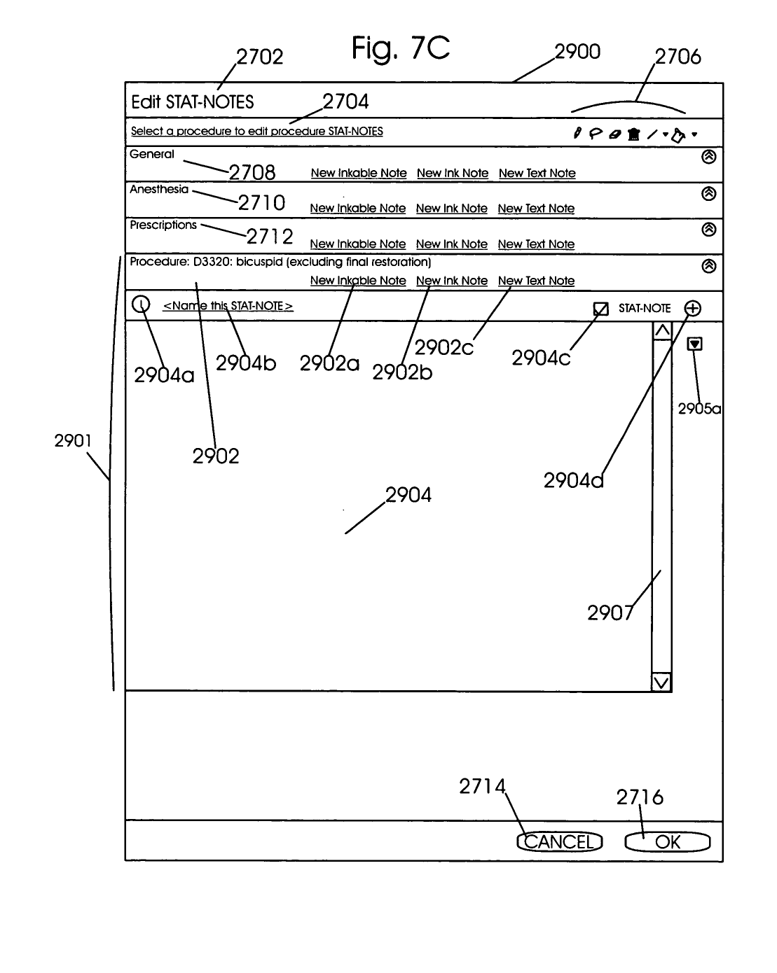

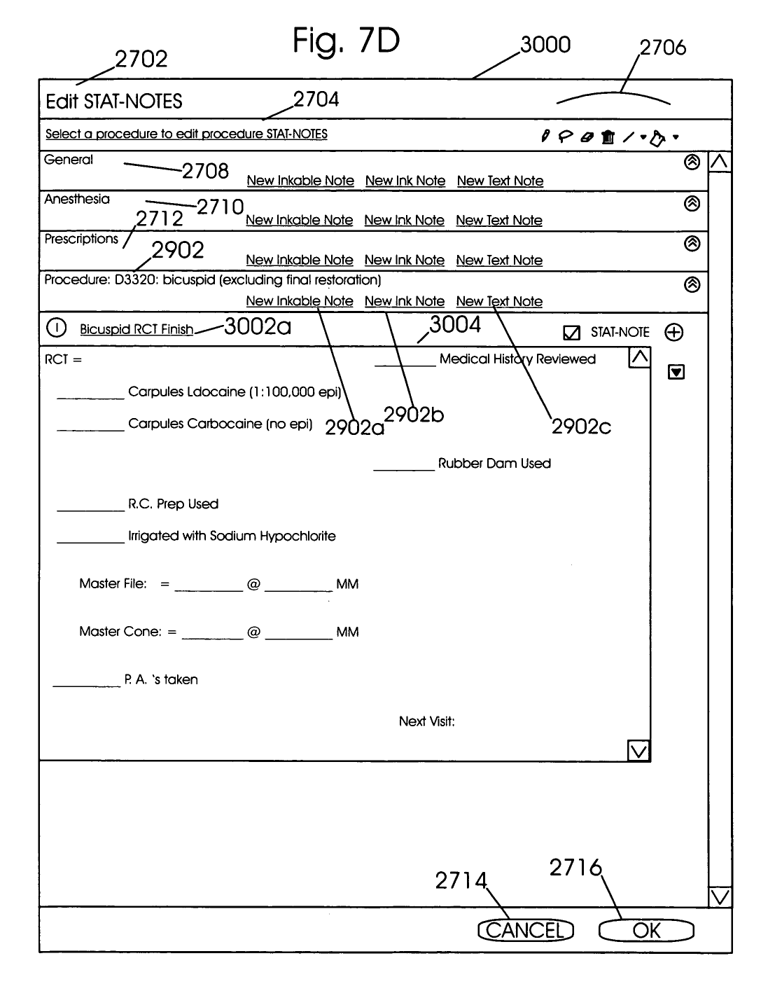

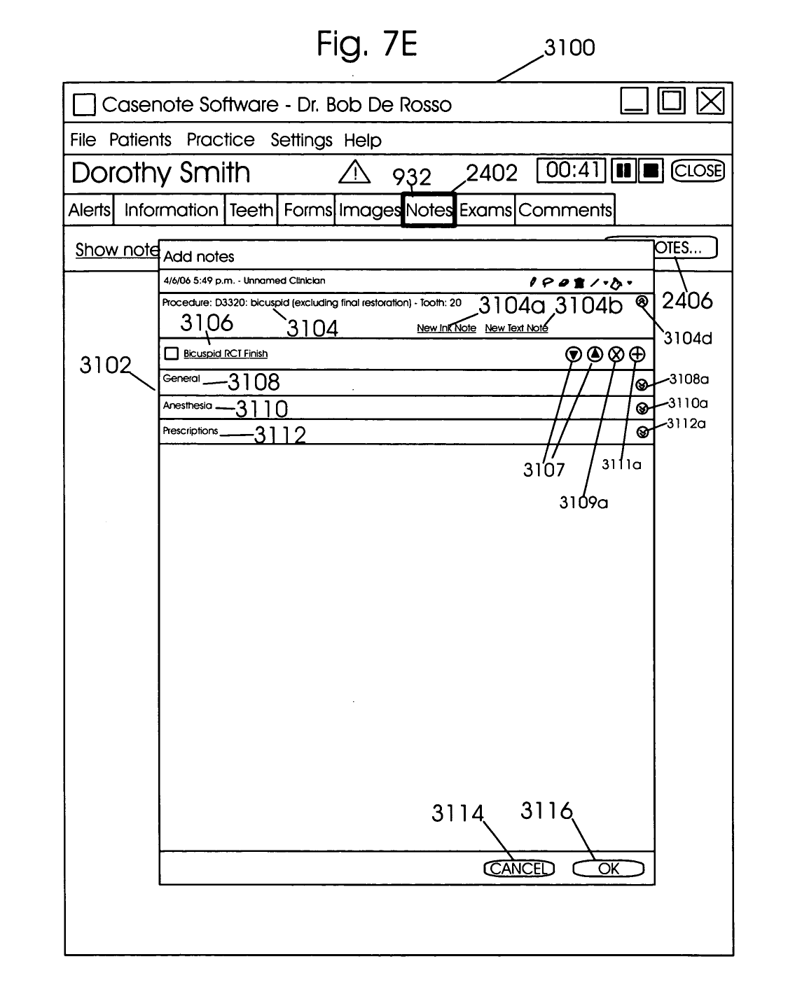

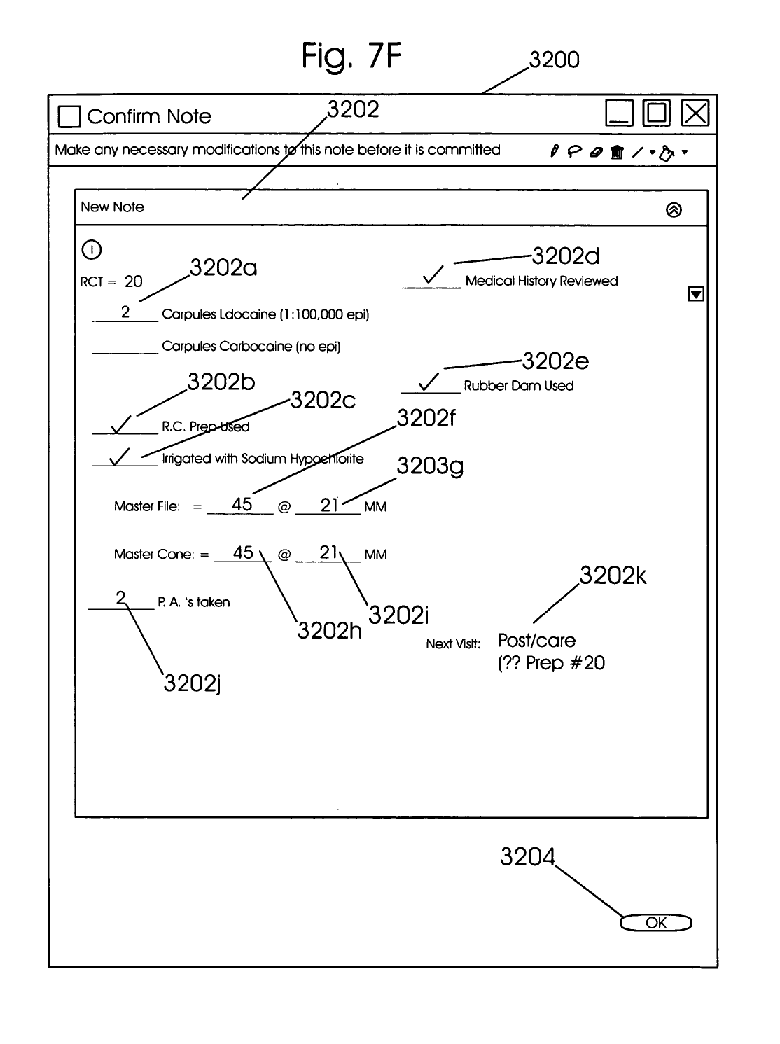

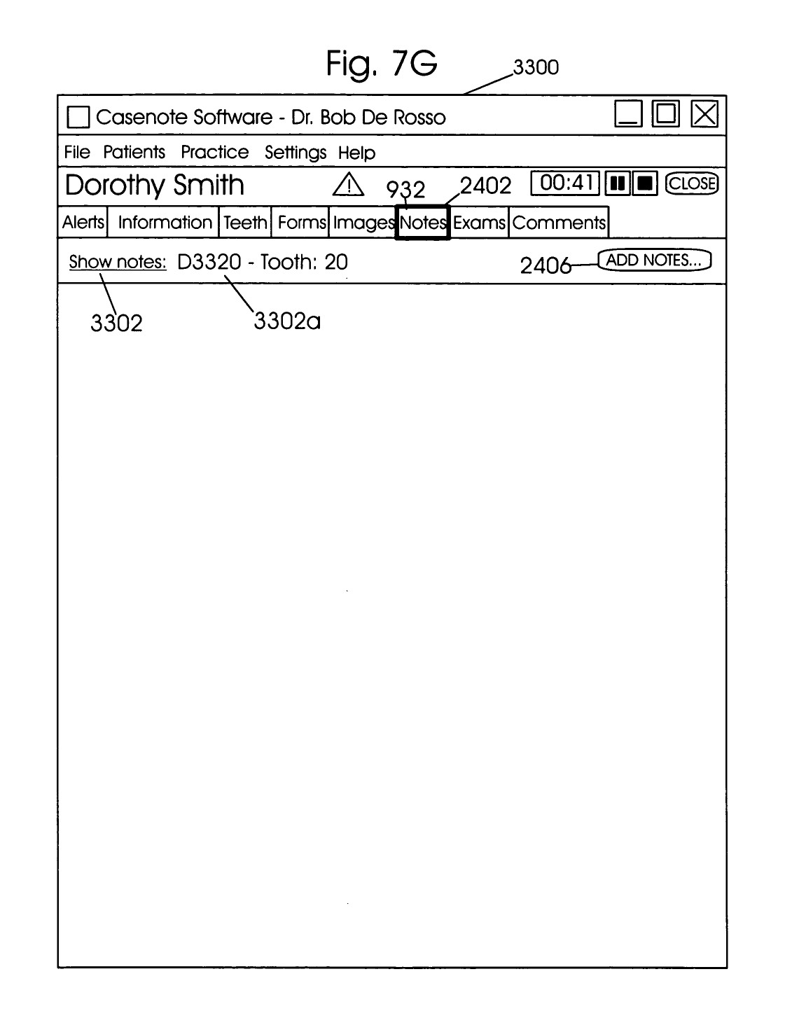

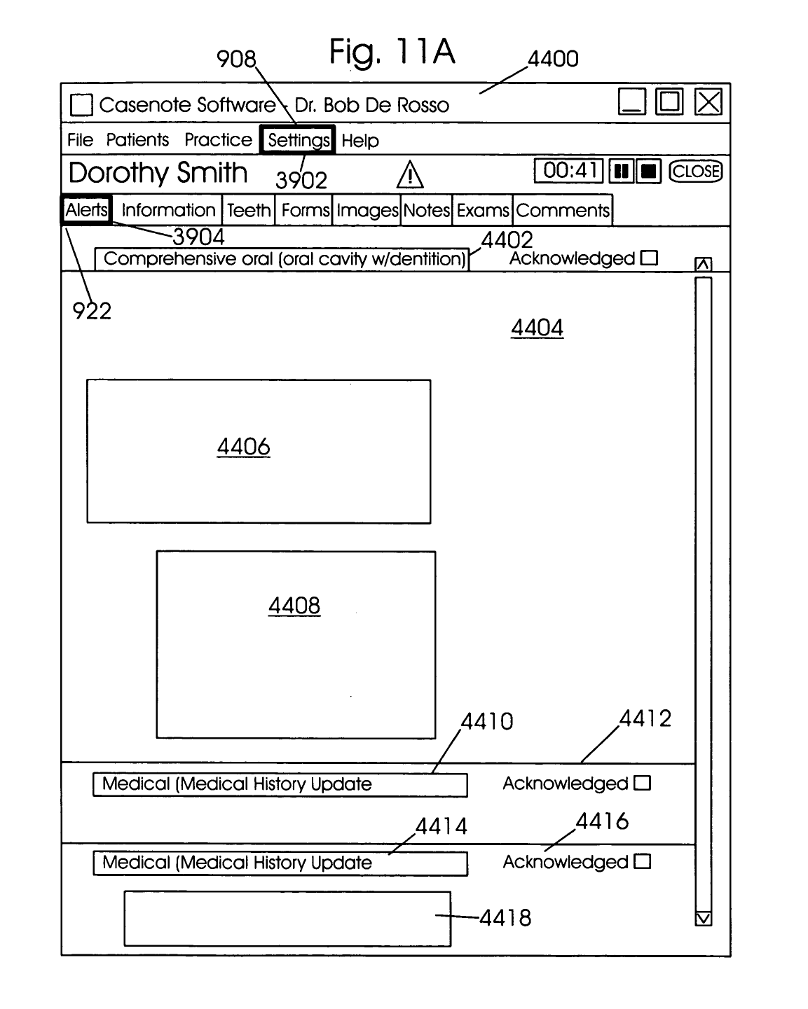

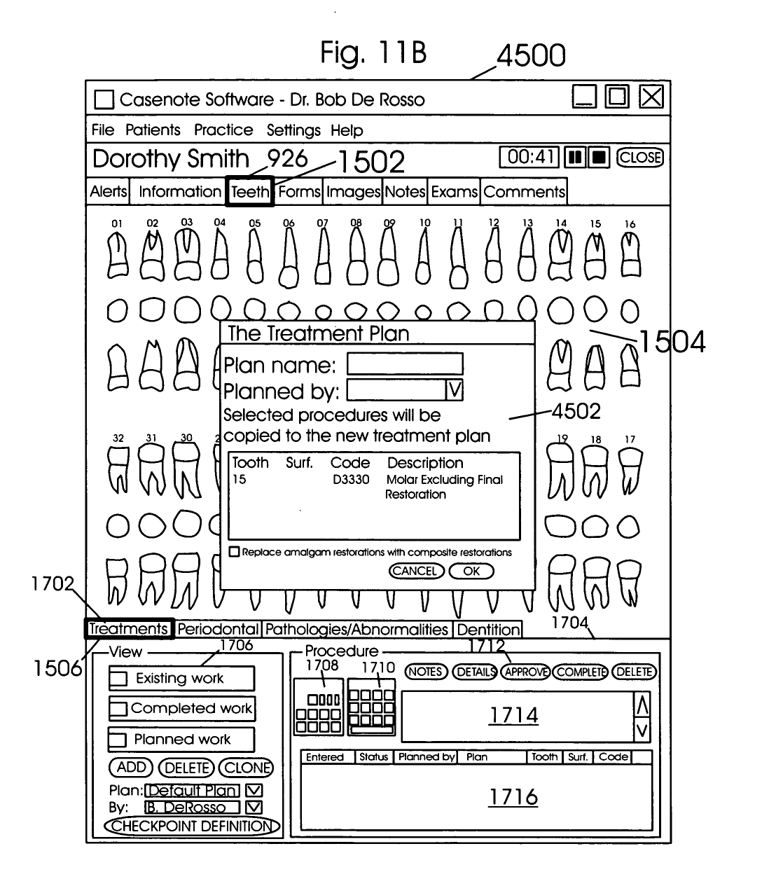

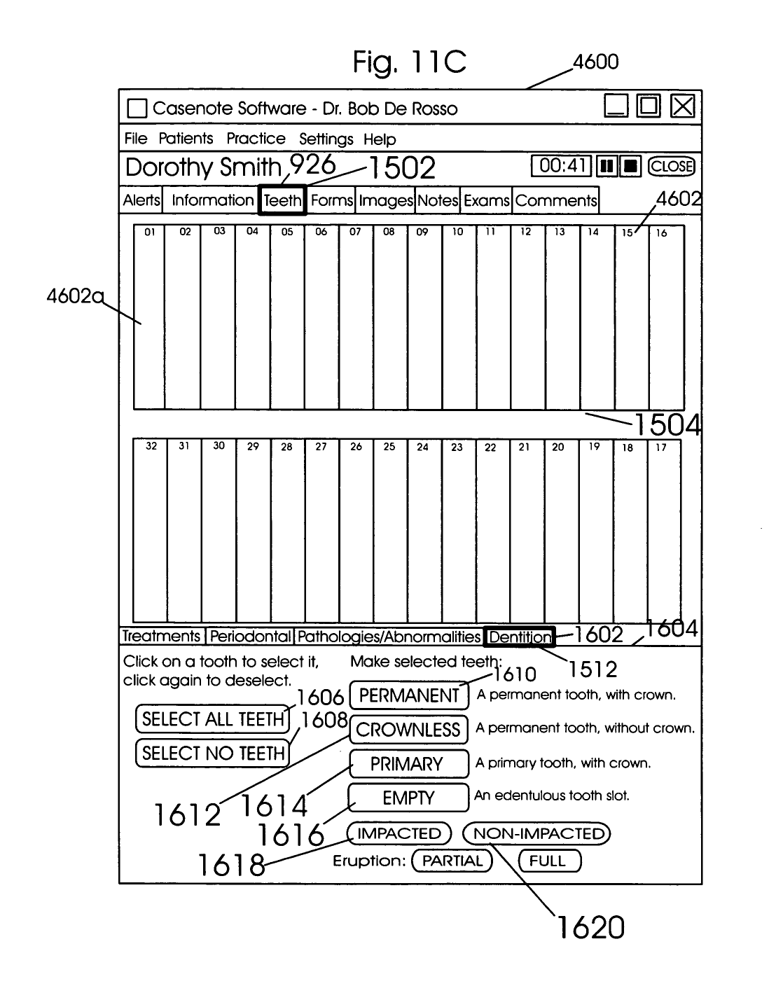

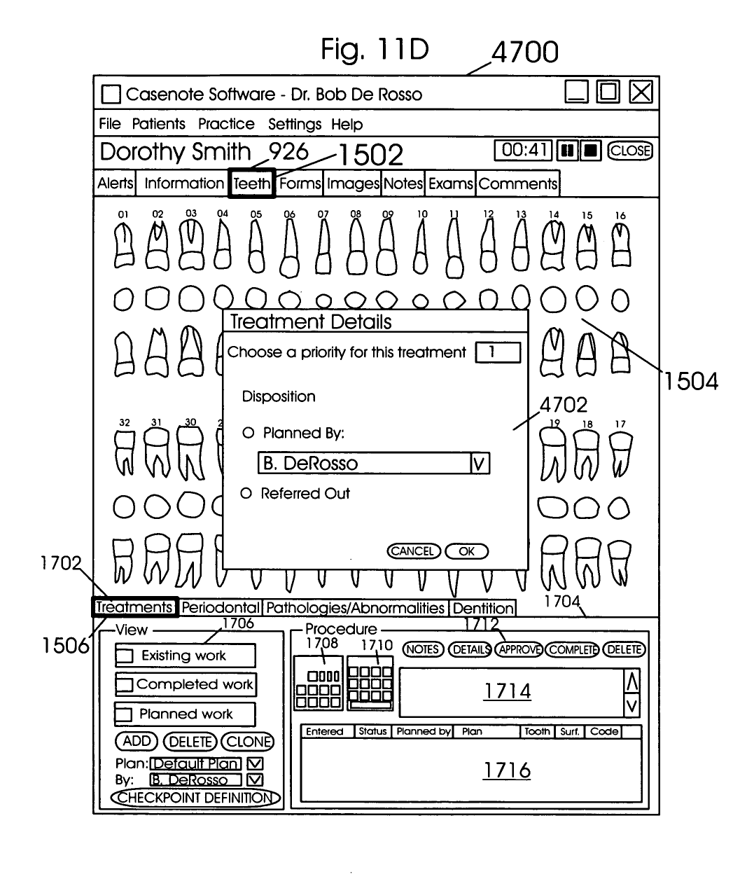

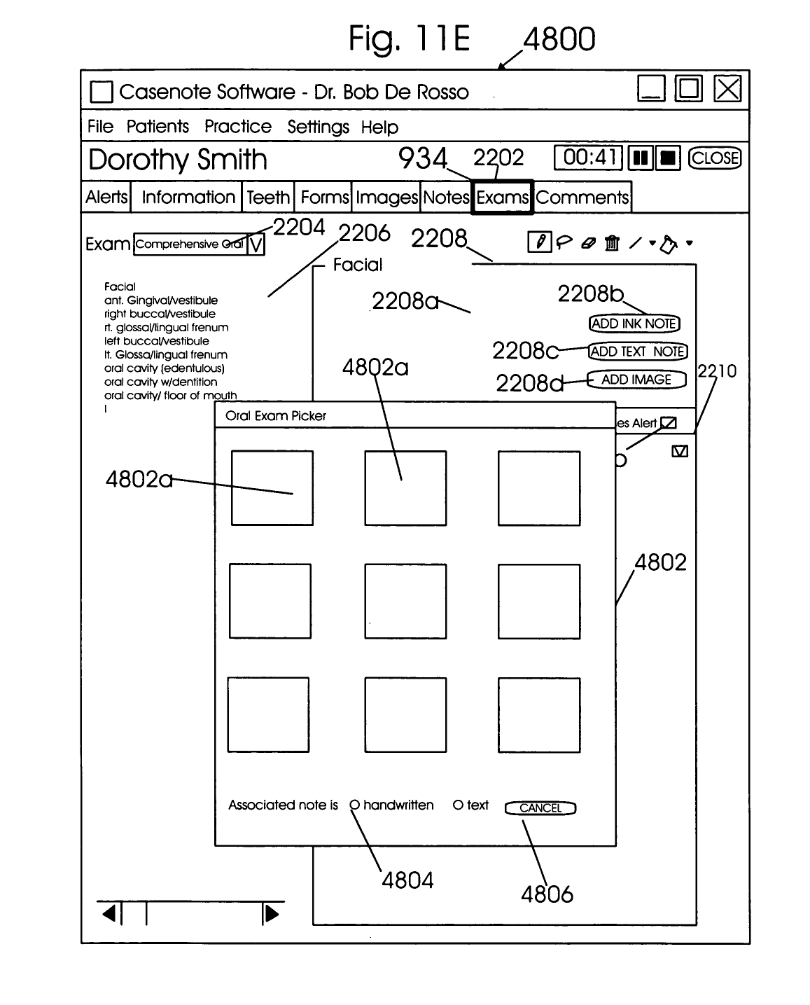

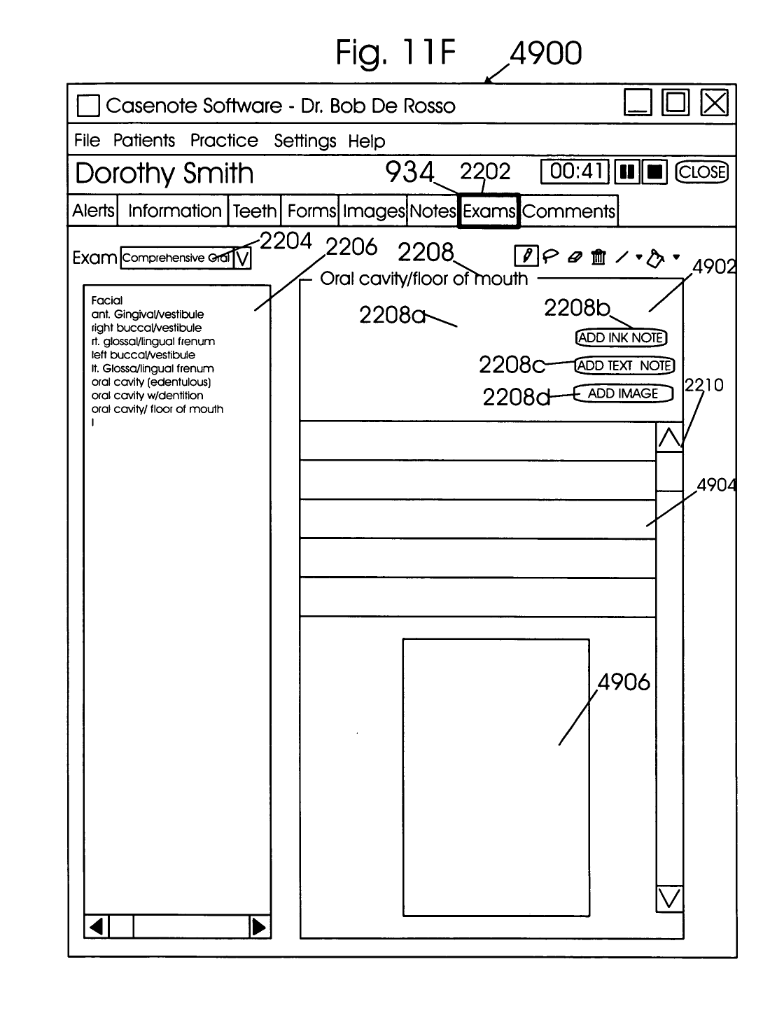

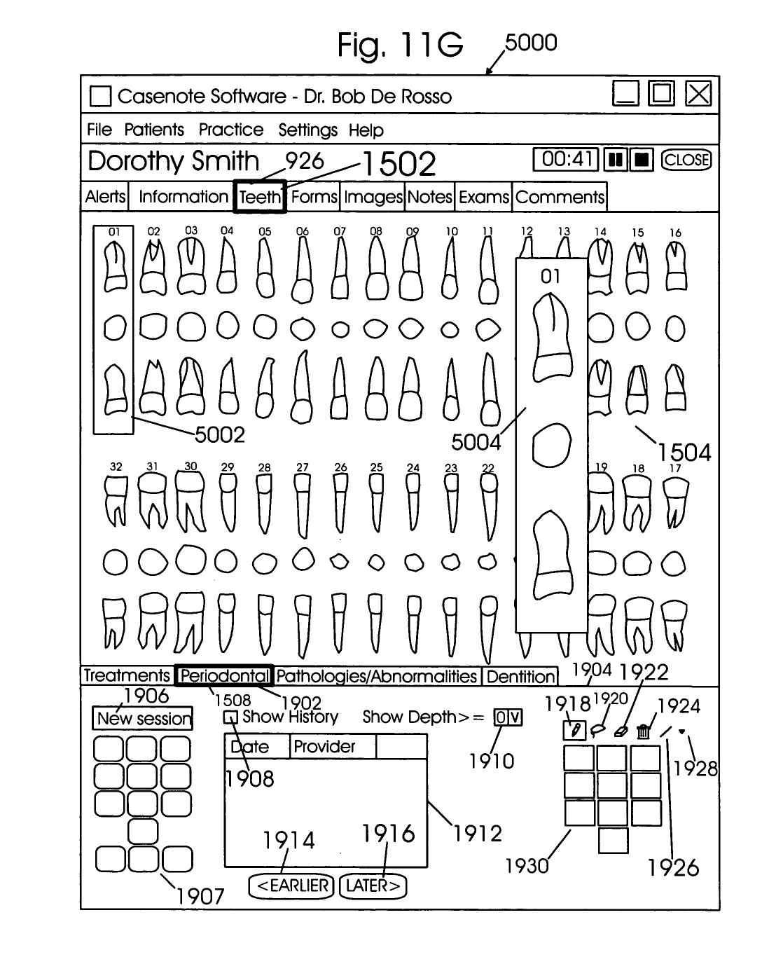

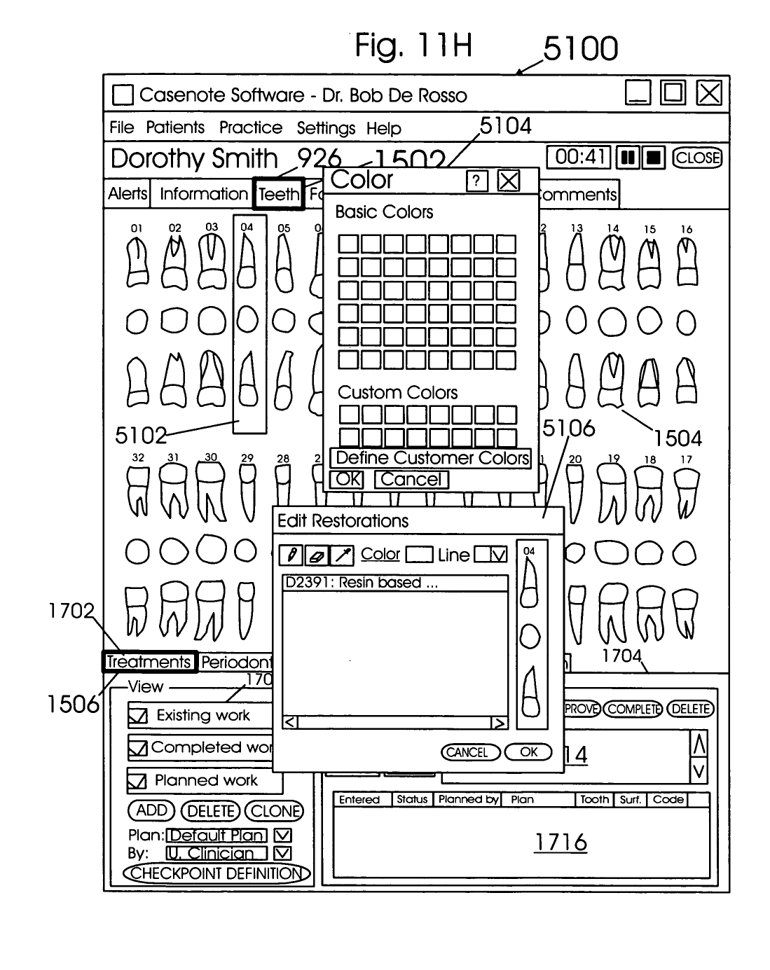

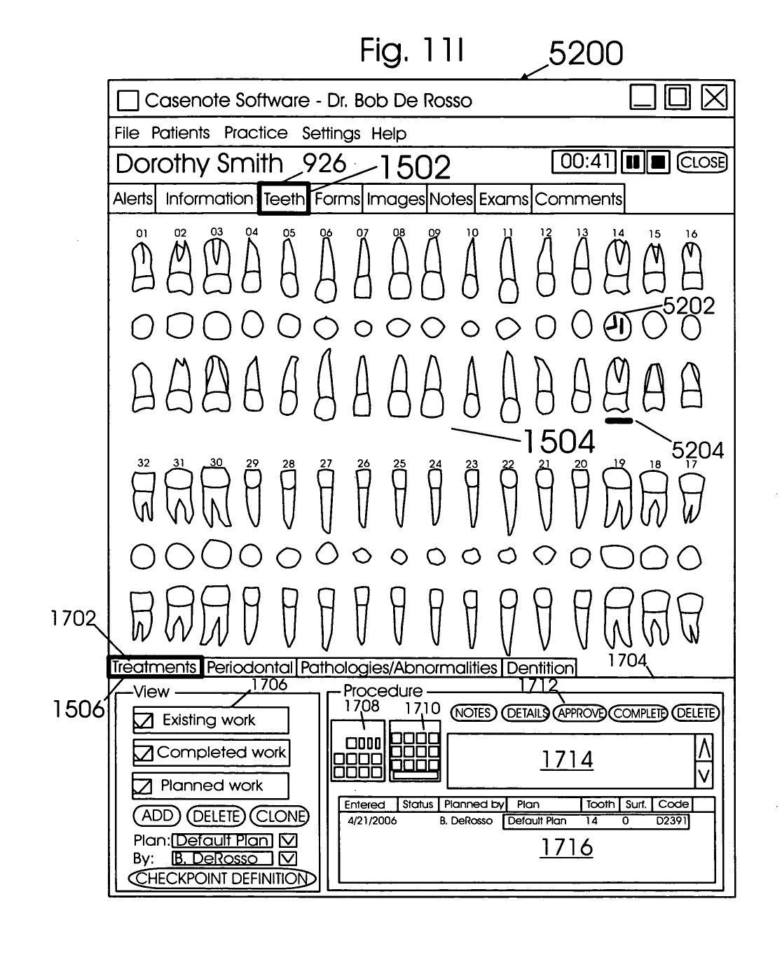

The window 206 further also includes field 220 for checking or unchecking login allowed and field 222 for checking or unchecking clinician privileges. When a user is created, the field 222 is unchecked. Typically, the clinician privileges field 222 will be checked only for a user who will be (a) adding clinical notes into a case note section, such as shown in FIG. 7E and FIG. 7F, i.e. into one of fields 3202a-k, (b) composing treatment plans into field 1504 and field 1706 of FIG. 4C using window or field 1708 of FIG. 4E and window or field 1710 of FIG. 4H, (c) entering medical alert information into the “Sentry” alert field 2200 shown in FIG. 5A, or (d) entering notations and treatment plans into the pathologies abnormalities window shown in field 2001 of FIG. 4G, (e) entering information into the periodontal window shown in FIGS. 4F and 11G), and (f) entering information into the landmark pathology alert window 4900 FIG. 11F. These users would include a dentist, hygienist, and perhaps an assistant. Front desk personnel would typically not have clinician privileges.

The text 244 in FIG. 2B indicates that two users have been created. Clicking on button 246 for “ADD USER” causes a user as entered in “edit user” window 206 to be added and to be displayed under the headings for “Title” etc. at the top of the window 204. Clicking on the button 248 for “edit user” causes the processor 10 to display the edit user window 206 on the screen of the monitor 12.

If the operator selects the “Policy” field 112 shown in FIG. 2A, the processor 10 causes the image 300 shown in FIG. 2C to appear on the screen of the monitor 12. FIG. 2C shows the field 112 surrounded by a thick black box or highlighting 302 to indicate that the field 112 has been selected. The image 300 includes a window 304. The window 304 includes text 306 and a field 308 in which the number of minutes of inactivity before locking the screen of the monitor 12 on which image 300 is displayed. The window 304 also includes a field 310 for checking or unchecking to disallow all logins. The window 304 also includes a button 312 which can be clicked on with a computer mouse (or stylus) of interactive device 14 to change an administrator PIN (personal identification number). A field 314 is also provided, which can be checked to not automatically show the “required new patient forms” query box or not checked to automatically show the “required new patient forms” query box.

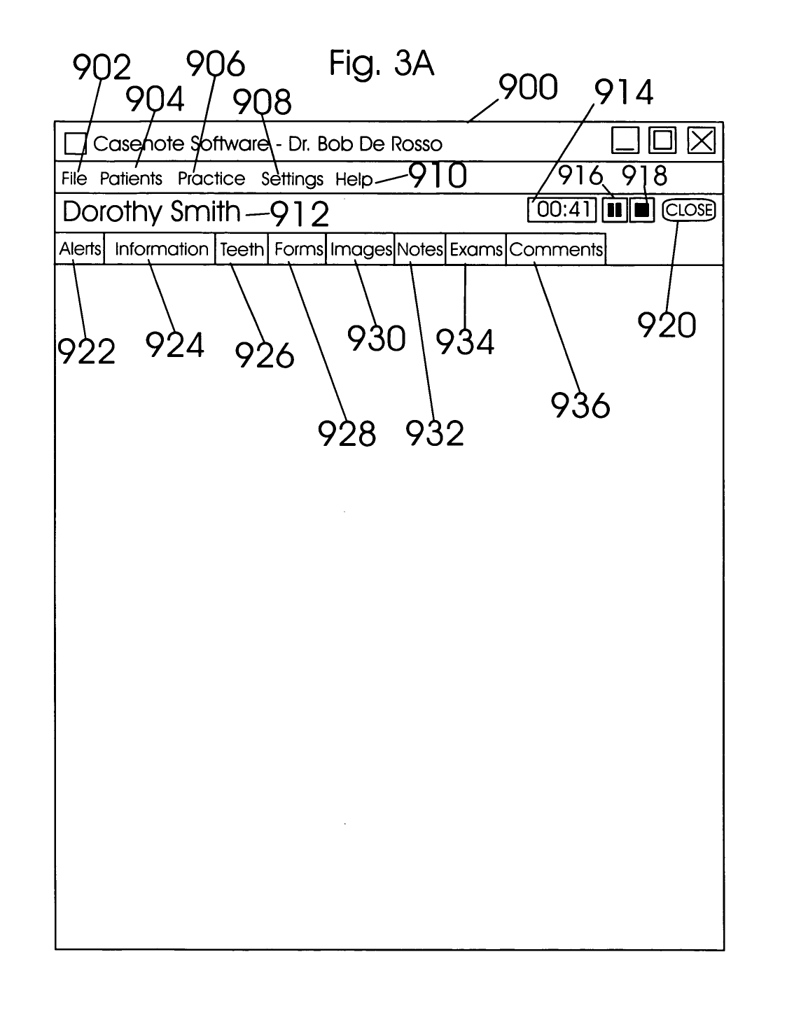

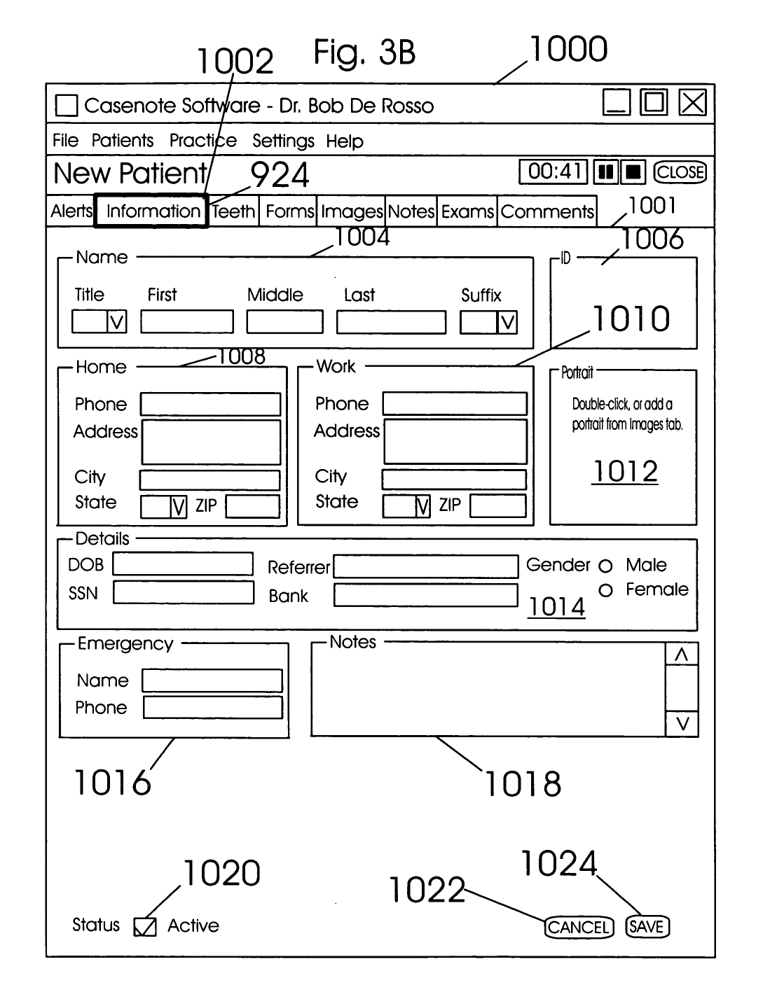

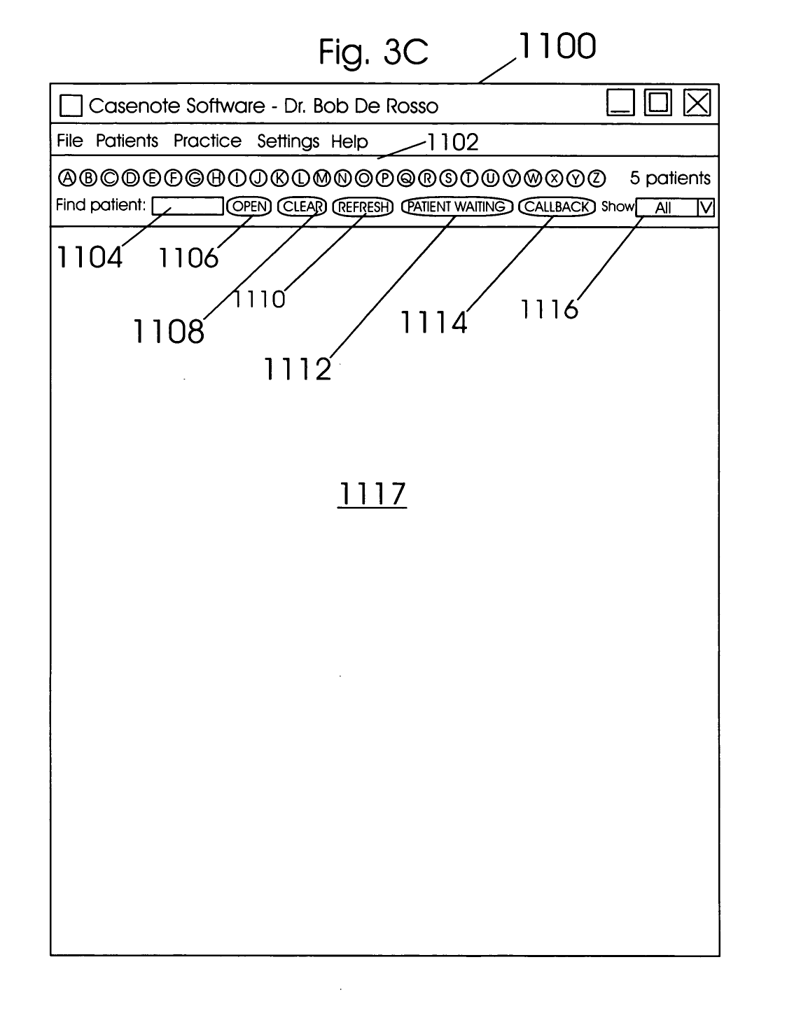

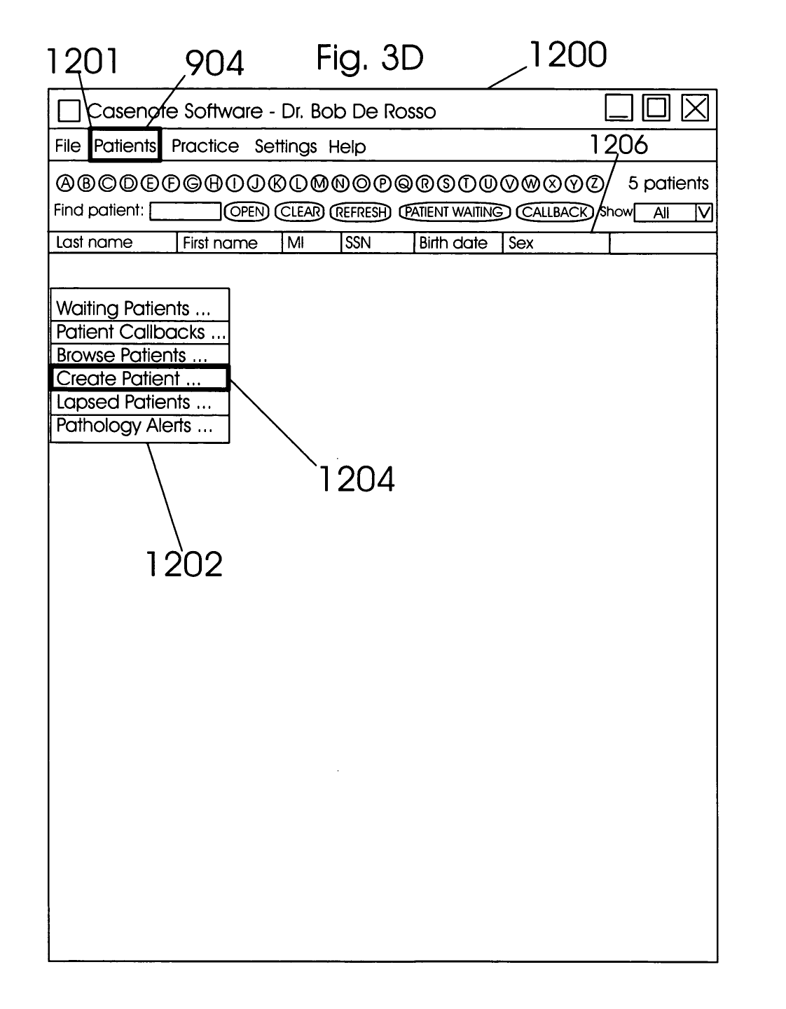

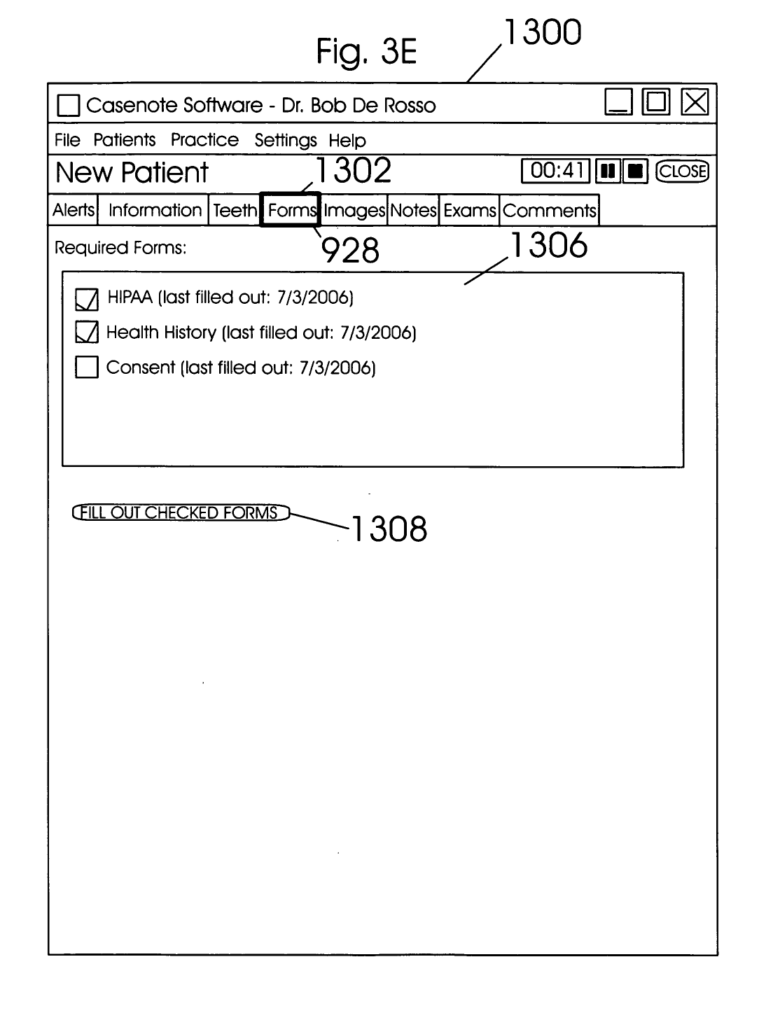

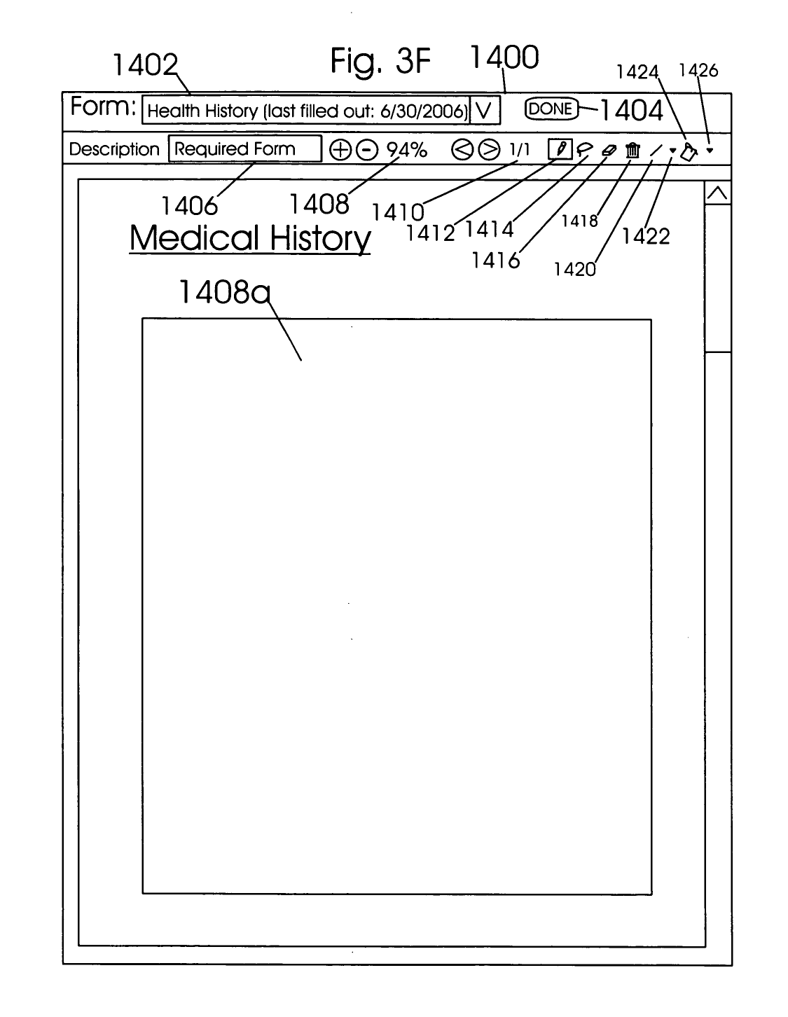

A field 322 is also provided, which can be checked or unchecked to not show or show, respectively, a “pop-up” or superimposable treatment browser, not shown, upon patient chart opening. Generally, a patient chart is comprised of windows or images including those shown in FIGS. 3A-12B. Typically monitor 12 is comprised of a plurality of monitors, and some of these monitors are for clinician personnel, while some of these are for non-clinician personnel. The field 322 causes a treatment ledger to be presented on screens of monitors of monitor 12 to non-clinical personnel only, upon the opening of a patient's chart of FIG. 3B at the non-clinician's particular monitor. This superimposable treatment browser, not shown in the drawings, is basically the same ledger as seen in a treatment window 1716 shown in FIG. 4C. The superimposable treatment browser feature, however, allows the “treatment browser”—to overlay all screens of programs which are open. The purpose is to enable easy transfer of treatment from the computer software in accordance with the present invention (which may be called case note software) to practice management software applications. The window 304 further includes text 316 showing “2 users” in this example, and buttons 318 and 320 which can be clicked on to add a user or edit a user, respectively.

If the operator selects the “procedures” field 114 shown in FIG. 2A, the processor 10 causes the image 400 shown in FIG. 2D to appear on the screen of the monitor 12. FIG. 2D shows the field 114 surrounded by a thick black box or highlighting 402 to indicate that the field 114 has been selected. The image 400 includes a window 404. The window 404 includes text 406. The window 404 further includes windows 408, 410, and 420. The entire list of Current Dental Terminology (CDT) dental codes may typically appear in window 408, although not shown in FIG. 2D. Favorite (or selected) dental procedures can be entered in window 410 by the administrator, using interactive device 14, and will appear on screens of all monitors for all clinicians of monitor 12 in the “Favorites” or “Misc” button in field 1710 of FIG. 4C and FIG. 4H. The full description of a particular CDT dental code will be displayed on monitor 12 in window 420 for each individual code which is selected from the CDT list, prior to selection for the favorites category. The window 420 allows a user (typically a dental clinician) to verify through the description that they will enter the correct code into the field 410 (the favorites category, “Favorites” or “Misc” button) in the procedure pad or window 1710 of FIG. 4H. The user, therefore, does not enter anything into window 420.

Window 404 includes buttons 412a and 412b. Button 412a causes the “maximizing of the CDT codes list shown in window 408, showing all of the individual procedures encompassed in the main and subcategories of the CDT list. Button 412b causes “minimizing” of the CDT codes list in window 408, back to where only the major categories are seen. Window 404 includes button 414 “ADD TO FAVORITES” which allows an administrator to enter codes into this category from the CDT codes list, which the user may commonly use, but which are from various code categories. In essence, miscellaneous, often used procedure codes are grouped and accessible via button 414 for easy location and entry. Buttons 418a and 418b allow a user to “move” a code up or down on the list in window 408, in order of preference of where they would like the specific code to appear (from top to bottom) in field 2106 FIG. 4H when the “Favorites” or “Misc” button is selected. The window 404 further includes a field 416 for entering a name of a dental procedure. Field 416 is where the user may “rename” a procedure which is entered into this category. The user may elect to change a procedure name from the original “official” code name given by the ADA. (American Dental Association).

If the operator selects the “Exams” field 116 shown in FIG. 2A, the processor 10 causes the image 500 shown in FIG. 2E to appear on the screen of the monitor 12. FIG. 2E shows the field 116 surrounded by a thick black box or highlighting 502 to indicate that the field 116 has been selected. The image 500 includes field 504 which can be selected to create a new exam. The image 500 includes a field 506 which allows the user to adjust the settings for the different types of exams present, through a “toggle”, such as in this case “Medical”. “Medical” and “Comprehensive Oral” are the standard exams in software in accordance with embodiments of the present invention (called “Casenote Software”), however, the administrator can create an unlimited number of “exam” classes by selecting field 504 shown in FIG. 2E. The image 500 includes fields 508 and 510. FIG. 2E shows that the field 510 has been selected as shown by the thick black box or highlighting 512 surrounding the “Conditions” field 510.

When the “Conditions” field 510 is selected the window 514 is displayed. The window 514 includes field 516, which can be clicked on to create a new condition. A new condition name can be typed into window 530, and additional descriptive material may be entered into field 532a. The window 514 includes field 520 for “Options”, field 524 for “Alert Form”, and field 526 for “Alert Images”. Field 520 is surrounded by a highlight window 522 to indicate that the field 520 for “Options” has been selected. When the field 520 has been selected, the window 528 is displayed. The window 528 includes field 530 for entering a name of a dental condition and field 532a for entering a description of a dental condition. The field 528 also includes fields 534, 536, and 538 which can be checked or unchecked to indicate that a condition is active, that a condition note causes alert by default, and that an alert is indicated on all patients, respectively. Field 528 also includes a button 540 which can be clicked on to update information regarding a condition entered in fields 530, 532a, 534, 536, and 538. The window 514 includes a list of conditions in window 518.

FIG. 2F shows an image 600. In FIG. 2F, field 526, for “Alert Images”, is surrounded by a highlight window 602 to indicate that the field 526 has been selected. When the field 526 has been selected, the windows 604 and 606 and the buttons 608 and 610 are displayed. The buttons 608 and 610 when clicked on, by a computer mouse (or stylus) of interactive device 14, allow an image to be added and deleted from computer memory 16, respectively. The field 604 shows headings for “Date”, “File”, “Pages”, and “Description”. A date, file, number of pages and a description for an image, such as a digital photograph, can be entered through a keyboard of interactive device 14 in accordance with an embodiment of the present invention. The field 606 includes a field 606a for entering a description concerning an image, and a magnification indication 606b which can be increased or reduced in magnification by “+” and “−” buttons, respectively. The field 606 also includes an indication 606c of the number of pages of the image, which in this case is “1/1” or one page of a total one page. There are “<” and “>” buttons next to the “1/1” indication 606c, to scroll to a different image, if any.

FIG. 2G shows an image 700. FIG. 2G shows that the field 508 for “Options” has been selected as shown by the thick black box or highlighting 702 surrounding the “Options” field 508. When the “Options” field 508 is selected the window 704 is displayed. The window 704 includes a field 706 into which a name can be entered for a type of exam. The window 704 further includes a field 708 which can be check or unchecked, using a computer mouse of interactive device 14, to indicate whether an exam is active. A button 710 is further provided for clicking on to update the status of a patient exam (active or inactive) if the status has been changed.

If the operator selects the “Locks” field 118 shown in FIG. 2A, the processor 10 causes the image 800 shown in FIG. 2H to appear on the screen of the monitor 12. FIG. 2H shows the field 118 surrounded by a thick black box or highlighting 802 to indicate that the field 118 has been selected. The image 800 includes fields 804, 806, 808, and 810. The image 800 relates to a user and patient lock function. The user and patient lock function allows an administrator to-unlock a user or patient account if the user (a) has not logged out properly, (b) has not logged out of a patient record properly (the system may typically interpret them as still in use) or (c) if a patient account is still open. All users may typically only view a patient chart, such as shown in images shown in FIGS. 3A-12B, which is currently opened by a clinician or non-clinician user.

Field 804 may contain a list of users. Field 808 may contain a list of patients. In one embodiment, the administrator typically must “highlight” the user or patient, in either field 804 or 808, respectively, followed by the selection of either button or field 806, to release a “user” lock, or button or field 810, to release a patient lock. After the locks have been released, the accounts are fully functional, and may be used in a regular fashion.

FIG. 3A shows an image 900 for display on a screen of the computer monitor 12. The image 900 is displayed when either a clinical or a non-clinical user logs-in and selects a particular patient's name (in this case “Dorothy Smith”) from an alphabetical patient list, followed by selecting an “open” button 1106 as shown in FIG. 3C. The image 900 is the main image or menu for a dental computer software program of one or more embodiments of the present invention.

The image 900 includes fields 902, 904, 906, 908, and 910, which will be described. The image 900 also includes text 912 indicating a patient name, field 914 indicating a “stopwatch” or timer for the appointment, field 916 indicating a pause button, field 918 indicating a stop button (for the timer), and field 920 for closing the image 900 form or window 1001 of FIG. 3B for this patient. The image 900 also includes fields 922, 924, 926, 928, 930, 932, 934, and 936.

FIG. 3B shows an image 1000 for display on a screen of the computer monitor 12. The image 1000 is displayed when the field 924 for “Information” has been selected. A thick, black, box or highlighting 1002 surrounds the field 924 to indicate that the field 924 has been selected. Selection of the field 924 causes the processor 10 to display the window 1001 on the screen of the monitor 12. The window 1001 includes windows 1004, 1006, 1008, 1010, 1012, 1014, 1016, and 1018. The window 1001 also includes fields 1020, 1022, and 1024.

A user or operator can create a patient chart, which will be stored in memory 16, by entering, using interactive device 14, a patient's information into the windows and/or fields shown in the window or patient chart 1001 of the image 1000 of FIG. 3B. The user or operator may enter a patient photograph by double clicking, with a computer mouse or stylus, on the window 1012 and selecting a photograph that has been scanned into the memory 16, or has been imported to the computer hard drive of the memory 16, using a digital photography camera or device.

The window 1004 has fields for entry regarding the name of a dental patient. A computer cursor of the interactive device 14 can be moved to the particular field and the interactive device 14 can be used to type or otherwise enter information into the particular field and into memory 16. An identification number for the patient is automatically assigned to each patient upon creation and appears in window 1006. The windows 1008 and 1010 have fields for entry of patient home information and patient work information, respectively. The window 1012 allows for display of a digital photograph of a patient. The window 1014 has fields for entry of various details regarding the patient, including date of birth (DOB), social security number (SSN), and further information. The window 1016 allows for entry of emergency contact numbers. The window 1018 allows for entry of notes regarding a patient. The field 1020 can be checked or unchecked to indicate if the patient status is active or inactive, after the “Edit” or “Save” button or field 1024 shown in FIG. 3B has been selected. The window 1001 further includes button 1022 for canceling out of the patient window, chart, or form 1001 and button 1024 for editing the fields in window 1001. A computer mouse, stylus, or computer keyboard can be used for entry of information.

FIG. 3C shows an image 1100 for display on a screen of the computer monitor 12. The image 1100 is displayed when a user first logs-on a computer software program in accordance with the present invention (which may be called “Casenote Software”). The image 1100 is the patient list window. The image 1100 is typically displayed by the processor 10 on a screen of the monitor 12 before the image 1000 in FIG. 3B. The patient name is selected in image 1100 of FIG. 3C, followed by selecting the “open” button 1106. This causes the image 1000 to appear on the screen of the monitor 12.

The image 1100 includes a set 1102 of twenty-six alphabetic buttons A-Z, which are used to select letters of a patient's last name, starting with the first letter. As subsequent letters of the patient's last name are entered (from field 1102) the program will show only the last names with those letters. This serves as a means to reduce the names in image 1100 in a patient list which will be located in field 1117 under the fields 1104-1116 therefore expediting the selection of a desired patient. Instead of manually entering the letters with a keyboard (as in field 1104), set 1102 allows the user to select letters with a stylus or mouse. The image 1100 also includes an entry box 1104, an open button 1106, a clear button 1108, a refresh button 1110, a patient waiting button 1112, and a callback button 1114. The image 1100 also includes a field 1116 which has an arrow. When the arrow is selected, the following “options” will appear in a drop-down menu: “All” to display all patients in a patient list, in field 1117. “Active” to display only active patients in the list in field 1117, and “Inactive” to display only “inactive patients in the list in field 1117. A patient's name can be entered in field 1104 and as the letters are entered (one by one) the field of patient names (below) will reflect those letters in the box. I.e., if “Ten” was entered, only the last names beginning with those letters, in alphabetical order would be seen in the list in field 1117. As more letters are entered, the list would become more specific. This may function in a manner similar to field 1102, with names being reflective of entered letters. The patient record or image 1000 of FIG. 3B, for the particular patient entered in 1104 can be opened by clicking on button 1106. Field 1108, when clicked on, clears letters in the field 1104, causing all of the patient names to appear in the patient list in field 1117 of FIG. 3C.

Field 1110 refreshes the main patient list and will then show names in field 1117 which were added after the screen was initially brought up. I.e. if the screen was brought up at 11:40 a.m. and a new patient was added to the list at 11:41 a.m., the new patient would not appear until the “refresh” button or field 1110 was pressed. This also works for patients that are deleted off the main patient list.

The patient waiting field or button 1112 is typically used by non-clinician front desk “clerical” personnel to “alert” the clinician or clinical staff that a patient has arrived for a specific clinician. The patient name would be selected from the main list, then the patient waiting button or field 1112 would be selected. At that point, the front desk personnel would select the clinician's name from the patient waiting module, not shown, which is prompted by the selection of field 1112 who is to be notified of their patient's arrival. After which, an audible signal (accompanied by a flashing “title bar”) would be heard and seen on that clinician's computer. The clinician's computer and the front desk computer may be part of the processor 10.

The callback field or button 1114 initiates a callback feature which can be activated by a stylus or a computer mouse. A user first highlights a patient (who is to be called back) then selects the callback field 1114. Typically, the following will need to be selected: (a) a caller (from the dental staff) from a drop-down menu, (b) call back time (either unspecified or time and date) (c) entry of callback reason/notes (optional) then select O.K button, not shown in the drawings. The user will then be reminded upon logout to call the person(s) entered into this feature.

FIG. 3D shows an image 1200 for display on a screen of the computer monitor 12. The field or window 1202 is displayed when the “Patients” 904 field has been selected as shown by the black, thick box or highlighting 1201 surrounding the “Patients” 904 field. The image 1200 includes the window 1202 having a list of options which can be selected. In this instance a “Create Patient . . . ” field has been highlighted by thick black box or highlighting 1204. In response to this highlighting, the image 1000, including window 1001 of FIG. 3B, is seen to allow for the entry of information to create a new patient account. The window 1001 includes headings for various information about a patient including “Last name”, “First name” etc. The patient information is entered into these spaces by selecting button or field 1204 for “Create Patient”, then entering a patient's information into the resulting window 1001 shown in FIG. 3B, followed by selecting the “save” button 1024 to save the patient's information into the memory 16.

Generally, only the following fields are needed to establish a patient record: patient name (first and last) and gender. This is to prevent the staff (both clinician and non-clinician) from having to enter “redundant” information which may be in other office software programs.

FIG. 3E shows an image 1300 for display on a screen of the computer monitor 12. The image 1300 is displayed when the “Forms” 928 field has been selected as shown by the black thick box or highlighting 1302 surrounding the field 928. The image 1300 will also be seen, when upon the creation of a patient chart through field 1204 in FIG. 3D, followed by the entry of information into the window 1001, “yes” is selected in the prompt box, which will present itself upon the opening of the window 1000 in FIG. 3B. The window 1000 asks the user “do you wish for the patient to fill out their required forms.” If “no” is selected, then, this prompt box—will continue to prompt each time the window 1001 of FIG. 3B is opened (until they are filled out) The administrator also has the option of checking field 314, in window 300 of FIG. 2C to eliminate the prompt box which appears asking “do you wish for the patient to fill out their required forms.” The image 1300 includes a window 1306 showing names of various required forms, next to checked or unchecked boxes and showing a date last filled out. The check mark indicates that the form was filled out and no check mark indicates that the form was not filled out. Acknowledging the “do you wish for the patient to fill out their required forms,” button will cause the computer program running on the processor 10 to register or store in memory 16 all of the included forms as “filled out.” An actual notation is not required. The image 1300 also includes a button 1308 to click on to fill out checked forms.

A patient typically would use the interactive device 14 to fill out the computer program's HIPAA forms and a medical/dental health history questionnaire (with the stylus) which may be automatically prompted with the creation of a new patient data chart or record through window 1001, which is stored as a new patient record in memory 16. The patient or staff member can click on the button or field 1308 to display the required forms on the screen of the monitor 12. After the patient has completed filling out these forms with a computer stylus or mouse, the patient shall return the computer (tablet personal computer) to the staff member, where that staff member will enter the staff member's P.I.N. (personal identification) number so that full access to all the patient's information will be granted. This feature will prevent any unauthorized individuals (such as patients) from being able to access confidential information belonging to other patients, thereby preventing any violation of the HIPAA act. In addition, users (both clinical and non-clinical) are also enabled to scan in any forms which they normally use, and organize them as templates associated and accessible via the “forms” tab shown in FIG. 3E, as well. Laboratory slips, consent to treatment forms, preferred health history forms/HIPAA forms as well as financial forms may all be categorized by name (topic) and may be stored in memory 16 and associated and accessible under the tab or button 928 for Forms. After being annotated and saved in memory 16, the forms will also typically be non-editable as the previously mentioned forms. In addition, the user is able to create their own forms (in text), which may be used as templates for any information, and may be annotated in either text or script “ink” (“ink” not meaning physical “ink”, and “handwriting with a computer stylus” in this program generally means moving a stylus over a tablet personal computer in a handwriting type motion to input information, but without using physical “ink”).

FIG. 3F shows an image 1400 for display on a screen of the computer monitor 12. The image 1400 is displayed when the button 1308 in FIG. 3E is clicked on by placing a computer stylus over the button 1308 and tapping or clicking with the computer stylus of the interactive device 14. The image 1400 includes field 1402, which displays the “title” of the form(s) selected to be filled out by the patient, as well as the last date which the forms was filled out by that patient (if it was previously filled out by that patient). The image 1400 further includes a button 1404 which shall be selected after all forms needing to be filled out, are completed. The image 1400 further includes a field 1406 which displays the category or type of the forms (in this case “Required Form”). Other categories may include “financial”, “laboratory”, “non-required” etc. The image 1400 further includes field 1408 which indicates magnification, and field 1410 which indicates the page number out of a total number of pages pertaining to that form.

The image 1400 further includes characters 1412-1426 which were created by Microsoft (trademarked) for the tablet personal computer and allow for functions inherent to the tablet personal computer. Character 1412 activates the “script” ink ability of the stylus (of the tablet). Character 1414 allows the user to “lasso” a script entry, and then “drag” it to another area of a writing field. Character 1416 “eraser” allows for small “narrow” stroke functionality with the tip of the stylus. Character 1418 “eraser” allows for large “broad” stroke functionality with the tip of the stylus. Characters 1420 and 1422 (drop down menu) allows the user to select the width of the writing stroke (fine tip to broad tip). Characters 1424, and 1426 (drop down menu) allow the user to select from a list of colors to write with (in stylus script). The image 1400 has a window 1408a wherein the electronic form is seen, and in which information for the form, in this case medical history, can be entered, using interactive device 14 with a stylus or with a keyboard, for example.

FIGS. 4A-4H show various images concerning “Teeth” processing. FIG. 4A shows an image 1500 for display on a screen of the computer monitor 12. The image 1500 is displayed when the “Teeth” field 926 is selected as shown by the thick black box 1502 or highlighting surrounding the teeth field 926. The image 1500 includes window 1504 which in this case shows all thirty-two permanent teeth, each tooth shown from three perspectives. The window 1504 shows thirty-two permanent teeth in FIG. 4A, but may show the following teeth depending on what has been selected:

(a) UPPER PERMANENT teeth: 01-05, 12-16 (buccal/occlusal/palatal views [from top to bottom]) and teeth 6-11 (Facial or labial)/incisal/palatal views from top to bottom.
(b) UPPER DECIDUOUS teeth A, B, and I and J (buccal/occlusal/palatal views [from top to bottom]) and C-H (facial or labial)/incisal/palatal views from top to bottom. The UPPER DECIDUOUS teeth are not shown in the drawings. Only the UPPER PERMANENT teeth are shown as an example. (c) LOWER PERMANENT teeth 17-21, 28-32 buccal/occlusal/lingual views [bottom to top] and 22-27 facial (labial)/incisal/lingual from bottom to top.
(d) LOWER DECIDUOUS teeth K and L, S and T buccal/occlusal/lingual views [bottom to top] and #M-#R facial (labial)/incisal/lingual from bottom to top. The LOWER DECIDUOUS teeth are not shown in the drawings.

The image 1500 further includes fields 1506, 1508, 1510, and 1512.

FIG. 4B shows an image or window 1600 which is used for the setup of images of teeth such as those seen in FIGS. 4A and 4C-4H. FIG. 4B shows an image 1600 for display on a screen of the computer monitor 12. The image 1600 is displayed when the “Dentition” field 1512 is selected as shown by the thick black box or highlighting 1602 surrounding the field 1512. The selection of field 1512 causes the window 1604 to be displayed on the screen of monitor 12. The window 1604 includes buttons 1606, 1608, 1610, 1612, 1614, 1616, 1617, 1618, 1619, and 1620, each of which can be clicked on to change the number and type of teeth that appear in window 1504, or to select certain teeth. The button 1610 can be clicked on to display all permanent teeth in window 1504. The button 1612 can be clicked on to display only crownless (or “root tips”) teeth. The button 1614 can be clicked on to display only primary teeth. The button 1616 can be clicked on to display only empty (edentulous) tooth slots. The buttons 1618 and 1620 can be clicked on to display impacted and non-impacted teeth, respectively. The buttons 1606 and 1608 can be selected to select all teeth or no teeth, respectively. Buttons 1617 and 1619 can be selected to allow a user to display partially or fully erupted teeth, respectively.

A patient's dentition may be selected and represented using the dentition window 1604. Here, pre-rendered images of the permanent and primary dentition represent the patient's existing dentition in any combination. The user is enabled to select the appropriate tooth spaces (cells) where the pre-rendered images of the dentition will reside. There are 32 cells, shown in FIG. 4B, arranged horizontally (sixteen cells, numbered 01-16 (from left to right), representing the maxillary dentition and sixteen cells, numbered 17-32 (from right to left) represent the mandibular dentition), each corresponding to the permanent dentition (and primary where applicable). Highlighted cells are considered to be “active”. A cell must be activated in order to place a tooth in that space (cell). The user may activate all of the cells by activating the “select all teeth” button 1606 or each cell may be activated manually with the stylus (or computer mouse) of interactive device 14. The categories of dentition are as follows: primary (deciduous), permanent, crownless—this selection reveals only the “root” portion of the selected permanent dentition, impacted-allows representation of non-erupted teeth (shows a red oval around the tooth), and partially erupted- allows the representation of a partially erupted tooth (teeth). After the dentition selection is complete, the user should then activate the “select no teeth” button 1608 in FIG. 4B which will deactivate all of the cells, prohibiting any further alterations of the dental cells, unless the cells are activated again. Window or image 4600 of FIG. 11C shows the outline of the thirty-two “cells” which will be seen highlighted (as they are here) when activated.

FIG. 4C shows an image 1700 for display on a screen of the computer monitor 12. The image 1700 is displayed when the “Treatments” field 1506 is selected as shown by the thick black box or highlighting 1702 surrounding the field 1506. The selection of field 1506 causes the window 1704 to be displayed on the screen of the monitor 12. The window 1704 includes windows 1706, 1708, 1710, 1714, and 1716. The window 1704 also includes a plurality of buttons 1712.

The window 1706 or “view” window, has entry fields for checking or unchecking with a stylus in order to specify whether a treatment refers to “existing work”, “completed work”, or “planned work”. The user is able to see any view(s) of these three stages of treatment at any time. Also to further aid the user, the following areas of information (Tooth/Surface/Code) will be highlighted with the color pertaining to which of the three stages (typically blue for “existing”, orange for “planned”, and green for “completed”) that it belongs in window or field 1716. The window 1706 also has buttons which allow information from windows 1716 and 1504 to be added, deleted, or cloned from another file, relating to the Tooth/Surface/Code that it belongs. The “ADD” button in window 1706 allows the user to add a treatment plan by selecting it. At that point, a box will be prompted, asking the user for the name and author of the treatment plan. After that information is entered, the user shall select an “OK” button, not shown, will be seen overlying a small portion of the dentition in window 1504 shown in FIG. 4C. Upon creation of a patient record as shown in window 1001 of FIG. 3B and storage in memory 16, the user is enabled to compose the “default” treatment plan. The plan name can be changed, however, computer software in accordance with an embodiment of the present invention automatically names the initial treatment plan “default plan” as shown in window 1706 in FIG. 4C.

The “DELETE” button in window 1706 allows a user to “delete” all of the treatment plan entries in memory 16 of the treatment plan whose name is seen in the “PLAN” field located inside the window 1706. The “CLONE” button will enable the “clone” function. The “clone” feature or function was designed to eliminate the redundant entry of treatment which is common to multiple treatment plans. The user will see the “clone” ledger, such as shown in image 4502 FIG. 11B after the button is activated.

The clone ledger shown in image 4502 FIG. 11B—will show all of the planned treatment (tooth/surface/code/description—in text) associated with the treatment plan in the “plan” field located in window 1706 shown in FIG. 4C. All of the treatment will be seen as “highlighted”. The user shall de-select, for example by tapping on text description with a stylus or a computer mouse of the interactive device 14, any treatment which they do not want to be carried over (cloned) into the new treatment plan. Also in this clone ledger in image 4502 shown in FIG. 11B, is the “Swap” feature, which allows the user to replace posterior amalgams with the appropriate counterpart (composites) to give this common treatment option, without requiring the user to enter each restoration as composites. The result will be an additional treatment plan which will list the same exact teeth/surfaces which were treatment planned for amalgams, treatment planned for composites. This feature is enabled by checking a checkbox in the lower left hand corner shown in image 4502 shown in FIG. 11B (accompanied by the text “Replace amalgam restorations with composite restorations”).

The window 1706 also has an entry field for indicating the name of a dental plan, which in this case is “Default Plan”. Default plan is the name automatically assigned to each new treatment plan. It may be changed at any time by the user. The window 1706 also has an entry field for indicating the dentist who authored the treatment, which in this case is “B. DeRosso”. The window 1706 includes a button “Checkpoint Dentition” which when clicked on takes a “screenshot” of the dentition and restorations in field or window 1504 of FIG. 4C at that moment, and saves it in memory 16 as a “non-editable” file associated and accessible through the image tab or field 930 shown in FIG. 3A, under a “saved dentition” category, not shown. The image is titled and dated upon it's being saved in the memory 16. When a category (in the left hand margin, of window 2500 FIG. 5D in the column to the left with the scroll bar at the bottom) is highlighted, the following information of the images contained in that category is seen in window 2508 shown in FIG. 5D: “Date (of entry)\File name\number of pages\description.”

The user will need to select the appropriate treatment stage (between “existing work”, “completed work”, and “Planned work” in window 1706 of FIG. 4C, by ensuring that the particular stage alone is activated, by clicking on it, which places a check mark, before entry of treatment. For example, the user may put a check mark using the stylus, next to “Existing work” in window 1706. If all of the treatment stage boxes are checked, any entered treatment will automatically be entered as “planned work” type treatment. The stage of completed treatment is reached only when a procedure is entered as completed by a current user, by checking the box next to “completed work” in window 1706 prior to entry of that procedure(s), or by highlighting a treatment entry which is currently marked as “planned” (status) in the ledger 1716 FIG. 4C, then selecting the “complete” button in window 1712 shown in FIG. 4C. Treatment status is demonstrated in two ways: as a text entry in the treatment ledger or window 1716 shown in FIG. 4C and as a “status” marker which is evident in the color of the status adjacent to a particular tooth or a set of teeth in the window 1504 of FIG. 4C.

The user may view one, two, or all three stages (existing, completed, and planned) of treatment at any time in an “onion skin” fashion by selecting the desired statuses to be viewed (using window 1706 of FIG. 4C). Two input pads or fields 1708 and 1710, whose icons 1708a and 1710a are shown in FIG. 4C, may be used to enter treatment into the above statuses. The restorative treatment entry pad 1708 or window 1708, whose icon is shown in FIG. 4C is shown in detail in FIG. 4D. Entry is typically permitted after the window 1708 is maximixed by clicking on the icon 1708a in FIG. 4C to show a detailed maximized version of FIG. 4D. The window 1708 of FIG. 4D is used for restorations which are “surface” specific. The procedure pad in window 1710 is shown in FIG. 4H. The icon 1710a can be tapped by a stylus to “maximize” the procedure pad 1710 as shown in FIG. 4H.

FIG. 4D shows the restorative treatment entry pad 1708 in detail. The entry pad 1708 includes keys, buttons, or fields 1708a-l. A user clicks on or taps with a stylus or otherwise selects one of the buttons or fields 1708a-l to enter various data. Buttons 1708b and 1708c allow a user to enter data indicating “amalgam” and “composite”, respectively. Button 1708d allows a user to enter data indicating a “gold” restoration. Button 1708i allows a user to enter “inlay or “onlay”. Data indicating a gold inlay or onlay can be entered by selecting button 1708i, followed by 1708d and a porcelain Inlay or onlay can be entered by selecting button 1708i, followed by 1708c. Data indicating a temporary restoration and a sealant can be entered through buttons 1708k and 1708l, respectively.

Data indicating “mesial” can be entered by selecting button 1708e. Data indicating “occlusal” (for posterior teeth) can be entered by clicking on button 1708f, “distal” through button 1708g, “buccal” (for posterior teeth) through button 1708j, “lingual” through button 1708a, and “cervical” through button 1708h. Incisal and Facial are surfaces specific to anterior teeth. Incisal=occlusal (posterior teeth) and facial=buccal (posterior teeth). For the following (anterior) teeth (permanent) 06-11 and permanent 22-27 and (deciduous) C-H and M-R. Window 1504 FIG. 4E shows the permanent dentition (#1-#32). A posterior tooth had been selected, as the pad (1708) shows “0” for occlusal and “buccal.” Button 1708f will be the incisal “I” button, and button 1708j will be the “facial” button. When entering multiple teeth at once, anterior and posterior are typically not able to be combined (as per a computer software program in accordance with an embodiment of the present invention.

The procedure-pad or window 1710 (which includes windows or fields 2102, 2104, and 2114, shown in FIG. 4H, is used to enter all remaining dental procedures. The standard setup of pad or window 1710 is for general dentistry. It may be comprised of thirteen keys or buttons, nine of which have names (this is the standard setup). The remaining four buttons (in windows 2102 and 2104) have display arrows. The pair of buttons in window 2104 represent upper (for the up arrow) and lower (for the down arrow), respectively, partial dentures under “R.P.D.” (which stands for removable partial dentures). When clicked on the arrows in 2104 prompt the codes (upper and lower removable partial denture codes contained in those buttons respectively) to appear in window 2106 of FIG. 4H, to be selected for entry.

The “MISC” (or “favorites”) button of the window 2114 is in the procedure pad or window 1710. When the “MISC” button of the window 2114 is selected, all content or dental procedures under that category are shown in the window 2106 shown in FIG. 4H. They will then be highlighted and entered as will the normal “protocol” of all keys in the procedure pad 1710. Therefore, after appearing in window 2106 of FIG. 4H, the user may select a code followed by selecting “DONE” button 2112 of FIG. 4H (to enter only that procedure at that time) or select the “ADD” button 2110 to add subsequent code(s) which will keep the procedure pad 1710 “maximized” for additional selections at that time. If the user selects “ADD” button 2110, and enters subsequent codes, the “DONE” button 2112 will need to be selected to enter into the ledger 1716 of FIG. 4C, the multiple codes which were selected, and onto the dentition (as the “images” which represent the treatment).

The pair of buttons in window 2102 represent upper (for the up arrow) and lower (for the down arrow), respectively, full dentures. When clicked on, the arrows in 2102 prompt the codes (upper and lower full denture codes accessible via those buttons, respectively) to appear in window 2106 shown in FIG. 4H, to be selected for entry (as with window 2104).

The procedure pad or window 1710 in FIG. 4H, is editable by the user in the following ways: (a) the user can reversibly eliminate any of the keys or buttons in windows 2102, 2104, and 2114, (b) the user can reversibly rename any of the keys or buttons in windows 2102, 2104, and 2114, and (c) the user can reversibly change the codes stored in memory 16 and (add/delete) accessible via each button (key) in windows 2102, 2104, and 2114. This includes the ability to combine any number of codes from any [C.D.T.] category and make the codes accessible via any one button. To enter dental work onto a tooth (teeth) in any of the three treatment stages (existing, planned or completed) of window 1706 of FIG. 4C, where a tooth (teeth) will be assigned the treatment, the tooth (teeth) must first be selected, followed by the entry of the procedure residing in the input pad or window 1710 shown in FIG. 4H. With procedures where a tooth (teeth) is not associated (such as a prophylaxis or panoramic radiograph), no tooth (teeth) need be selected. The procedure pad 1710, will also enable the user to group multiple C.D.T. codes under a single “pseudo code” which may then be associated with and accessible through any key(s) in fields 2102, 2104 and 2114 to expedite the entry of these codes, by allowing their entry [multiple codes] under one code or “multicode.”

The restorative treatment entry pad or window 1708 shown in FIG. 4D can be used following selection of the tooth (teeth) by entering the appropriate surface button(s), of buttons or fields 1708 a,e,f,g,h, or j, followed by the button which represents the material, of 1708 b,c,d,i,l,k, respectively, The surface buttons or 1708f and j shown in FIG. 4D will automatically change in the following manner for anterior/posterior teeth: Anterior—incisal/facial, posterior—occlusal/buccal. After the user verifies their choice (by tapping on the ledger box or field 1802 shown in FIG. 4E, a pre-rendered image of the restoration in the appropriate color will appear on the appropriate tooth (teeth) in window 1504 of FIG. 4C, in it's proper outline form. Also present will be a text entry in window 1716 of FIG. 4C for the restoration including date of entry, date of completion, treatment status, treatment plan name, provider, code #, tooth/teeth #, name of procedure, and fee, where the “plan”, “tooth”, “surf.” and “code” columns will be highlighted according to the status of the procedure (existing, completed or planned). If the user wishes to edit the restoration size or shape, they are enabled to do so with a restoration editor, such as shown in window 5106 of image 5100 of FIG. 11H.

To activate the restoration editor, shown in 5100, FIG. 11H, the user must “double-tap” on the particular tooth, in window 1504 of FIG. 4H with the restoration to be augmented. The editor's interface or window 5106 shown in FIG. 11H, will then be seen. The restoration and tooth image to be edited will be seen in the window 5106. Text entries for all restorations (if more than one) on that tooth will be seen highlighted. For example, “D2391:Resin Based . . . ” would be highlighted in window 5106 of FIG. 11H. The restoration who's text is highlighted, such as in window 5106 of FIG. 11H will be seen on the tooth, such as on the actual drawing, diagram, or picture, or view of tooth 04 shown in window 5106, where the restoration will be able to be edited. Here the user is able to erase, by selecting an eraser button and/or add to [using a stylus] the pre-rendered restoration (directly on tooth #04 in FIG. 11H with the stylus) to more accurately represent the restorations form.

There would typically be a color grid, such as window 5104 in FIG. 11H, which appears when the user selects the field named “color” in window 5106 shown in FIG. 11H, which also allows the user to change the color of the restoration if they wish. The window 5104 includes a grid of boxes, each of which would be a different color under “Basic Colors” to change the color of the restoration. The window 5104 also includes a grid of boxes under “Customer Colors”, each of which would be a different color. The user is also able to select the thickness of the stylus's writing point by selecting the “toggle” switch located next to the text field “Line” in window 5106 shown in FIG. 11H. After the restoration has been edited, the user may then select the “OK” button in window 5106 shown in FIG. 11H to apply the change, or select the cancel” button in window 5106 shown in FIG. 11H to cancel the editing function. After the “OK” button shown in window 1506 of FIG. 11H is selected, the tooth will appear in field 1504 with the edited restoration.

Following the selection of the tooth (teeth) from field 1504 shown in FIG. 4H, the user will then select the proper key containing the code from the windows 2102, 2104, and 2114 of the procedure window or pad 1710 shown in FIG. 4H, which represents the procedure/restoration to be associated with that tooth (teeth). At this point, all codes associated with and accessible via that key will be visible in the ledger box or window 2106 of FIG. 4H. The user will then select the appropriate code with the stylus (or mouse) followed by either the “ADD” button 2110, or the “DONE” button 2112 shown in FIG. 4H. The “ADD” button 2110 allows the user to add the treatment to an “intermediate ledger”, not shown in the drawings in memory 16 which allows the user to keep entering treatment with the procedure pad 1708 in a continuous fashion. For example, multiple procedures may be added to multiple teeth. The “add” button 2110 is typically selected between each separate entry. This keeps the keypad or procedure pad 1708 maximized as shown in FIG. 4H and all of the treatment being added would be posted to the intermediate ledger, not shown, which is simply keeping track of all of the entries. When the “DONE” button 2112 is selected, all of the “added” treatment will then be seen in the treatment plan ledger or window 1716 shown in FIG. 4C as part of the treatment plan, as well as on the teeth in field 1504 shown in FIG. 4H (typically when treatment icons are applicable).

A universal treatment entry module may be provided. The universal treatment entry module may be a super-imposable pad similar in form to the restoration pad no #1708 shown in FIG. 4E—and the procedure pad 1710 shown in FIG. 4H, with a ledger similar to 1716 shown in FIG. 4C-included. The user will be able to look at other programs, such as digital radiography, while still viewing either of these modules and the ledger. The user may make entries into this universal treatment module, which will enter treatment into the memory 16. The universal treatment module will work in other programs in the same “super-imposable” manner as the “treatment browser” not shown. The universal treatment module allows the user to deploy the above entry pads while the user is viewing another application (such as a digital radiography program). Upon re-entering a computer software program in accordance with an embodiment of the present invention, which can be called “casenote software”, the user will find all of this information present in the treatment ledger shown in 1716 shown in FIG. 4C and as images on the dentition, such as on window 1504 of FIG. 4H. The universal treatment module may essentially be the same or similar to the module shown in window 1704 of FIG. 4C. When window 1708a (restoration pad icon) is tapped, then window 1708 of FIG. 4E (maximized), and windows 1802 and 1804 will typically be displayed on monitor 12 by processor 10. When the procedure pad icon 1710a is selected, then FIG. 4H fields 1710, 2102, 2104 2114, 2106, 2108, 2110, and 2112 will typically be displayed on monitor 12 by processor 10.

The following is an additional description of a “clone” feature, referring to the “clone” button in the window 1706 of FIG. 4C, which was described previously above. Multiple Treatment plans in accordance with an embodiment of the present invention, include the ability for the user to “copy” treatment planned in an earlier treatment plan into the current plan. Upon the request to start a new treatment plan (in response to selecting the “clone” button in the window 1706), the user will encounter an interface, such as shown in window 4502 in image 4500 of FIG. 11B, which will list the entire content of a previous treatment plan the user has selected to clone. All choices will be “pre-checked” as a default, allowing the user to “deselect” those treatment choices which they do not want to carry over. After selecting, the user would select the “OK” button at the bottom of the clone interface or at the bottom of window 4502 in FIG. 11B. All of the selected treatment to carry over would appear in ledger or window 1716, and on the dentition images such as shown in window 1504 in FIG. 4C. This feature serves to eliminate the redundant entering of treatment which is similar in multiple plans. Also the Clone interface (ledger) in window 4502 in FIG. 11B, includes a “Swap” feature, which allows the user to replace posterior amalgams with the appropriate counterpart (composites) to give this common treatment option, without requiring the user to enter each restoration as composites. The result will be an additional treatment plan which will list the same exact teeth/surfaces which were treatment planned for amalgams, treatment planned for composites. This feature is enabled by checking a checkbox in the lower left hand corner of window 4502 of FIG. 11B (accompanied by the text “Replace amalgam restorations with composite restorations.”) The “Clone” feature and the “Swap” feature can both be used together to create treatment plan variations.

The buttons 1712 in FIG. 4C, include a “Notes” button, a “Details” button, an “Approve” button, a “Complete” button, and a “Delete” button. The “Notes” button when clicked on, along with one of the text entries (of any stage) in the treatment ledger or window 1716 will display notes associated with that procedure, on the screen of the monitor 12, and will give the ability to compose a new note via an “add notes” button 2406 shown in FIG. 7G. The “add notes” window 3300 shown in FIG. 7G is an important component which brings the user from the entry of “Completed work” in window 1706 of FIG. 4C to the composition of a case note (either manual or with the STATNOTE) through interface 3102 shown in FIG. 7E.

The “Details” button, of buttons 1712, when clicked on, prompts the “treatment details” interface or window 4702 shown in image 4700 shown in FIG. 11D allowing the user to (a) select a priority of that entry (from 1-10), (b) change a “planned by” treatment author if that treatment entry was planned by a different clinician than the clinician who appears in window 1706 shown in FIG. 4C, in the “By” field located under the “Plan” field, or (c) demonstrate that the procedure has been “referred out” to another practitioner. This status would then be shown in FIG. 4C, window 1716, under the “planned by” column with the words “referred out.” The “Approve” button of buttons 1712 of FIG. 4C, when “clicked” on prompts an interface which allows the front desk to convey the “insurance” approval status (whether or not that treatment entry has been approved by the patient's insurance provider) by asking “Has this procedure been approved by the patient's insurance.” At that point, the user will select “yes” or “no.” If “no” is selected, then the clinician's name (in the “planned by”—column in FIG. 4C, in window 1716) will appear in red text, and if yes has been selected, the clinician's name will appear in green text under the “planned by” column.

The “complete” button of buttons 1712 along with the selected “planned” text entries in the ledger or window 1716, when clicked on allow a user to compose a case note related to the procedure(s) which have been selected “highlighted” as completed, by automatically bringing the user to the “add notes” window or button 2406 of FIG. 7G. After the user selects the “add notes” button 2406 of FIG. 7G they will automatically be brought to the “add notes” interface or window 3102 shown in FIG. 7E, where they can enter a casenote(s) either manually (by selecting button or field 3104a or 3104b shown in FIG. 7E, to add a manual “ink” or text note, respectively (in the following note categories or fields: 3104, 3108 3110 3112) or enter a STATNOTE via the “add notes” interface or window 3102 of FIG. 7E, by “checking” off the checkbox which is adjacent to the STATNOTE “title or “header's” (3106 of 3102 shown in FIG. 7E) that they desire to use which has been pre-associated with that procedure (as shown in field 3104) All four of the major categories (Procedure, General, Anesthesia, Prescriptions) may have STATNOTES attached in the same fashion as field 3106 in this example. Within the “General” (field 3108), Anesthesia (field 3110) and Prescription (field 3112) headings (or categories), the user may additionally create “sub-headings”, where individual STATNOTES (which relate to those subheading(s)) may be grouped and remain unseen (hidden) until that subheading tab was maximized. This would facilitate a less “crowded” appearance in those four main categories when they are selected in the “add notes” interface.

The “Delete” button of buttons 1712 may typically only be activated when an “existing” or “planned” treatment entry in ledger 1716 shown in FIG. 4C is selected. When clicked on, it allows a user to delete the treatment entry highlighted and shown in window or ledger 1716. When a procedure has been completed and the user highlights it, only the following two buttons will appear for buttons 1712: the “notes” button which allows the user to view existing notes or add a note regarding that completed procedure, and (b) the uuncomplet”—button, which is seen in place of the “complete” button. Selecting the “uncomplete” button allows a clinician to change the treatment's status from “completed” back to “planned into the treatment plan in which it was first planned.” It will not erase any other information entered regarding the completion of that treatment, such as a case note.

The window 1714 in FIG. 4C will display the entire description of the selected dental procedure text entry listed in window or ledger 1716, when the text in 1716 is highlighted without selecting any of the buttons of buttons 1712. The window 1716 shows information regarding treatments including the date which the treatment was entered into the ledger or window 1716, the date the treatment was completed, status (existing, planned or completed), a “planned by” entry which shows who authored the treatment plan (such as a dentist), a plan name, tooth number(s), surfaces of a restoration (where applicable), and a dental code of the particular procedure. Information under the “plan”, “tooth”, “surface” (where applicable) and “Code” categories is typically “color-coded” (highlighted) in the color of its treatment status (Existing [blue], Planned [orange] and Completed [green]) to aid in the easy identification of the treatment status.

FIG. 4E shows an image 1800 for display on the screen of the computer monitor 12. The image 1800 is displayed when the “Treatments” field 1506 is selected as shown by the thick black box or highlighting 1702 surrounding the field 1506 and when the window 1708 has been selected. The selection of the window 1708 causes the fields 1708a-L shown in FIG. 4D to be enlarged and placed in the lower left corner of image 1800. The selection of the window 1708 also causes a window 1802 to be displayed. Various descriptions of procedures entered (by selecting a tooth (teeth) followed by the selection of materials/restorations/surfaces contained in buttons 1708a-1708L for window 1708 shown in detail in FIG. 4D, (as necessary) will typically automatically be displayed in the window 1802 shown in FIG. 4E, and typically will be clicked on by a user to enter that entry(s) into the treatment ledger or window 1716 shown in FIG. 4C.

The image 1800 includes a cancel button 1804 for canceling out of the window and proceeding back to the image or screen 1700 shown in FIG. 4C. Treatment entered by either the restoration pad or window 1708 shown in FIG. 4D or the procedure pad or window 1710 shown in FIG. 4H, will automatically be entered as “planned” work if all three of the treatment stages are “checked” in window 1706 in FIG. 4C, or if the “planned work” stage tab is checked alone. At this point, a colored icon, such as orange, may automatically be seen adjacent to the dentition image(s) in window 1504 to which that procedure has been planned for. To complete “planned” treatment after that point, any “planned” treatment entry in window or ledger 1716 generally must be selected, followed by the selection of the “complete” button of buttons 1712. At that point, the user will be taken to the “Add Notes” window or image 3300 shown in FIG. 7G, where the user may select the “Add Notes” button 2406, which will bring the user to the “Add Notes” interface 3102 shown in FIG. 7E where the user may compose a case note to document the procedure(s) completed.

If the “completed work” tab or box in window 1706, is checked alone, then the treatment will automatically be entered as completed, and the user will be brought to the “Add Notes” window or image 3300 shown in FIG. 7G where they may select the “Add Notes” button 2406 shown in FIG. 7G, which will bring the user to the “Add notes” interface 3102 shown in FIG. 7E, so that they may compose a case note entry to document the completion of a treatment. A corresponding “green” colored icon will typically be automatically placed (by a program running on processor 10 in accordance with an embodiment of the present invention, also called “casenote” software) adjacent to the dentition image(s) in window 1504 concerning which that procedure(s) has been completed on.

If the “Existing Work” tab of window 1706 is selected, any entries will be recorded as “existing” work, and may, in one embodiment, be automatically accompanied by a “blue” icon adjacent to the dentition image(s), such as in field or window 1504, of that procedure(s).

FIG. 4F shows an image 1900 for display on the screen of the computer monitor 12. The image 1900 is displayed when the Teeth field 926 is selected and the “Periodontal” field 1508 is selected. The field 1508 is selected in FIG. 4F, as shown by the thick black box or highlighting 1902 surrounding the field 1508. The selection of field 1508 causes the window 1904 to be displayed. The window 1904 includes button 1906, fields 1908, 1910, 1912, and buttons 1914 and 1916. The window 1904 further includes characters 1918, 1920, 1922, 1924, 1926, and 1928, whose functions are similar to characters 1412, 1414, 1416, 1418, 1420, 1422, and 1426, respectively, and were created by Microsoft (trademarked) for the tablet P.C. and allow for functions inherent to the tablet P.C.

The window 1904 further includes a pad or plurality of buttons or keys 1907. The pad 1907 includes keys for entering numbers 1-3 in the top row, 4-6 in the next row, 7-9 in the next row, and the number 10 in the fourth row. The last (fifth) row of the pad or keys 1907 includes a forward skip and reverse button, and a third button “0”. The window 1904 also includes a key or button 1906 which is the “start session”/“end session” key, and is used to activate the periodontal window interface or windows 1904 and 1504. To record the probing depths with their associated teeth/periodontal probing sites, key 1906 must be selected, in one embodiment, when it reads “start session.” At that point, a cursor will appear in the distal-most buccal probing box of tooth number 1 shown in window 1504. A “focus” or enlargement of the tooth in which the probing depths are being entered into, will also appear on the opposite side of the window in 1504 (for example, the focus for tooth 1, which is seen on the left side of the window, will appear on the right side. FIG. 11G shows a window 5004 of a “focus” or enlargement of tooth no. 1. This will allow the user to observe a dramatically larger view of that tooth being probed, as well as the numbers (probing values which are being entered) without obscuring the tooth in the normal dentition pattern. The user may enter the probing depths either manually via pad or window 1907 whereby each value will be entered by selecting the depth value (1-10 millimeters) on the pad 1907 with the stylus or computer mouse.

Key(s) or pad 1930 is typically a color pallet from which the user will select the appropriate color representing the notations/documentations which they make using a stylus after selecting character 1918. The user is also enabled to choose the “thickness” of the tip of the stylus from the drop down menu located by selecting the character 1928.

Field 1908 enables a “show history” function. When this feature is activated (by “checking” this checkbox) field or window 1912 will display each probing session (by date and clinician). Each session (and their corresponding depths) are displayed both, in field 1912, and in an expanded view (vertically) on the main dentition field or window 1504 shown in FIG. 4F. Each of these sessions will be differentiated by color-coded highlights. When the number of sessions in the show history feature are too numerous to be displayed in field 1912 and on the dentition screen or window 1504, buttons 1914 and 1916 will automatically become activated to allow “scrolling”. Field 1910, the “show depth feature”, allows the user to display teeth, from previous probing sessions, on the basis of their periodontal pocket depth. When the “toggle” function (arrow) for field 1910, is selected, the drop down menu displays the numbers 1-10. When the user selects one of these values, only teeth with at least one pocket depth(s) of that value or greater, will be seen on the dentition screen or window 1504 along with their measurements. This enables the clinician to view only periodontally affected teeth with unparalleled ease and effectiveness.

Periodontal notations can be made directly on the dentition image, window, or field 1504 with the stylus. Probing depths are entered into the periodontal grids adjacent to the dentition window 1504 in the usual and customary method, and are stored in the memory 16.

FIG. 4G shows an image 2000 for display on the screen of the computer monitor 12. The image 2000 is displayed when the “Teeth” field 926 is selected and the “Pathologies/Abnormalities” field 1510 is selected. The field 1510 is selected as shown by the thick black box or highlighting 2002 surrounding the field 1510. The selection of the field 1510 causes the window 2001 to be displayed on the screen of the computer monitor 12. The window 2001 includes buttons 2004 and 2006. The buttons 2004 and 2006, when clicked on, cause an ink (or handwritten) note image and a text note image, respectively, to be displayed on the screen of the monitor 12, allowing a user to enter various information. “Ink” and handwritten is used in the sense of a note written with a stylus into a tablet personal computer. The window 2001 includes characters or fields 2010 which have similar functions to characters 1918-1928 for the tablet PC previously described.

The window 2001 also includes a keypad 2012, which after selecting to write with the stylus, acts as a color palate. The window 2001 further includes a “Checkpoint” button 2008 for taking a “screenshot” of the dentition in window 1504 and notations of pathologies and/or “on the fly” treatment plans which have been written manually with the stylus into a tablet personal computer, made with the stylus at that moment, or prior moments which exist on the screen of the monitor 12 at that time, and saves the “screenshot” in memory 16. The “screenshot” is associated and accessible via the images tab or field 930 of FIG. 3A, under a “saved pathologies” heading, and is non-editable file in memory 16. The image is titled and dated upon it's being saved.

Selecting the field 1510 allows the user to write directly on the screen (with the stylus) in a myriad of colors/thicknesses/textures after activating the stylus writing function as described above. The user is also able to create a treatment plan “on the fly” by drawing the treatment directly on the dentition images or teeth in field 1504, using the universal dental symbols/nomenclature which have traditionally been used on paper charts. The user is also able to make “ink” (handwritten) or “text” notations, by first clicking on buttons 2004 and 2006, respectively, where they may detail pathologies, observations or compose a treatment plan. All entries are typically kept (as with all entries in a software program in accordance with an embodiment of the present invention) “read only” (non editable) and in chronological order in memory 16. The memory 16 may be comprised of multiple memory units, such as both a read only memory and a read/write memory. The header includes the date, time, author's name, sequence number, and entry description.

A “treatment plan” button can be added to field 2001 which when selected will cause a treatment planning “pad” to appear (in 2001 shown in FIG. 4G). This pad will have an infinite number of fields which will be in a “rectangular” form. They will be longer (right to left, than higher (top to bottom.) Each field will enable the user to record a treatment plan entry into it using wither the stylus (script) or keyboard.) Only one treatment entry should be recorded into each field. After all entries are entered into their respective fields, they will automatically be saved to memory upon closure of the chart. When the user desires to view the plan, they will select the “treatment plan” button once again. At that point, they will be asked if they would like to view the previous plans, or create a new one. If the user desires to view the current plan, it will appear (in field 2001 shown in FIG. 4G). Highlighting a field (by stylus or mouse) will cause the five buttons seen in window 1712 shown in FIG. 4C to appear. They will have the same functionality as in FIG. 4C. Each field which has documentations will be added to the “uncompleted treatment” report. When that report is selected (through button 906 shown in FIG. 3A) it will automatically show all of the “active” fields. Any documentations inside the fields will be seen at that time. Thus, this report will show all activated fields (and their content therein.) To enter treatment as “completed”, the user will simply select the field(s), then choose the “complete” button (as seen in window 1712 of FIG. 4C. That field will then appear “shaded” with a green color. To delete a procedure, the user should select the field of the entry to be deleted, then select the “delete” button which is similar to that in window 1712 shown in FIG. 4C. The “completed treatment” report (located in or activated through button 906 shown in FIG. 3A) will show all of the fields which have been entered as “completed” by the user in 4G.

FIG. 4H shows an image 2100 for display on a screen of the computer monitor 12. The image 2100 is displayed when the “Teeth” field 926 is selected, the “Treatments” field 1506 is selected, and the icon 1710a shown in FIG. 4C is selected. The window or procedure pad 1710, as previously described, as shown in FIG. 4H, includes windows 2102, 2104, and 2114. Window 2102 refers to full dentures and has up and down arrow buttons for activating all of the upper cells/lower cells respectively, after the user has either entered an extraction for an existing tooth (teeth) or the cells are empty. In total, all upper or lower cells, in one embodiment, typically must meet this criteria. After selecting either the upper or lower arrow button of window 2102, the cells will appear as highlighted (active) in dentition window 1504 of FIG. 4H, and all relevant codes for full upper/full lower dentures, such as Complete Denture-Maxillary D5110, for the upper arrow, will appear in window 2106. At that point, the user may select the code(s) needed to be entered followed by either the “add” button 2110, the “done” button 2112, or the “cancel” button 2108, to achieve the desired result.

Window 2104 refers to R.P.D (removable partial denture) and has up and down arrow buttons. To enter codes into the ledger or window 1716 in FIG. 4C and onto empty cells (or those cells with a “planned” extraction) in window 1504, such as shown in FIG. 11C, the user must “tap” on those cells which are to receive the treatment. For example, the user may tap on cell 4602a of empty cells 4602. When the arrows in window 2104 (representing upper partial denture/lower partial denture) are selected, all relevant codes (such as Maxillary Partial Denture D-5211) are displayed in window 2106. At that point, the user may select the code(s) needed to be entered followed by either the “add” button 2110 the “done” button 2112 or the “delete” button 2108 to achieve the desired result. The window 2114 includes nine keys which are named for, and contain the codes for general dentistry. These buttons are pre-set (to “Perio”, “Endo”, “Post/Core”, “Crowns”, “Surgery”, “MISC” (or “Favorites”), “Bridges”, “Veneer”, and “Preventive/Diagnostics”, however, they may be edited as described previously. The window 2100 includes window 2106 which displays all of the codes associated with and accessible via the button selected, and allows a procedure(s) to be selected for entry by tapping on it with the stylus. The window 2100 also includes buttons 2108, 2110, and 2112 for canceling, adding, and indicating that the user or operator is done with the form, respectively.

FIG. 5A shows an image 2200 for display on a screen of the computer monitor 12. The image 2200 is displayed when the “Exams” field 934 is selected as shown by the thick, black box or highlighting 2202 surrounding the “Exams” field 934. The image 2200 includes field 2204, window 2206, window 2208, and window 2210. Field 2204 allows a user to enter a category of alert, such as a “Medical” alert in this case, or a comprehensive oral exam (landmark pathology alert feature) by selecting the “toggle” switch or down arrow in field 2204. Window 2206 shows types of medical alerts which may include the following categories: “drug interactions”, “allergy”, “pre-medication required”, “pregnancy” and “other”. The latter would include any medical alerts which cannot be categorized by the preceding four categories. In this case, a drug interaction indication 2206a is shown highlighted by highlighting or black outline 2206b.

The “comprehensive oral” exam (landmark pathology alert) option shown in what FIG. 11A enables the user to select one of nine “pre-rendered” images shown in FIG. 11E in the “oral exam picker” of the oral and peri-oral anatomy. At that point, the clinician is able to “recreate” the lesion/condition/abnormality using the stylus in a variety of colors, and textures. The user is also able to enter radiographs and photos, by selecting button 2208d in field or image 2200 shown in FIG. 5A. The user is further enabled to add an “ink” or “text” note corresponding to this entry by selecting either field 2208b or 2208c, respectively.

Upon each subsequent opening of the patient's chart, i.e. window 4400 FIG. 11A all “alert” information will be the first window evident as an alert which will appear in the “alert sentry”, window number 4400 FIG. 11A (until it is deactivated). The clinical user must “acknowledge” all alerts, otherwise the chart will remain as “read-only” If the “landmark Pathology Alert has not been deactivated after 14 days of it's creation, it will appear to all users upon login. This will ensure that a potentially fatal or destructive lesion/abnormality/condition is either properly treated or referred.

Window 2208 allows various information to be entered concerning the particular medical exam. Window 2208 includes text 2208a and buttons 2208b-d. Buttons 2208b-d allow an ink note, a text note, and an image to be added to the particular exam record, which would then be stored in memory 16 of FIG. 1. Window 2208a requests that the clinician add any information relative to the alert. Windows 2208b and 2208c enable the user to add an “ink” note or a text note, respectively, which will appear when the alert is seen in the alert window 2308 of image 2300 of FIG. 5B upon opening of the patient's chart. Window 2208d allows the clinician to “attach” an image (form) to that alert which may request that the patient “sign-off an important information regarding the alert. Window 2210 includes text 2210a, an entry field 2210b regarding alert, and a field 2210c for entering various information. Window 2210a is the “heading” of the “ink” or text note added to the alert. It contains a sequence #/Date/Time/Clinician. 2210b is the “causes alert” activator, which ensures that the alert will be seen upon the opening of the chart, shown in window 2308 of image 2300 of FIG. 5B. All alert conditions are activated (automatically) by default. 2210c is where the “ink” or text field will appear which is to be written on.

FIG. 5B shows an image 2300 for display on the screen of the computer monitor 12. The image 2300 is displayed when the “Alerts” field 922 is selected as shown by the thick, black box or highlighting 2302 surrounding the “Alerts” field 922. The image 2300 includes text 2304 and 2306 and entry fields 2304a and 2306a. Fields 2304 and 2306 indicate the type of alert. FIG. 11A shows a screen shot of an “alert” window. FIG. 11A shows the “landmark pathology” image and documentation (window or fields 4406 and 4408, respectively) and the medical alerts or fields 4410 and 4414). The “Medical history update” or window 2300 (and window 4400 in FIG. 11A) is always seen at the opening of all patient's charts, as shown in FIG. 5B. The entry fields 2304a and 2306a shown in FIG. 5B 2300 and FIG. 11A 4400 can be checked to acknowledge the alerts. Upon “checking the box(s), the alert will then be considered as acknowledged. At this time, the attached “form” will also automatically be prompted from the patient to fill in the appropriate information as well as give their signature. The clinical user will then have full access to the patient's total chart, including treatment entry, and completion, Clinical case note documentations, “medical” and “Pathology” alerts entry, dentition set-up, periodontal entries etc. shown in FIG. 3C-9D. The image 2300 also includes field 2308 which is where all information concerning the alert, such as the “ink”/text notes and images (pre-rendered/radiographs/photos) will be seen.

Medical health complications or alerts, allergies, current medication or conditions noted in the medical/dental health history questionnaire filled out with reference to FIG. 3F window 1408 (medical dental history form as well as any new conditions noted in the “medical history update”) should be entered into the “Sentry Alert”.

FIG. 5C shows an image 2400 for display on the screen of the computer monitor 12. The image 2400 is displayed when the “Notes” field 932 is selected as shown by the thick, black box or highlighting 2402 surrounding the “Notes” field 932. The image 2400 includes entry field 2404, button 2406, text 2408, maximizing button 2408a, text 2412, maximizing button 2412a, text 2414, text 2416, text 2418, entry field 2420, magnification indication 2422, pages of total number of pages indication 2424, and character buttons 2426, 2428, 2430, 2432, 2434, 2436, 2438, and 2440, The character buttons 2426-2440 are inherent to the tablet p.c., and similar to buttons 1412-1426, shown in FIG. 3F. The image 2400 also includes a form 2442 which in this case is a medical history form.

Entry field 2404 allows a user to select which notes they would like to view. For example, the user may view “All” notes, notes pertaining to completed treatment, notes pertaining to planned treatment, and notes pertaining to existing treatment. In FIG. 5C, “All” for all notes, has been entered in FIG. 5C. Furthermore, the user is able to select from each case note entry as per tooth number or restoration with this function. Button 2406 enables the user to add an “ink” (handwritten) or text casenote as a “general” case note entry. Text 2408 and Text 2412 are the headings seen in the casenote for alert acknowledgements. They have the sequence number/the date/time/clinician and the type of alert acknowledged. They are typically displayed in red to distinguish them as medical alert casenote headings. Buttons 2408a and 2412a are the maximizing buttons for acknowledged alerts. Upon clicking” either of buttons 2408a and 2412a, the original alert, notes and signed acknowledgement forms will be evident or displayed on the screen of monitor 12. When either of buttons 2408a or 2412a are clicked again, all of the information regarding the alert will be minimized, showing only the red heading 2408 or 2412 as before maximizing. Text 2414 shows the header of the original “medical history update” form after this form has been maximized. The text 2414 is mostly obscured by 2442 (the medical history form) which is also maximized. Please note that typically the controls 2426-2440 are deactivated as all forms are typically read-only after they are saved.

FIG. 5D shows an image 2500 for display on the screen of the computer monitor 12. The image 2500 is displayed when the “Images” field 930 is selected as shown by the thick, black box or highlighting 2502 surrounding the “Images” field 930. The image 2500 includes buttons 2504 and 2506. Buttons 2504 and 2506, when clicked on, allow an image to be added or deleted, respectively, from or to any of seven fields. The images are stored in memory 16, but are associated or accessible via one or more of the seven categories, tabs, or fields. The categories are X-rays, oral photos, information forms, medical forms, scanned charts, portraits and miscellaneous documents, and appear in the left hand column window. The user will be able to “scan” all hardcopy documents kept in a traditional paper chart into each of these categories, where they will be saved as non-editable to the memory 16, referring to a particular patient, which in this case is “Dorothy Smith”. After being added, an image may typically only be deleted in that session. This means that once a patient record is closed, any information scanned so that it is associated with this tab, or images 930, will-be non-deletable from the memory 16. The image 2500 also includes window 2508. Date, file, pages, and description information can be entered in window 2508 under the appropriate headings, referring to the particular image. This information is then stored in memory 16.

The window 2500 also includes entry field 2512 into which a description of an image can be entered. The window 2500 also includes magnification indication 2514, pages of total pages indication 2516, and a plurality of character buttons 2518 whose function is similar to character buttons previously described for FIG. 5C.

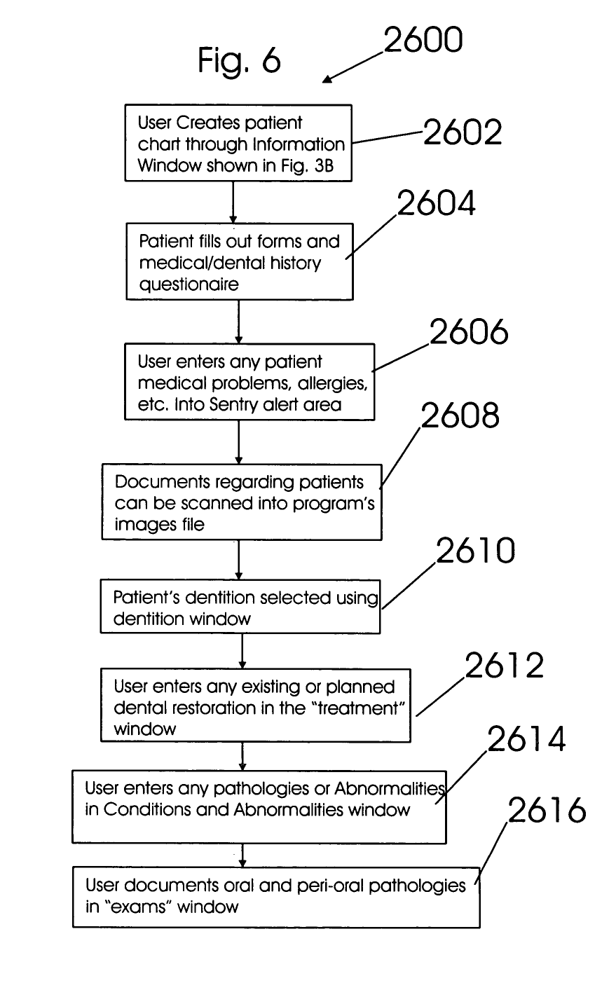

In operation, an embodiment of the present invention provides a method as shown by a flow chart 2600 in FIG. 6. At step 2602 the user or operator creates a patient chart by providing the requested information into the patient information page or window 1001 as shown in FIG. 3B (only name and gender is required to create a patient chart). A patient photo may be entered in the information page of FIG. 3B, but is not required. At step 2604 the patient fills out electronic HIPAA forms and a medical/dental health history questionnaire as shown for example in FIG. 3F, or if the user prefers, the patient may fill out “paper” hardcopy forms which may be scanned into the memory 16 and associated and accessible via the “images” field 930. At step 2606, the user enters any patient medical problems, allergies, etc. into memory 16 and this becomes associated and accessible via a sentry alert area, as shown for example in FIG. 5A for the “exams” tab or field 934. Medical alerts should be entered into memory 16 so that they are accessible and associated with the “medical” field 2204 (as seen in FIG. 5A). At step 2608 all hard copy documents in a patient's existing chart may be scanned into memory 16 and associated and made accessible via the images field 930 where they will typically remain as read-only images. At step 2610, the patient's dentition can be selected by a user using the “dentition set-up” window or window 1604 shown in FIG. 4B and FIG. 11C. At step 2612 the user enters any existing or planned dental restoration using the treatment window 1706, 1708 and 1710 in FIG. 4C. At step 2614 the user enters any pathologies or abnormalities of the oral cavity which are evident radiographically or upon clinical exam in the “Pathologies/Abnormalities” window 2001 in FIG. 4G. At step 2616 the user documents any oral and peri-oral pathologies on pre-rendered anatomical images/photographs/radiographs using the stylus (ink technology) in the “exams” window (the user should select “comprehensive oral” from the drop-down menu in field 2204 to view these “pre-rendered” images) shown by FIG. 5A. This information will be evident in an alert which will appear upon the opening of the patient's chart in the “sentry window” 2308 of FIG. 5B and as seen in 4404 FIG. 11A, each time window 1001 of FIG. 3B, is opened (until it is deactivated.) If it has not been deactivated after fourteen days, it will appear to all users upon login.

Entry of completed work is accomplished by highlighting the treatment listing(s) in the treatment ledger or window 1716 in FIG. 4C followed by selection of the “complete” button of buttons 1712 in FIG. 4C. At this point, the user is automatically brought to the “Add Notes” window or image 3300, such as shown in FIG. 7G. The user is able to add a case note by selecting the “add notes” button 2406 shown in FIG. 7G, which will bring forth the “Add Notes” interface 3102 in FIG. 7E and then selecting to add a new note “manually” in “ink” or “text” or by an available STATNOTE header in window 3106 of FIG. 7E, followed by button 3116 shown in FIG. 7E which will bring forth an interface or screen which can be called the STATNOTE interface or window 3202, shown in FIG. 7F. The STATNOTE interface or window 3202 will present a “templated” case note where only variables and exceptions need to be added. All case notes typically will be preserved as non-editable and in chronological order.

After initial creation of a patient chart such as through window 1001 in FIG. 3B, each time that a patient chart is opened by bringing up image 900, by selecting the patient's name from the main patient list (1117 FIG. 3C) and by thereafter selecting any of the fields 922, 924, 926, 928, 930, 932, 934, and 936 for patient information, the user will, in one embodiment of the present invention, always receive restricted access to patient information (adding notation and treatment plans), and will be unable to make any additions without acknowledging the following: Health history update (patient verification required), and any “sentry” alerts. This is true unless the feature is de-activated by the administrator and any medical or “landmark pathology” alert entered into the “sentry alert” (as per steps 2606 and 2614 in the method of FIG. 6), including those requiring patient verification forms to be filled out and signed.

The computer software, method, or process in accordance with one or more embodiments of the present invention may be used for applications which involve any recording, organizing and archiving of data. Additional areas include other healthcare fields and inventory/stock applications.

Variations of a dental electronic patient record or computer software program in accordance with an embodiment of the present invention, may include: a program which has an associated practice management component; a program with different modes of entry for progress notes; deletion of dental codes, icons, images—replaced by those from other healthcare disciplines such as medicine (general practice and all specialties, chiropractics, optometrics, veterinary, podiatry, physical therapy).

The sentry alert feature shown by FIG. 5B (FIG. 5A for the input of medical alert information) provides unparalleled protection for both the patient and clinician against human error and negligence. A stylus may be used to fill out all forms (in script). After a patient completes their initial comprehensive medical health history form provided in this software program, the clinician will enter any existing medical conditions, allergies, medications that the patient is taking, etc. by setting up appropriate alerts within the sentry by using fields in image 2200 shown in FIG. 5A. Each time that patient is seen, upon the opening of their chart the user will have access to all windows shown in FIGS. 3A-12B. The user is required to “acknowledge” the alert by “checking” fields 2304a and 2306a in FIG. 5B and taking appropriate actions. A “medical history update” alert, which is window 2306 shown in FIG. 5B, is displayed upon the opening of every patient chart, each time they are opened. The patient must fill-out and sign auto-default forms (which may be part of an embodiment of the present invention software) and the forms may be entered into the computer program and/or into memory 16 by the user (via scanning or custom request to a computer software company servicing the computer software program or by creating their own electronic forms by using the present invention). The company servicing the computer software program may provide unparalleled documentation for the following alerts: medical history update verification of pre-medication, consent to treat a minor, consent to treatment, laboratory reports or any types of forms used in everyday practice scenarios.

Forms which may be electronically stored in memory 16 in accordance with one or more embodiments of the present invention may include: HIPAA Notice of Privacy, Practice, Medical and Dental history, Treatment Plan proposal, Method of Payment, and Treatment Consent Forms.

The user may scan in and add any forms that he or she wishes, and then set up an alert which will be associated to them by attaching a form (image) to an existing alert (FIG. 5A, 2208b) or by creating a new alert condition in either the existing “medical” or “comprehensive oral” alerts categories (such as through field 516 of image 500 shown in FIG. 2E) and creating a new “condition” or, by creating an entirely new category of exams (in addition to “medical” and “oral comprehensive” (field 504 in window or image 500 shown in FIG. 2A). A form may be attached to these new conditions and/or exams by selecting the window 600 of FIG. 2F, and an “add form” option (button 608 when the “alert form” button is selected (next to button 602)), then the Add field or button 608 (and an image may be attached from a computer hard drive which may be part of memory 16). Once these forms are filled out and entered, they may be stored in memory 16 as non-editable, time stamped and dated, and may be archived or associated with, or accessible through both the note or case note field 932, and the image section through field 930, as shown by window 2400 in FIG. 5C (casenote) and FIG. 5D (in the appropriate category [exam acknowledgement forms] in the left hand column. These forms are legally binding documents. The Sentry feature is also correlated to the Landmark Pathology function. FIGS. 11E and 11F show where the landmark pathology alerts are entered, and windows 4406 and 4408 in FIG. 11A show where the landmark pathology alert shows up when the chart is opened

The landmark pathology function shown by FIGS. 11E and 11F is another feature of one or more embodiments of the present invention. There are typically nine pre-rendered images of the oral peri-oral anatomy which may be located in the nine boxes in window 4802 of image 4800 of FIG. 11E, which may be drawn-on with the stylus to illustrate any pathology, abnormality or condition. After the user makes the appropriate documentations on the images, the documentations are saved to memory 16 so that they are accessible via tab or field “images”. The documentation is accessible in the through the “images” window in FIG. 5D, in the left hand column under the category named “oral exams” and in the “Exams” window shown in FIG. 5A when field 2204 is set to “comprehensive oral”. Each time the patient's chart or window 1000 shown in FIG. 3B is opened after the alert is entered, in field 2308 of FIG. 5B, the alert is seen in the “Sentry” alert window shown in FIG. 5B, and must be acknowledged to gain full access to the patient's chart (including making clinical notations/entering treatment).

If the alert is not de-activated after a period of fourteen days (from it's initial entry) an alert box, not shown in the drawings, is seen upon all users logins which reminds all users that the alert has not been deactivated. De-activation should occur due to referral for further treatment, disappearance of the lesion (entity), treatment and/or resolution of the lesion or confirmation that lesion is non-pathological and requires no treatment.

A computer program in accordance with an embodiment of the present invention also provides dentition set-up as shown in FIG. 4B and FIG. 11C. The processor 10 sets up a representative dentition and displays it on the screen of the monitor 12 using the computer program's dentition images, which may be stored in memory 16.

The treatment entry window 1704 shown in FIG. 4C allows for entry of existing dental work and planned treatment work including multiple treatment plans. The universal treatment entry module, not shown in the drawings, allows a user to enter treatment while viewing another application, such as a digital radiography application. One embodiment of the present application also provides an in-line display, not shown in the drawings, of a radiograph/image/photo within the final, non-editable case note entry.

A voice activated dentition set-up, existing dental work entry, treatment plan entry, and periodontal examination, not shown in the drawings, may also be enabled by a computer software program in accordance with one or more embodiments of the present invention, which may be called “Casenote” software. An associate compensation calculator may calculate the percentage of a dental associate's production.

One embodiment of the present invention may provide an electronic consent form through image 1300 of FIG. 3E. Such a form or forms may cover any procedures which place a patient at risk or have an irreversible result. Such procedures may include extractions, root canal therapy, periodontal surgery, implant surgery, final processing (dentures), and in-office whitening.

One embodiment of the present invention may also provide reports by clicking on the practice tab or field 906 shown in FIG. 3A. Such reports may include referred treatment, planned treatment (by type/provider/date/coverage), completed treatment (by type/provider/date/coverage), lapsed patient's report, three and four month recall STM (Soft Tissue Management) alerts staff when these patients are overdue for their three or four month recall visits, apprehensive patients, lab cases—this report will show date out, expected date of return, cost (pre-associated in grid) and the laboratory, monthly lab expenditures, orthodontic patients, tooth shade, uncompleted patients, and production forecaster.

Further reports may be provided by clicking on the practice tab or field 906 of FIG. 3A such as auto default of common appt. time upon cancellation (to fill in that cancelled time interval), T.M.J.D. (Temporal Mandibular Joint Dysfunction), edentulous patients, periodontal disease, three and four month soft tissue management report, demographic—by zip code/area code and exchange, high caries index, and emergency patients. Emergency patients criteria is for patients who present to the office when in need of emergency treatment only. The emergency patient is typically not an active patient who presents for routine recalls/preventive dentistry.

Further reports may be provided concerning transient patients. Transient patient reports may include a report of any patient who presents for treatment, who is visiting the area and who resides at a location which is typically too far to be that of an active patient. Other reports may include an age report—the user will be able to set this criteria. This report will help determine the age of the patient population. Further reports include occlusion classifications—I, II, III, all divisions, cross bites, open bites etc, apicoectomy—patients who have had apicoectomy treatment, and symptomatic tooth/sedative filling—those patients who, at the last visit, have complained of a symptomatic tooth or have had a sedative filling placed into a deep preparation or a symptomatic tooth.

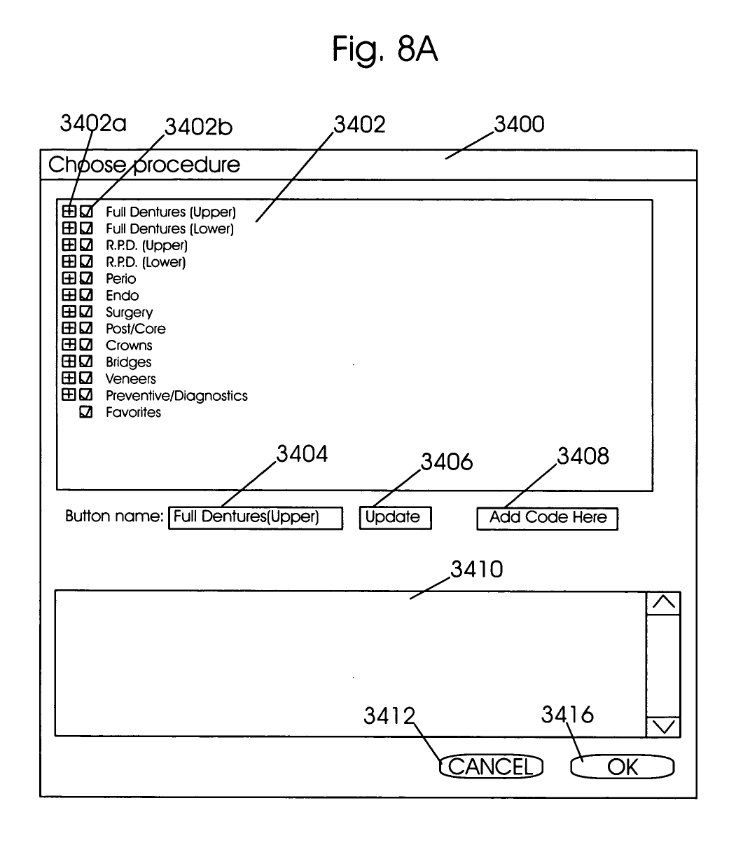

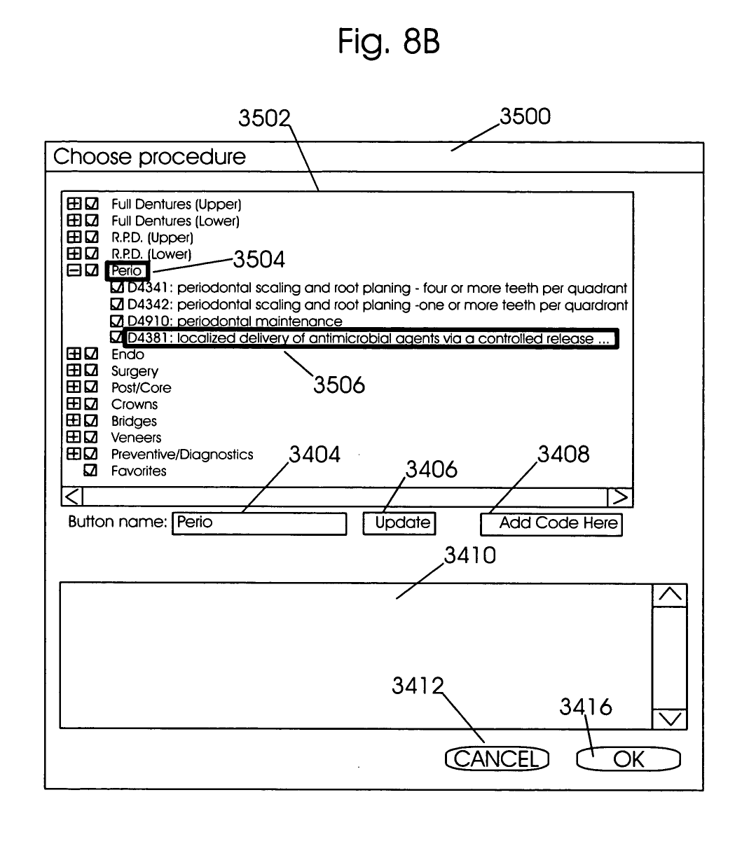

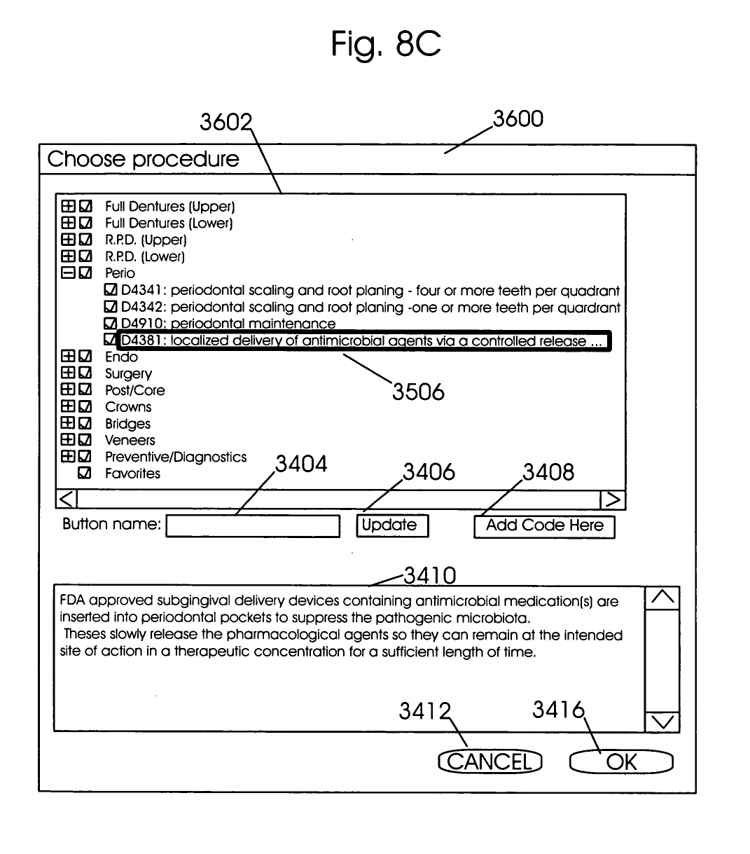

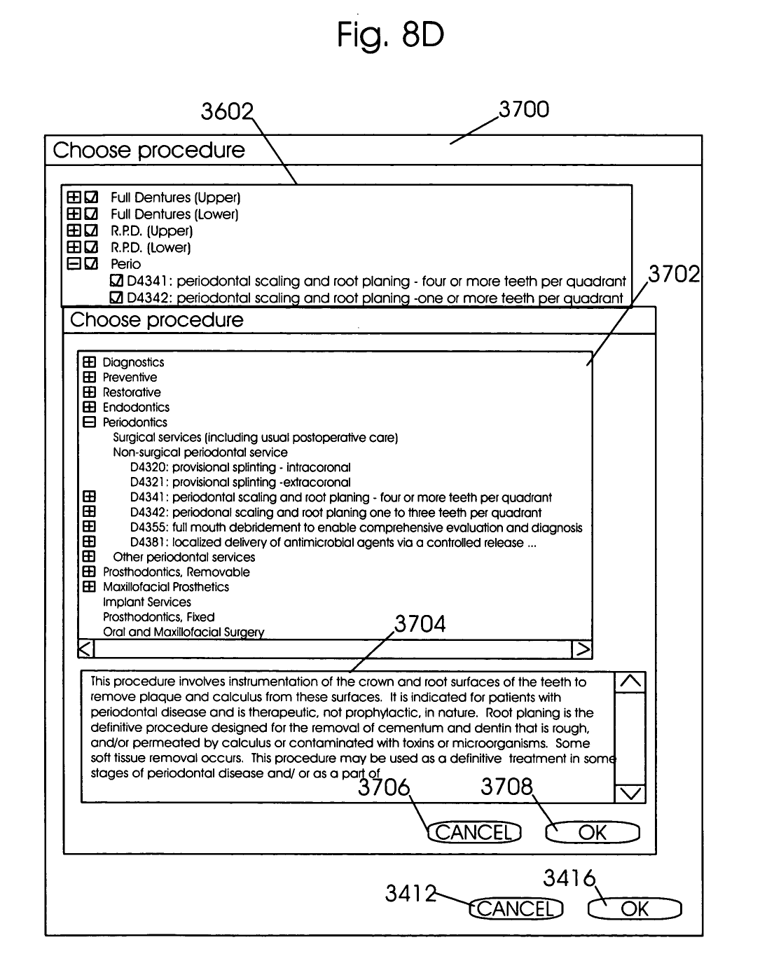

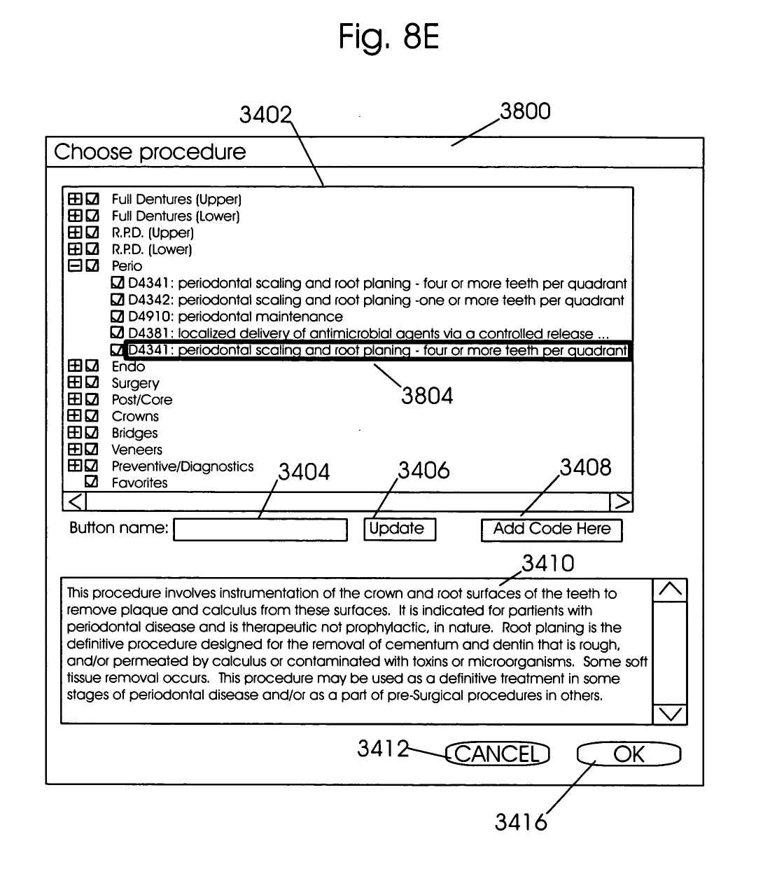

FIG. 7A shows an image 2700 which can be displayed on the monitor 12 of the apparatus of 1 of FIG. 1. The image 2700 can be called the “Edit STAT-NOTES” interface as shown by a title 2702. This may be typically where a user can compose a status note or “STATNOTE” (case note template.) The image 2700 includes a link or field 2704 which can be selected to allow a user to write a “STATNOTE” or case note, template, and to attach the status note to a major C.D.T. category (such as “Diagnostics”, “Restorative”, “Endodontics” or “Periodontics”), a sub category (such as Surgical services, Non-Surgical services [Periodontics] [as seen in window 3702 shown in FIG. 8D), amalgams or endodontic retreatment, or a single dental procedure in the CDT list (such as D4320, D4321 or D4341). After these associations have been made [between STATNOTE template and major C.D.T. category, C.D.T. sub category or individual procedure] the STATNOTE(s) associated will appear in the “ADD NOTES” interface or window 3102 in field 3106 in FIG. 7E under the procedure header bar 3104 upon it's opening using field 3104d, when a procedure matching the criteria of the major C.D.T. category, C.D.T. sub-category or individual C.D.T. code is entered as completed. A user should click on one of buttons or fields 2708d, 2710d, or 2712d to open the respective categories to view a stat note “title” or “header(s)” which has been composed and associated or attached to that category. At that point, the user may select the “name” or “title” of the STATNOTE and view it, edit it or delete it. The user may then select the button(s) 2708d, 2710d, and 2712d again, to close their respective category.

The image 2700 also includes fields 2708, 2710, and 2712 concerning general, anesthesia, and prescription case note composition interface categories, respectively. Each includes a link for creating a new inkable note, a new ink note, and a new text note: fields 2708a-c for general, fields 2710a-c for anesthesia, and fields 2712a-c for prescriptions. Each of the “new inkable note” fields allows a user to write an inkable STATNOTE (template). “Inkable” generally means moving a stylus over a tablet personal computer with a handwriting type motion to enter data, but typically does not involve physical ink. This is where the template or “STATNOTE” is written and displayed by the monitor 12 in text in the case of an “inkable note”, and then the user is able to hand write in (using a stylus on a tablet personal computer or devices allowing “ink” technology) changes or additions in window 3202 of FIG. 7F. Each of the “new ink note” fields allow the user to write a status note or STATNOTE template in handwriting or script. The user can then write changes or additions into a status note or STATNOTE in script or handwriting in field 3202 shown in FIG. 7F. Each of the “new text note” fields allows the user to write a status note template in “text”, i.e by typing into the keyboard of the interactive device 14. The user can then input changes or additions into a status note in text in field 3202 of FIG. 7F.

The image 2700 includes button or field 2714 which can be clicked on to cancel the interface or image 2700, and button 2716, which can be selected to save the status note or STATNOTE (case note template) note, and the association with it's category, sub-category or individual procedure just created, to memory 16 and/or to the computer program in accordance with an embodiment of the present invention. The image 2700 includes tablet personal computer characters 2706 similar to characters previously described.

FIG. 7B shows an image 2800 which can be displayed on the monitor 12 of the apparatus 1 of FIG. 1. The image 2800 includes fields 2706, 2708, 2710, 2712, 2714, and 2716 as previously described in FIG. 7A. The image 2800 also includes a window 2802 (containing the complete list of C.D.T. codes) for choosing a major category (such as “Diagnostic, Preventive or “Restorative”) a sub-category (such as “pulp-capping” or “pulpotomy”) or an individual procedure (such as D3310, D3320 or D3330), to “associate” or “attach” with or to a STATNOTE (case note template) which will be composed in window 2904 shown in FIG. 7C. After the case note template or STATENOTE is composed, whenever a procedure(s) is completed, which matches the above “associated criteria”, the STATNOTE template will be available in the “ADD NOTES” interface 3102 of FIG. 7E as field 3106 under the procedure header bar or field 3104 of FIG. 7E, upon it's opening using 3104d, to add notations and variables to, or edit the template content. After which, the user may enter the augmented STATNOTE (case note template) into the final “non-editable case note section.

The window 2802 includes a list of terms in CDT (current dental terminology) including various dental codes used in the United States of America. The categories shown closest to the left hand side of the window 2802 (such as “Diagnostic”, “Preventive” etc.) are the major categories. The items shown with a first indentation, such as “Pulp capping” are sub-categories. The items shown with a second indentation, such as “D3310 . . . ” are individual procedures. Whenever field 2704 is selected in FIG. 7A, a general list such as the CDT list, such as shown in window 2802 of FIG. 7B may be displayed. The user selects field 2704 when the user wants to write a STATNOTE (casenote template) and associate or attach it to a major category, sub-category or procedure belonging to the C.D.T. codes, in memory 16. The title of that status note will then be seen in an “Add Notes” interface, such as shown in FIG. 7E, 3102, 3106, after that procedure(s) (if for a single procedure) or a procedure(s) within the main category or sub-category to which the STATNOTE has been “associated with” or “attached to” has been completed. The image 2800 also includes a window 2804 (which shows the description of the C.D.T. main category, sub-category or individual code highlighted or selected by the user), and cancel button 2806 for exiting out of window 2802 without saving and the OK button 2808 for saving user's choice of category, sub-category or procedure to associate with (or attach to) a STATNOTE (casenote template) that will then be composed. As noted above, after the STATNOTE is composed, and named by clicking in field 2904b shown in FIG. 7C, button 2716 should be selected to save the information to memory 16.

FIG. 7C shows an image 2900 which can be displayed on the monitor 12 of the apparatus 1 of FIG. 1. The image 2900 includes fields 2706, 2708, 2710, 2712, 2714, and 2716 as previously described in FIG. 7A. The image 2900 also includes fields 2902a, 2902b, and 2902c which are provided for entering appropriate notes regarding the procedure shown in field 2902. The image 2900 also includes fields 2904a, and 2904b “Name this STATNOTE field. When field 2904b is clicked upon, the user is able to enter the name of the status note (case note template) seen in field 3002a of FIG. 7D. The field 2904c is a “checkbox” which is automatically selected by default. When the field 2904c is checked, it means that the STATNOTE is “active”. The STATNOTE will appear as an option when an associated procedure is completed (as seen in window or field 3106 of FIG. 7E). This occurs when the procedure header for 3320 is opened, by a button, not shown in the drawings, in that row similar to button or field 2708d shown in FIG. 7A, upon completion of procedure 3320. Button 2904d allows the maximizing and the minimizing of field 2904. The image also includes window 2904. This is the field where the STATNOTE template will be composed.

In FIG. 7C, a single dental procedure “D3320: . . . ” has been selected and the title of that procedure appears at the top of the case note template or “STATNOTE” creation field 2902. The field 2904c is checked by default and unchecking it by clicking on it, deactivates, but does not delete the case note template or STATNOTE. The field or button which is the same as 2708d, 2710d and 2712d in FIG. 7A (or field 3104d in FIG. 7E) maximizes or minimizes the status note entry platform or window 2901 for the selected procedure, which in this case is “D3320”. The button 2904d minimizes and maximizes field 2904 in FIG. 7C (the field where the STATNOTE content will be composed.

The user can enter a title for a status note by selecting the field 2904b. The user can enter template information for the STATNOTE in field 2904. In FIG. 7D the user has only associated (or attached) procedure D3320 (3002a) to the “EDIT STATNOTE” interface. The user may now select one of the three options: fields 2902a, 2902b or 2902c to compose the STATNOTE (case note template) in field 2904. In FIG. 7D, the user has selected to compose an inkable note, a text template which is annotated in the field 3102 of FIG. 7E or the field 3202 of FIG. 7F by the stylus using “ink” technology. The text template has been created. The user can use a stylus to actually hand write into window 3102 shown in FIG. 7E when procedure 3106 is opened using button 3111a in FIG. 7E, or in fields 3202a-k of window 3202 of FIG. 7F, and also anywhere on the fields occupying 3202a-k, window 3202 as displayed on monitor 12. The arrow or control 2905a increases the writing field 2904 vertically if the user taps on it with the stylus to allow a greater amount of content to be hand written in field 2904. Note that if the user has selected field 2902b in FIG. 7D (compose an “ink” STATNOTE (case note template), this is generally the only case where the stylus would be able to be functional in window 2904. The stylus would, of course be functional in the field comparable to window 3202 of FIG. 7F (which would contain the “ink” template as described above) as well as in the resulting field if the user selected field 3104a shown in FIG. 7E to add a new “ink” note without using a template STATNOTE.

When the field or window 2904 reaches the bottom of the window (i.e maximum size on the screen of monitor 12), a scroll bar 2907 (including up and down arrows) can be used to control the vertical field of view. A scroll bar will also show up in field 3004 of FIG. 7D, as well as in window 3202 shown in FIG. 7F, when button 2905a is tapped on until those fields reach the bottom of the window.

FIG. 7D shows an image 3000 which can be displayed on the monitor 12 of the apparatus 1 of FIG. 1. The image 3000 includes fields 2706, 2708, 2710, 2712, 2714, and 2716 as previously described in FIG. 7A. The image 3000 also includes an indication 2902 of a selected procedure, in this case “D3320: bicuspid (excluding final restoration)”. The image 3000 also includes field 3002a which shows the STATNOTE (case note template) name or title. The window 3004 shows a completed template “inkable note” STATNOTE (casenote template). A user can click on an “OK” button 2716 to save this “inkable note” STATNOTE (casenote template) and attach it to the information about the particular dental procedure in memory 16. If the user had selected a major category or sub-category from the CDT list in field 2802 shown in FIG. 7B, then the STATNOTE in field 3004, would have been attached and saved to memory 16 in the same fashion.

FIG. 7E shows an image 3100 which can be displayed on the monitor 12 of the apparatus 1 of FIG. 1. The image 3100 includes the fields shown for image 900 in FIG. 3A. The image 3100 also includes window 3102. The window 3102 is titled “Add notes” and shows a dental procedure identification and tooth number identification in field 3104. The window 3102 also includes links 3104a and 3104b for adding a new ink note or handwritten note and new text note via a keyboard of interactive device 14, respectively. The window 3102 also includes fields 3108, 3110, and 3112 for opening the respective categories as field 3104 is opened due to the selecting of 3104d. When these buttons are selected, fields 3104a and 3104b will be seen on the screen of the monitor 12, as well as any STATNOTE titles (in order of preference from top to bottom) of those STATNOTES (case note templates) attached to that selection.

The window 3102 also includes fields 3114 for canceling out of window 3102 and 3116 for advancing the STATNOTE(s) chosen by “checking” field(s) 3106 of those STATNOTE (case note template(s)) or the “ink” or text notes that were composed by selecting 3104a or 3104b, respectively, to be in the final case note, to the “Confirm Note” window in window 3202 of image 3200 shown in FIG. 7F. The user may “view” the actual STATNOTE(s) (case note template) in FIG. 7E, contained under field 3104 by selecting button 3111a in FIG. 7E and then button 2905a shown in FIG. 7C.

After the dental procedure: “D3320: bicuspid . . . ” is entered as completed by a) highlighting the procedure shown in field 1716 of FIG. 4C, and selecting the “complete” button from window or field 1712 (for a planned procedure(s), or by b) selecting only the “completed work” checkbox in field 1706 of FIG. 4C, followed by the “done” button 2112 shown in FIG. 4H, for the procedure pad or c) by tapping the selected entry's code description in field 1802 of FIG. 4E for the restoration pad, the user is brought to the “Add Notes” window shown in FIG. 7G. The user will then select button 2406 shown in FIG. 7G, which will bring them to the “Add Notes” interface 3102 shown in FIG. 7E. The user may choose from any of the following four categories: general, anesthesia, prescriptions, or the procedure D3320 category, by selecting with the stylus one of buttons 3104d, 3108a, 3110a, or 3112a, respectively. In the event of multiple procedures being entered as completed all of their procedure codes and descriptions would be seen in the categories (title bars) along with the tooth number(s). The user may add notations in this window, by maximizing the STATNOTE field or button 3111a shown in FIG. 7E, and button 2905a as seen in FIG. 7C.

The user can check the box next to the field 3106 which will select the STATNOTE (case note template) corresponding to the title adjacent to it, in this case “Bicuspid RCT Finish”. After this the user should then select the “OK” button 3116, which will bring the STATNOTE to the confirm note window (maximized) 3200 shown in FIG. 7F where the user may add notations and verify all entered changes or additions before the status note is committed to the final “non editable” case note stored in memory 16.

The window 3102 in FIG. 7E includes down and up arrows 3107 which can be used to adjust the order of appearance of multiple STATNOTE titles, in a top to bottom hierarchy, if multiple status notes exist under a category. The window 3102 in FIG. 7E also includes “X” button 3109a which will delete the current STATNOTE. The window 3102 in FIG. 7E also includes a “+” button 3111a which will maximize and minimize the corresponding STATNOTE annotations which may be made on the STATNOTE (casenote template) at this point by selecting button 3111a, and adding the notations in the proper medium (“Ink” or “text”.)—Button 2905a may also be used to view the entire STATNOTE (casenote template) by increasing the field on which the STATNOTE template resides upon it's maximization.

FIG. 7F shows an image 3200 which can be displayed on the monitor 12 of the apparatus 1 of FIG. 1. The image 3200 includes window 3202 (which is displaying an “inkable note” STATNOTE (case note template) for entering handwritten notations. Handwritten notations, such as handwritten notations 3202a-3202k, have been entered into the window or form 3202, and are stored in memory 16, after the OK button 3204 is selected. The image 3200 in FIG. 7F is also called the “confirm note” window and is the final chance for additions or changes to be made before the note stored in memory 16 as a non editable case note. Changes made to either the “ink” or text templates will typically not be saved to that template unless the user decides to save the new changes as part of that status note, or designate a new name for the changed template. The user would select the OK button 3204 to enter the information as a non-editable case note into memory 16.

FIG. 7G shows an image 3300 which can be displayed on the monitor 12 of the apparatus 1 of FIG. 1. The image 3300 includes fields shown for image 900 in FIG. 3A. The image 3300 also includes a field 3302 to select to show notes for a particular dental procedure and a dental procedure identification 3302a, which in this case is “D3320—Tooth:20”. Selecting the field 3302 for “Show notes” causes a prompt box to ask “existing”, “completed”, “planned” or “all.” This allows the user to select from which case notes (already in the non-editable casenote section) they would like to see. As any of the above three statuses are selected, the relative tooth #procedure codes, descriptions and surfaces (where applicable) are automatically seen. The user should just tap on the exact case note heading that they would like to see, and the processor 10 will display it on the monitor 12 in the case note section. Selecting the field 2406 for “Add Notes” brings up the “Add Notes” interface or window 3102 shown in FIG. 7E.

The user can also enter a case note by selecting the “ADD NOTES . . . ” button 2406 in FIG. 7G, which will display the “add notes” interface or window 3102 shown in FIG. 7E, however, if button 2406 is selected without entering a procedure as completed, the “add notes” interface 3102 FIG. 7E, will show only categories 3108 and 3112.

FIG. 8A shows an image 3400 which can be displayed on the monitor 12 of the apparatus 1 of FIG. 1. The image 3400 allows a user to choose a dental procedure. The image 3400 includes a window 3402 which lists the current names of the keys of the procedure pad 1710 in FIG. 4H. Each procedure pad key name in window 3402 has a box with a plus sign in it, 3402a, which (when tapped on with the stylus or mouse) will “maximize that key's content, displaying the individual C.D.T. codes contained in that key's content and a box with a check mark in it next to it indicating that that procedure pad key is activated or “present” in the keypad 1710 when the icon 1710a is selected. If the check box is deactivated (unchecked) the keyname will be deleted, and the key will not be present in the procedure pad fields 2102, 2104, and 2114 shown in FIG. 4H. There is also a favorites (or “MISC”) designation in window 3402 which has a box with a check mark in it which indicates this key's active status and it's presence in the keypad 1710 shown in FIG. 4H. The image 3400 includes field 3404 which displays the “current” name of a procedure pad key when that key name is “selected” (tapped on) from the list seen in 3402, FIG. 8A. The user may then remove that current key name (by backspacing with the cursor) and enter the new key name in text, followed by selection of field 3406, which will “update” the procedure pad and list, in field 3402. Field 3408 is used to add a C.D.T. code to a key in the procedure pad 1710.

The image 3400 includes a window 3410. When C.D.T. main categories, sub-categories and/or individual codes or procedures, such as code “D4381: . . . ” in FIG. 8C, are highlighted following the maximizing of any of the key names and highlighting of their content, their full CDT description appears in window 3410 in FIG. 8C. The image 3400 includes fields or buttons 3412 for canceling the interface 3400 FIG. 8A (and any changes made during the maximization of that interface) and 3416 for saving any and all changes to memory which were made during the maximization of interface 3400 in FIG. 8A.

FIG. 8B shows an image 3500 which can be displayed on the monitor 12 of the apparatus 1 of FIG. 1. The image 3500 includes a window 3502 which includes a listing of the key names shown in window 3402 of FIG. 8A and also includes a listing 3504 of further procedures under the designation “Perio”. The designation “Perio has been selected as indicated by the box with a “−” sign in it, next to “Perio”. After the “+” (maximizing) button has been selected, and the individual codes within or associated with that key are seen (as in the codes under “perio” in fields 3505 and 3506 in FIG. 8B. The “−” symbol is then seen in the box which represents the “minimizing” function, which will hide the individual codes in that key, under that key name, as all are in field 3402 in FIG. 8A. By de-selecting (unchecking) the checkboxes next to the individual codes (such as 3506 code D4381), these codes will be reversibly eliminated from that key's content and will not be visible (in field 2106 in FIG. 4H) when the contents of that key are displayed by selecting that key when the procedure pad is maximized. Highlighting field 3506 indicates that the procedure D4381 has been selected or clicked on by a user. The designation “Perio”—appears in the field 3404 only as a result of highlighting “perio” or 3504 with the stylus or computer mouse, which is used to change the name of the key.

FIG. 8C shows an image 3600 which can be displayed on the monitor 12 of the apparatus 1 of FIG. 1. The image 3600 includes a window 3602 which includes a listing of the procedures shown in window 3502 of FIG. 8B. The designation “Perio” has been selected as indicated by the box with a “−” sign in it, next to “Perio”. Highlighting 3506 indicates that the procedure D4381 has been selected or clicked on by a user. No designation appears in field 3404 indicating that the name of the button “perio” is no longer selected, due to the selection of 3506 for code D4381. The window 3410 now includes text describing the dental procedure D4381 as will the descriptions of any individual C.D.T. code be when highlighted in FIG. 8C, windows 3600 and 3602. To add a code(s) to a key (such as the content included under “Perio” 3504) the last individual C.D.T. code appearing under that key name, as seen with field 3506 in FIG. 8C, located under must be highlighted (tapped on with the mouse or stylus) followed by the selection of the “Add Code Here” button 3408 in FIG. 8C. This will also cause the full description of the individual C.D.T. code selected to appear in field 3410 of FIG. 8C. This will prompt window or interface 3702 in FIG. 8D, causing window 3702 to be displayed by processor 10 on the screen of the monitor 12.

FIG. 8D shows an image 3700 which can be displayed on the monitor 12 of the apparatus 1 of FIG. 1. The image 3700 includes a window 3602 similar to that shown in FIG. 8C. However, the window 3602 is now overlapped by a window 3702 which provides the entire C.D.T. list of dental codes from which the user will select the code to be added to the selected key's content (“Perio” field 3504 in FIG. 8B) under the highlighted code 3506 (or code D4381) which appears last in the list of the individual codes contained in that key. First, the user will select the “maximizing” icon (similar to 3402a of FIG. 8A) adjacent to the main C.D.T category (i.e.” Perio” for periodontics in FIG. 8D field 3702) which contains the sub-category containing the individual code to be entered. Then the user shall select the “maximizing” icon (similar to 3402a FIG. 8A) adjacent to the sub-category (i.e. “Non-surgical periodontal services in window 3702 in FIG. 8D) which contains the individual code that will be added to that key (“Perio” in field 3504 in FIG. 8B). At that point all of the individual codes in this sub category will be visible in window 3702 in FIG. 8D, which includes codes D4320 through D4381 and the individual code (i.e. code D4341 in FIG. 8D) to be added to the key (“perio” shown in field 3504 in FIG. 8B) which will appear under the last code in that category (code D4381 shown in FIG. 8B, in window 3506) should be highlighted (“tapped on” with the stylus or mouse) which will propagate that code's full C.D.T. description to appear in FIG. 8D, field 3704 for the user to read and verify the correct code selection. At that point, FIG. 8D button 3708 will cause field 3702 shown in FIG. 8D to depart from the screen and add that code to the key (“perio” shown in window 3504 of FIG. 8B) and it will appear as the last code in the list (shown in field 3804 in FIG. 8E) and save the change into the memory 16. Selection of button 3706 shown in FIG. 8D will cause the departure of FIG. 8D window 3702 from the monitor 12 without adding a code to the keypad or the memory 16. Addition of code(s) to the same key (“perio” shown in field 3504 of FIG. 8B 3504) or a different key may only be accomplished one code at a time, following the same (above) protocol.

FIG. 8E shows an image 3800 which can be displayed on the monitor 12 of the apparatus 1 of FIG. 1. The image 3800 includes a window 3402. The image 3800 includes highlighting 3804 selecting and identifying an added dental procedure “D4341”. Window 3410 has a description of the added dental procedure.

Referring to FIGS. 8A-8E and FIG. 4H the name of a key in the procedure pad 1710 of FIG. 4H can be changed as follows. First the key desired to be changed is selected (using a computer mouse or stylus of interactive device 14) in window 3402 of FIG. 8A, such as for example “Full Dentures (Upper)”. The selected key will appear in the field 3404 as in FIG. 8A. The name in the field 3404 is highlighted using for example, a computer cursor. A new name then can be entered with a keyboard of interactive device 14 into field 3404. The update field 3406 is selected and the “OK” button 3416 is clicked on to change the key.

Referring to FIGS. 8A-8E, and FIG. 4H, a key can be deleted from the procedure pad 1710 of FIG. 4H as follows. The check mark, in 3402b in FIG. 8A for example, is deselected, with a stylus or computer mouse. The update button 3406 is selected and then the OK button 3416 is selected, which causes the key (in this case the upper arrow in the window 2102 for “Full Dentures” in FIG. 4H) to be deleted.

Referring to FIGS. 8A-E and FIG. 4H, codes can be deleted from the keys in the procedure pad 1710 as follows. First the key's name is located in window 3402 of FIG. 8A. For example, the key name may be “Full Dentures (Upper)” corresponding to the up arrow under “Full Denture” for the procedure pad or window 1710 in FIG. 4H. Then the maximizing box (”+” or “−”) at the same vertical level as the key name in window 3402, such as 3402a, is maximized (clicked on or toggled to change to “−”) to expose all codes in or under that key or category. For example in FIG. 8B all codes under “Perio” key name have been exposed. Then the check box of the code to be deleted is unchecked. For example, in FIG. 8B, if the code D4341 is to be deleted, then the check box next to D4341 is clicked on to uncheck it. Then the update field 3406 is clicked on and thereafter the “OK” button 3416 is selected to save the new settings (i.e. code D4341 has been deleted and will not appear in field 2106 of FIG. 4H when the “Perio” key in the procedure pad 1710 is thereafter selected).

Dental codes can also be added to a key of the procedure pad or window 1710 of FIG. 4H. Firstly, the name of the key is located such as “Perio” in FIG. 8C. Next the maximizing box is selected to maximize (“−”) to show all codes within the “Perio” key. Next the last code description, such as “D4381: . . . ” in FIG. 8C, is highlighted, such as by highlighting 3506. Next the “Add Code Here” button 3408 is selected, and in response a choose procedure window 3702 (containing the complete list of C.D.T. codes) is displayed as shown in FIG. 8D. The user would then maximize a major category, such as “Periodontics”, a subcategory, and then select a specific code, followed by selecting the “OK” button 3708 to save the code under the appropriate category. “Multicodes” are able to be added to any of the keys in 1710 of FIG. 4H. A multicode allows the user to “group” more than one code together under a name chosen by that user, enabling a “streamlined” entry while eliminating redundant code entry. “Multicode” entry is accomplished in the same fashion as single code entry with the procedure pad. The user is able to reversibly delete and/or change the titles or headings of the pre-set sub categories in field or window 3504, shown in FIG. 8B.

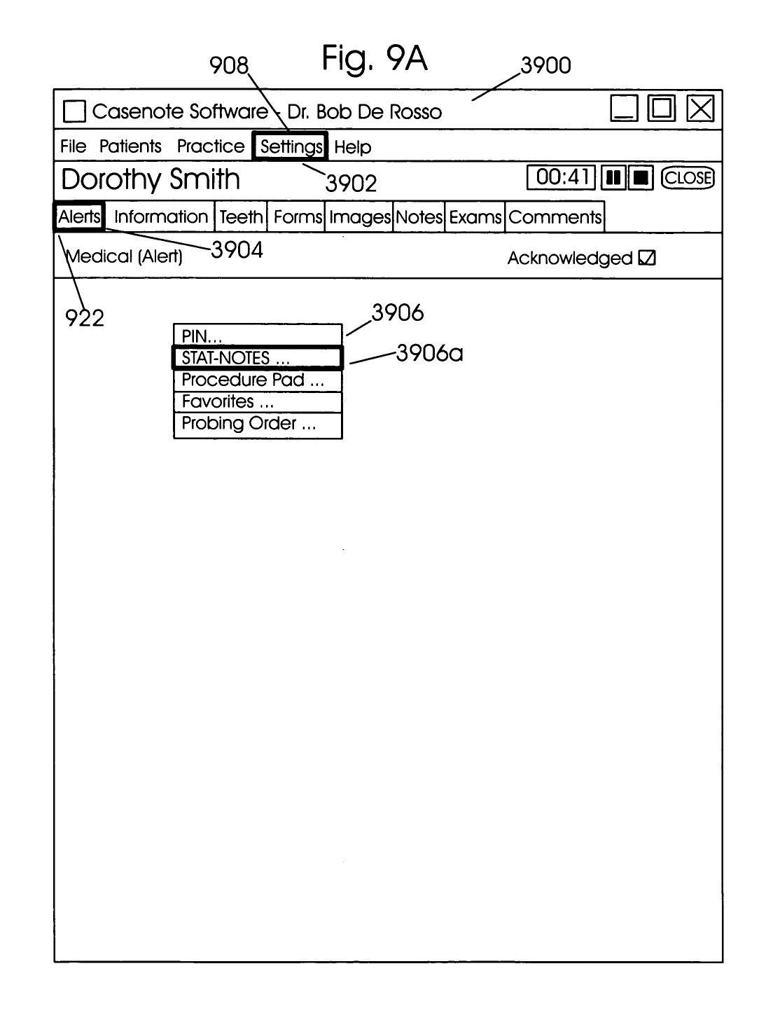

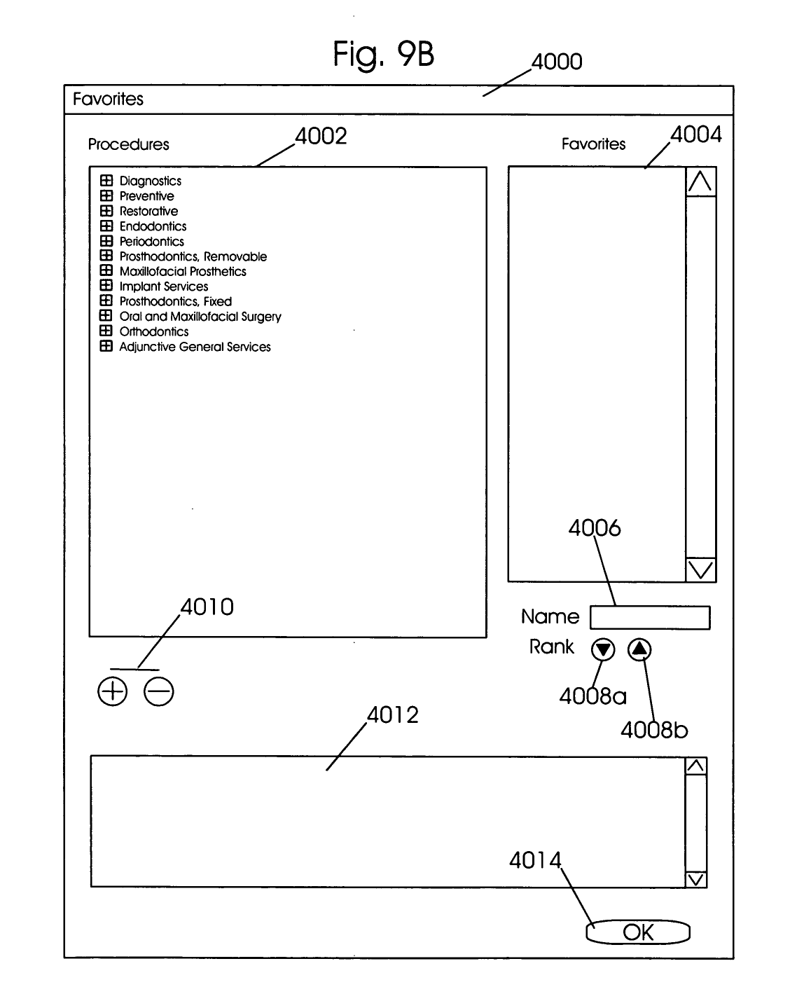

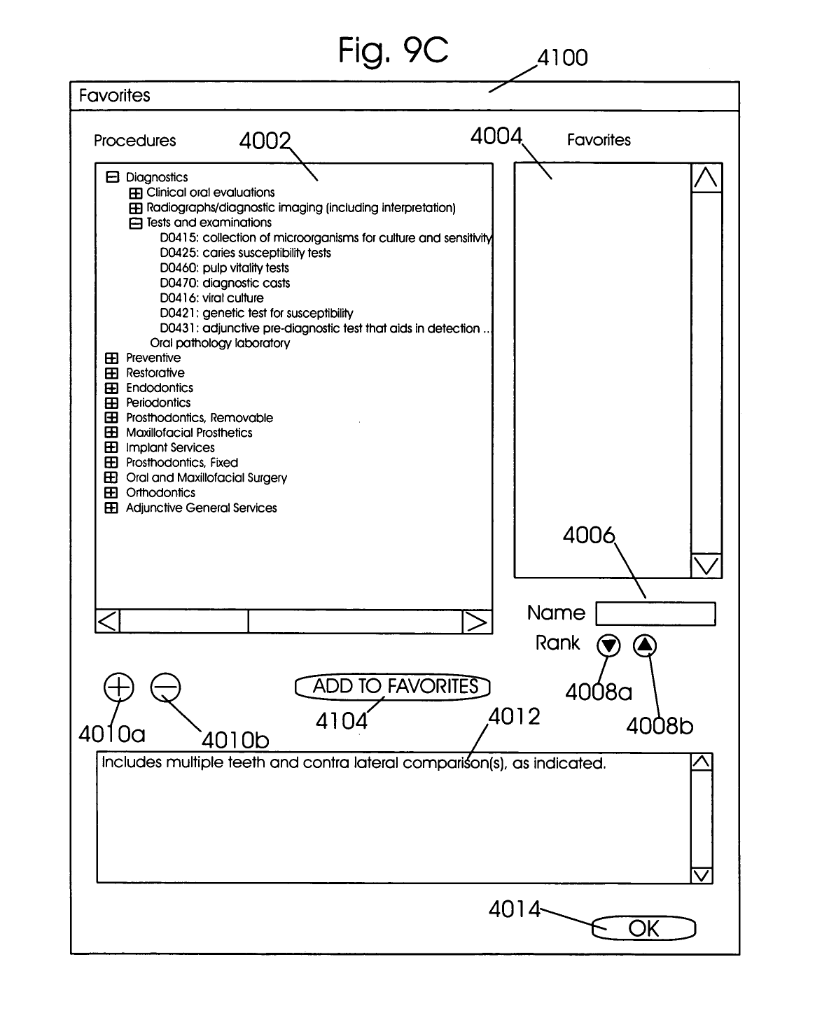

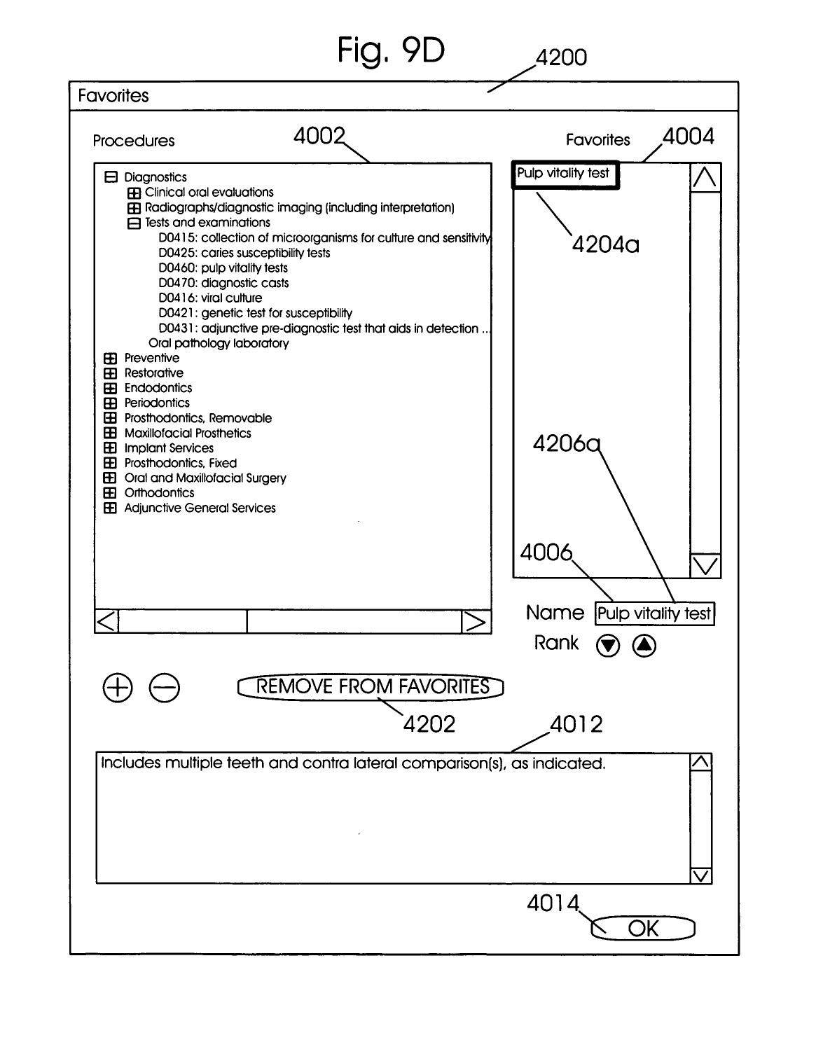

FIG. 9A shows an image 3900 which can be displayed on the monitor 12 of the apparatus 1 of FIG. 1. The image 3900 includes information similar to FIG. 3A. The image 3900 includes window 3906. Window 3906 has a plurality of fields which can be clicked on. The plurality of fields include “PIN . . . ”, “STAT-NOTES . . . ”, “Procedure Pad . . . ”, “Favorites . . . ”, and “Probing Order . . . ”. Each entry when clicked on or selected brings up a different image or screen. Selecting “pin” allows the user to change their current personal identification number and save the new personal identification number to the memory 16. The “STAT-NOTES” field is shown selected by highlighting 3906a in FIG. 9A. Selecting the “STAT-NOTES” field brings up image 2700 shown in FIG. 7A. Selecting the “Procedure Pad” field in window 3906 of FIG. 9A brings up image 3400 in shown FIG. 8A.

Clicking on the “Favorites” field in window 3906 of FIG. 9A brings up a window 4000 shown in FIG. 9B. The window 4000 includes window 4002 which contains a list of CDT categories. The window 4000 also includes window 4004 which may contain a list of favorite dental procedures selected form the complete list of C.D.T. codes which may be accessible through window 4002 of FIG. 9B. If field 4004 has a large number of procedure codes, such as more than can be seen on one screen of monitor 12 at one time, these codes can be scrolled through using up and down scroll arrows. Down and up arrows 4008a and 4008b, respectively, can be used to organize the order (from top to bottom) or “rank” in which the user sees the entries in window 4004, as well as in window 2106, FIG. 4H, when the “favorites” or “Misc” button is selected. The window 4000 includes window 4012 which is where a full description of a particular CDT category, sub-category or individual code will appear when it is highlighted with a stylus or mouse.

The maximizing boxes next to the categories (shown with “+”s in FIG. 9B) can be selected to open to show sub categories (when selected to change to “−”). If a category, sub-category or individual procedure is selected (by tapping with a stylus or computer mouse followed by the selection of “Add to Favorites” button 4104 shown in FIG. 9C, it will appear in field 4004 under “Favorites”, as shown in FIG. 9D for “Pulp vitality test”. This shows that “Pulp vitality test” has been added to the content in the “Favorites” or “Misc.” button for procedures seen in 1710. Button 4010a when clicked on causes all main categories to maximize in field 4002, which will display all of that category's sub-categories and individual codes below in the field 4002. Button 4010b causes all the main categories in field 4002 to “minimize”, whereby the sub-categories and individual codes are no longer seen in window 4002.

Field 4006 in FIG. 9C displays the name of the item in field 4004 under “Favorites” which has been highlighted by mouse or cursor, allowing the user to “edit” the original CDT name to a new name where it will then appear in field 4004, as well as in window 2106, FIG. 4H, when the “favorites” or “Misc” button is selected.

Button 4008a and button 4008b enable the user to “move” the order of appearance of the content in field 4004 under “Favorites” when that item content is highlighted in field 4004 upwards towards the top of the “Favorites” list in field 4004 (for button 4008b) and downwards (for button 4008a) towards the bottom of the “Favorites” list to establish a “rank” or “hierarchy” relevant to the selection process when the “Favorites*” or “Misc.” button is selected of procedure window or pad 1710 shown in FIG. 4H.

“OK” button 4014 is selected when all choices have been made. These settings will then be saved by the computer program in memory 16.

Clicking on the designation for “Diagnostics” procedure (or on the box next to “Diagnostics) in window 4002 in FIG. 9B (causing the box next to diagnostics to have a “−” sign instead of a “+” sign) and further clicking on the designation for “Tests and examinations” (or box next to it) in window 4002 in FIG. 9C causes a list of procedures or sub procedures to be provided as shown in FIG. 9C. This also causes a button 4104 for “Add to Favorites” to be displayed on the screen of the monitor 12. In addition, the window 4012 has a description of the highlighted major category, sub-category or procedure, in FIG. 9C. The fields 4004, 4006, 4008a, 4008b, 4010, and 4014 from FIG. 9B, remain the same in FIG. 9C.

FIG. 9D shows an image 4200 which can be displayed on the monitor 12 of the apparatus 1 of FIG. 1. The image 4200 includes windows 4002 and 4012, as in FIG. 9C. The image 4200 includes window 4004 which now shows a designation for “Pulp vitality test” highlighted by highlighting 4204a. The window 4200 also includes field 4006 which shows “Pulp vitality test” designation 4206a. The window 4200 also includes a “Remove from Favorites” button or field 4202, which will remove the entry 4204a (any highlighted entry) from window 4004 in FIG. 9D. Clicking on “Probing order” in field 3906 in FIG. 9A, will allow the user to select between two pre-set periodontal probing orders.

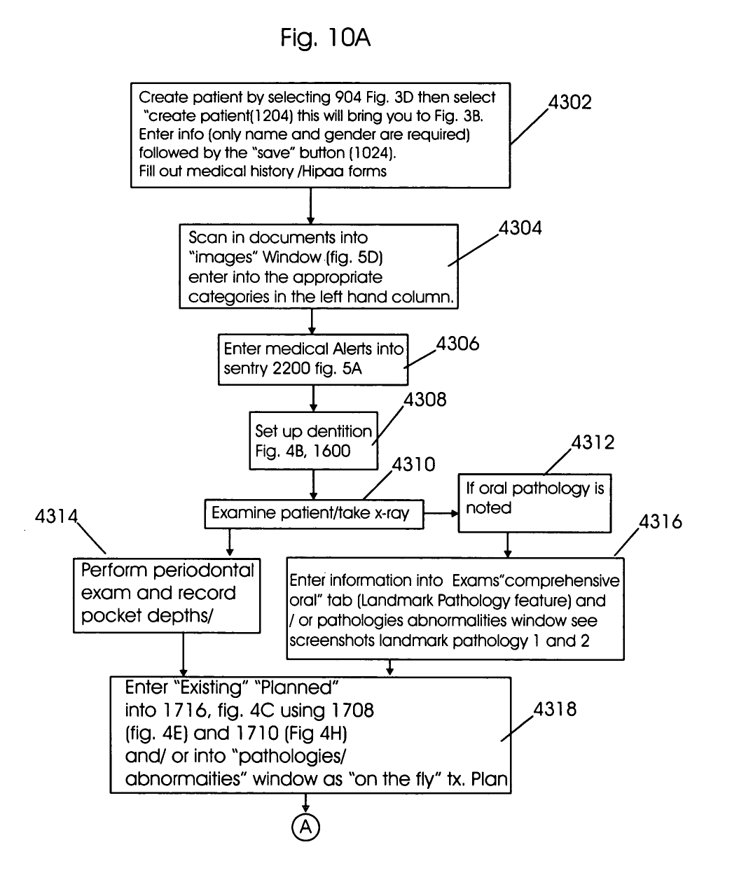

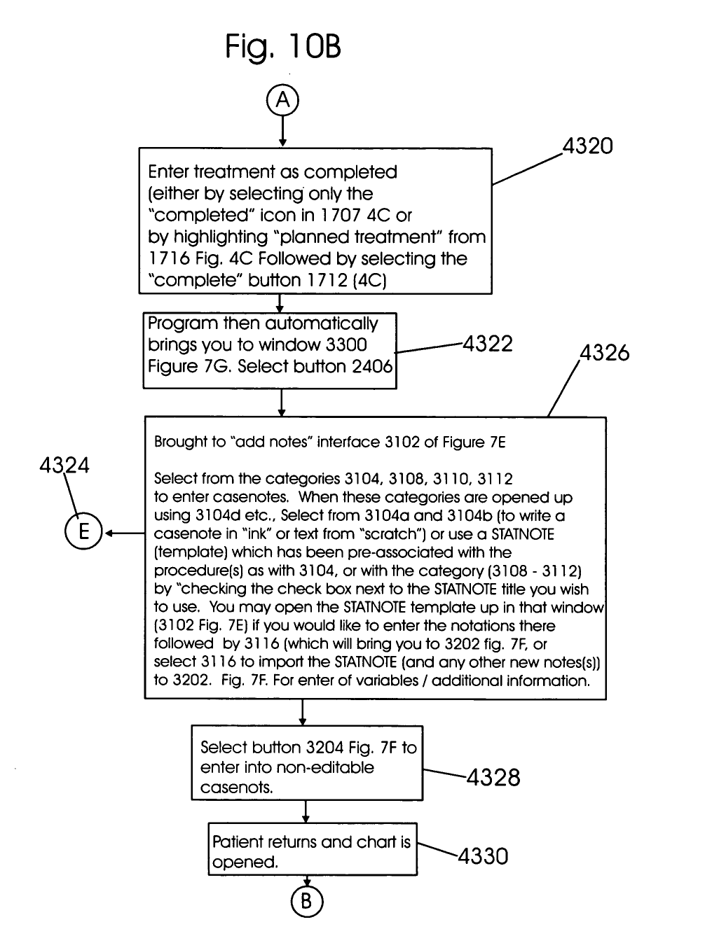

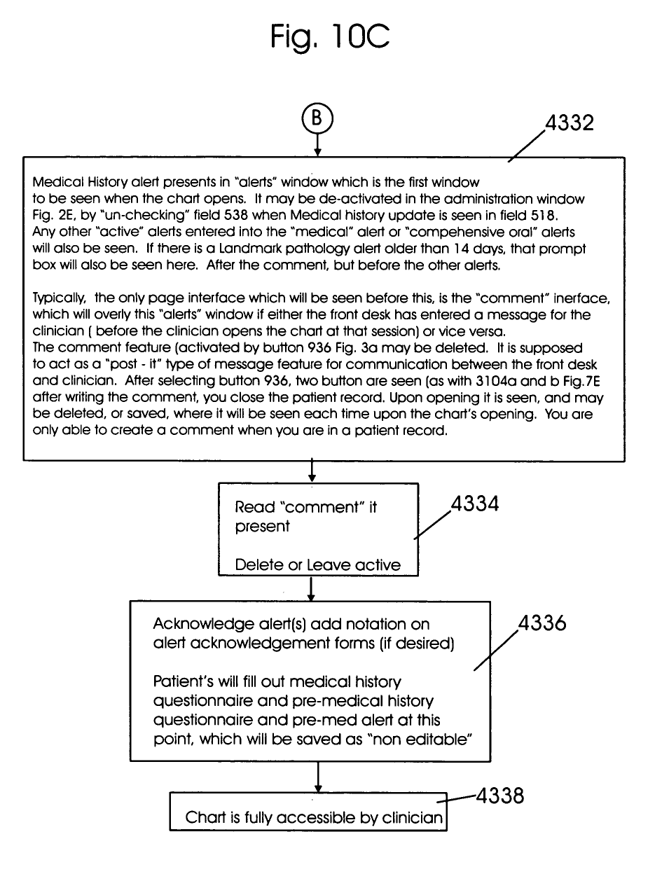

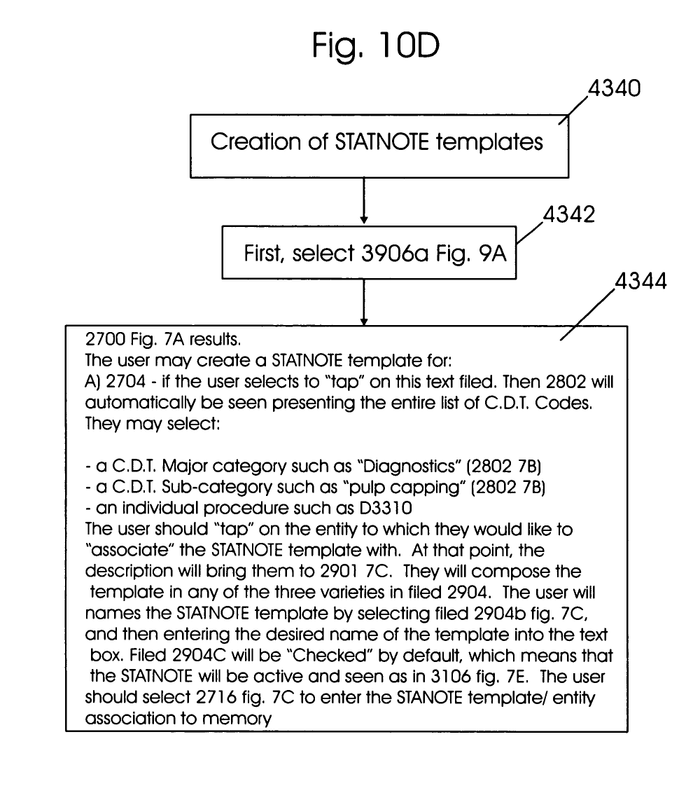

FIGS. 10A-D show a flow chart of a method in accordance with an embodiment of the present invention. At step 4302, a user, such as a dentist or dental clinician, creates a patient file by first selecting “Patients” field 904 shown in FIG. 3D to bring up pull down menu or window 1202. The user would then select field 1204, shown in FIG. 3D, for “Create Patient”. Selecting field 1204 will cause the processor 10 to display the image 1000 shown in FIG. 3B on the monitor 12. Information can then be entered for the patient by the dentist or dental clinician, by using image 1000, but typically only the name and gender of the patient are required. After the patient information has been entered using image 1000, the save button or field 1024 is selected. This causes the processor 10 to display FIG. 3B (in the saved state). The patient then fills out embedded medical history and HIPAA forms.

At step 4304 of FIG. 10A, the dentist or dental clinician scans in documents using image 2500 of FIG. 5D. At step 4306 the dentist or dental clinician enters medical alerts using “sentry” window or image 2200 shown in FIG. 5A. Next, the user sets up dentition for the particular patient at step 4308 through image 4600 shown in FIG. 11C. The image 4600 shows the empty cells and the “eruption” buttons When the user initially starts a new patient chart, all cells are empty as seen in FIG. 11C. Window 1600 in FIG. 4B shows the result of selecting the “select all” field followed by the “permanent” field. At step 4310 the dentist or dental clinician examines the patient and/or takes X-rays of the patient's teeth and/or mouth. If no oral pathology is noted, the user next performs a periodontal exam and records pocket depths using image 5000 FIG. 11G for each tooth at step 4314. If an oral pathology is noted at step 4312, then the dentist or clinician next enters information into memory and associates it with the exam's comprehensive oral tab image 4900, FIG. 11F (Landmark Pathology feature) and/or pathologies abnormalities window or image 2000 of FIG. 4G at step 4316.

In either case, any existing or planned dental work is entered, at step 4318, into image or window 1716 using pad 1708 shown in FIG. 4E or pad 1710 shown in FIG. 4H, and/or into “pathologies/abnormalities” window image 2000 of FIG. 4G as on the fly treatment plan.

At step 4320 treatment is entered as completed, either by selecting only the “completed” icon in field 1712 in FIG. 4C (if the procedure is being completed without first being planned), or by highlighting “planned treatment” from field 1716 in FIG. 4C followed by selecting the “complete” button in field 1712. Following the selection of the complete button in field or window 1712, the processor 10 automatically displays the image 3300 shown in FIG. 7G on the monitor 12. The user may then select the “Add Notes” button or field 2406 shown in FIG. 7G at step 4322 of FIG. 10B.

Selecting the “Add Notes” button 2406 causes the processor 10 to display image 3100 and window, image, or interface 3102 shown in FIG. 7E. At step 4326 shown in FIG. 10B, The user can select from the categories or fields 3104, 3108, 3110, or 3112 to enter case notes. Case notes in the present application, are typically notes regarding a particular patient. When one of these categories 3104, 3108, 3110, or 3112 are opened up, using buttons or fields 3104d, 3108a, 3110a, and 3112a, respectively, the user can select from either field 3104a or 3104b to write a case note in “ink” or text from “scratch”. “Ink” in the present application means handwritten note using a stylus and a tablet personal computer. “Text” in the present application means note entered through a keyboard. The user may also use a status note (or stat-note) template which has been pre-associated with the procedure as with 3104 or with the category 3108-3112 by checking the check box next to the STATNOTE (status note) title (field 3106 of FIG. 7E) the dentist or clinician wishes to use. The user may open the status note template up in the window 3102 of FIG. 7E if the user would like to enter notations there followed by selecting the OK button 3116 which will cause window 3202 of FIG. 7F to be displayed. Alternatively, the dentist may select the OK button 3116 to import a status note and any other new notes, to the window 3202 of FIG. 7F and for entry of variables and additional information. Selection of creation of status note causes the method to proceed to step 4324 at node E, which continues on FIG. 10D. At step 4326, button 3204 in FIG. 7F is selected to enter into a non-editable case note. At step 4330a patient returns and a patient chart is opened as shown in image 2300 FIG. 5B. This demonstrates how when the patient chart is opened, the sentry alert feature is the first page or image seen on the monitor 12 displaying all of the medical alerts.

The method proceeds to node B which continues on FIG. 10C. At step 4332, the medical history alert presents in “alerts” window 2300 FIG. 5B (also shown in 4400 FIG. 11A), which is the first window to be seen when the patient's name is selected from the main patient list shown in image 1117, in window 1100 in FIG. 3C. The field 2304 and 2304a may be de-activated in the administration window of FIG. 2E, by unchecking field 538 when Medical history update is seen in field 518. Any other active alerts entered into the medical alert or comprehensive oral alerts in window 2200 of FIG. 5A and window 4900 FIG. 11F will also be seen in window 4400 of FIG. 11A (also shown in window 2300 of FIG. 5B). If there is a Landmark pathology alert older than 14 days, that prompt box will also be seen here in window 4400 of FIG. 11A (also shown in window 2300 of FIG. 5B.) after the comments but before the other alerts.

The only page interface which typically will be seen before this, is the “comment” interface, not shown in the drawings, which will overlay the “alerts” window, if either the front desk has entered a message for the clinician (before the clinician opens the chart at that session) or vice versa. The comment feature (activated by button 936 of FIG. 3A) may be deleted. It is supposed to act as a “post-it” type of message feature for communication between the front desk and the clinician. After selecting button 936, two buttons are seen (as with 3104a and 3104b of FIG. 7E after writing the comment, the dentist (or front desk personnel) closes the patient record. Upon opening it is seen, and may be deleted, or saved, where it will be seen each time upon the chart's opening. Typically the user will only be able to create a comment when the user is in a patient record.

At step 4334, the user reads a “comment” if present and may delete it, or leave it active.

At step 4336, the user acknowledges alert(s), adds notation on alert acknowledgement forms if desired. In addition, the patient fills out medical history, medical history update, and pre-med alert (or any other alerts that the user has entered and/or attached forms for) at this point which will be saved as a non-editable file.

At step 4338 the patient's chart, including all information from all windows (FIGS. 3A-12B) is fully accessible by a dentist or dental clinician.

FIG. 10D shows the creation of a status note template. Step 4340 is an entry point. At step 4342, a dentist or dental clinician selects field 3906a for “Statnotes” shown in FIG. 9A. This causes the processor 10 to display on the monitor 12, the image 2700 shown in FIG. 7A. The dental clinician or dentist may create a status note template by selecting field 2704 in FIG. 7A then field 2802 will automatically be displayed presenting a list, such as the entire list of C.D.T. codes. The user may select (a) a C.D.T. major category, such as “diagnostics”, (b) a C.D.T. sub-category such as “pulp capping” or (c) an individual procedure such as “D3310”. The user should select or “tap” on the entity to which they would like to associate the status note template with. At that point, the description will bring them to window 2901 in FIG. 7C. They will compose the template in any of the three varieties in field 2904. The user will name the status note template by selecting field 2904b in FIG. 7C, and then entering the desired name of the template into the text box. Field 2904c will be checked by default, which means that the status note will be active and seen as in 3106 of FIG. 7E. The user should select window 2716 in FIG. 7C to enter the status note template/entity association to memory 16.

FIG. 11A shows an image 4400 which can be displayed on the monitor 12 of the apparatus 1 of FIG. 1. The image 4400 may include a field 4402 which indicates “Comprehensive oral (oral cavity w/dentition”) in FIG. 11A. The image 4400 may further include a window 4404. The image 4400 may include a handwritten notation in a field or window 4406. The image 4400 may include a digital image of a mouth with teeth in field or window 4408. The image 4400 may include fields 4410, 4412, 4414, and 4416. The image 4400 may include a handwritten notation in a field or window 4418. The window 4418 is similar to window 2300 shown in FIG. 5B. However, in the window 4418, in contrast to window 2300, shows a “landmark pathology” alert being displayed, in addition to the “medical” alerts upon opening of the patient's chart.

FIG. 11B shows an image 4500 which can be displayed on the monitor 12 of the apparatus 1 of FIG. 1. The image 4500 may include a window 4502 for entering information regarding a treatment plan. Image 4500 shows window 4502 or the “clone” feature interface (as described above). Also shown is the “replace amalgams with composites” function. This interface is seen as a result of the selection of the “clone” button in field 1706.

FIG. 11C shows an image 4600 which can be displayed on the monitor 12 of the apparatus 1 of FIG. 1. The image 4600 may include a window 4602 of a plurality of entry boxes, rectangles or fields, in place of the teeth shown for example in FIG. 4H. There is an entry box for each tooth, such as box 4602a for tooth “01”. The boxes may be highlighted or shaded a color, such as blue. FIG. 11C shows the “dentition set up” window as it is seen when the patient chart is first set up. All of the “cells” are seen as empty. It works as described in the “dentition setup” section described above. In this screenshot or image 4600 of FIG. 11C, the “Eruption” status buttons are now seen. They were not shown in window 1600 of FIG. 4B.

FIG. 11D shows an image 4700 which can be displayed on the monitor 12 of the apparatus 1 of FIG. 1. The image 4700 may include a window 4702 which may refer to treatment details.

FIG. 11E shows an image 4800 which can be displayed on the monitor 12 of the apparatus 1 of FIG. 1. The image 4800 may include a window 4802, which may show nine digital images as referred to in field or window 2206. For example, window 4802 includes a field 4802a which may include a facial digital photograph image for a patient. Similarly, image 4802b may include an ant. Gingival/vestibule digital photograph image for a patient. By selecting the image, it will then appear as 4906 in FIG. 11F A field 4804 allows for entry of whether a note is handwritten or text. A field 4806 allows for exiting out of the window 4802.

FIG. 11F shows an image 4900 which can be displayed on the monitor 12 of the apparatus 1 of FIG. 1. The image 4900 may include a window 4902, which allows for entry of handwritten notes in field 4904 and for displaying of a digital image of a mouth and teeth in field 4906, which may then be attached to the “sentry” alert feature. This was previously described above in the “landmark pathology” alert description.

FIG. 11G shows an image 5000 which can be displayed on the monitor 12 of the apparatus 1 of FIG. 1. The image 5000 may include a window 5002 which highlights three perspective views of a specific tooth, in this case tooth “01”. The image 5000 also includes a window 5004 which shows a larger image corresponding to window 5002 for tooth “01”. The image or screen shot 5000 shows the “periodontal probing session” screen as it is seen when the “start session” button is selected, as with FIG. 4F which shows the periodontal window prior to selecting the “new session” button.

FIG. 11H shows an image 5100 which can be displayed on the monitor 12 of the apparatus 1 of FIG. 1. The image 5100 may include a window 5102 which highlights three perspective views of a specific tooth, in this case tooth “04”. The image 5100 also includes a window 5004 which allows selection of colors for the tooth “04”. The image 5100 also includes a window 5106 regarding editing restorations concerning the tooth “04”. Image 5100 shows the “restoration editor” interface which is prompted upon “double clicking” as described previously.

FIG. 11I shows an image 5200 which can be displayed on the monitor 12 of the apparatus 1 of FIG. 1. The image 5200 may include marks 5202 showing an occlusal restoration which will be seen as a result of the entry of an occlusal restoration using the restoration pad (1708) on tooth “14”. The image 5200 may include a mark 5204 which indicates that the “14” tooth has been selected.

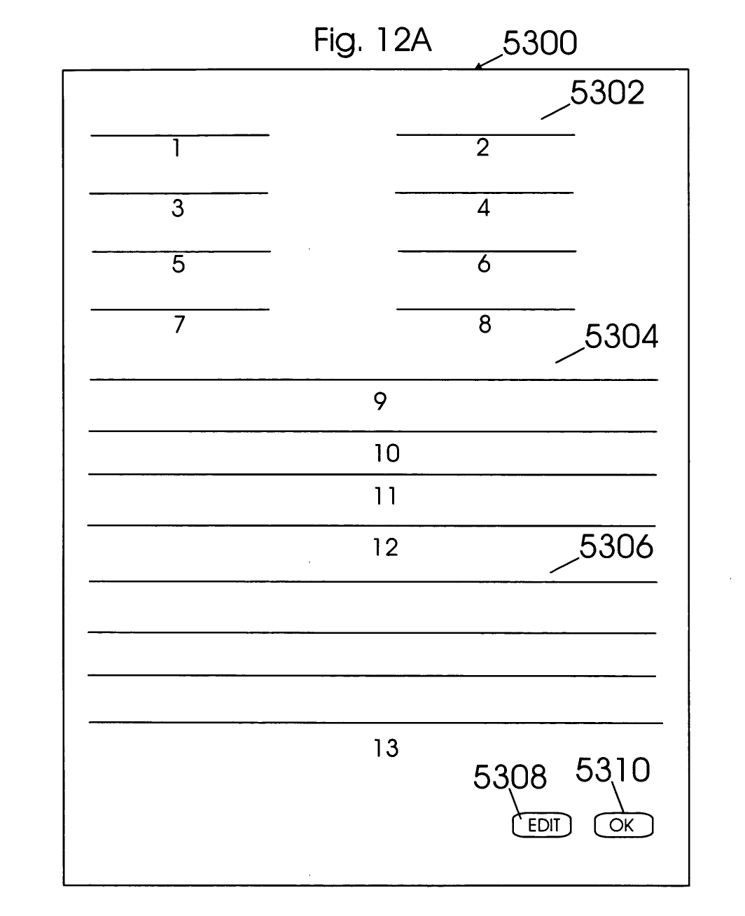

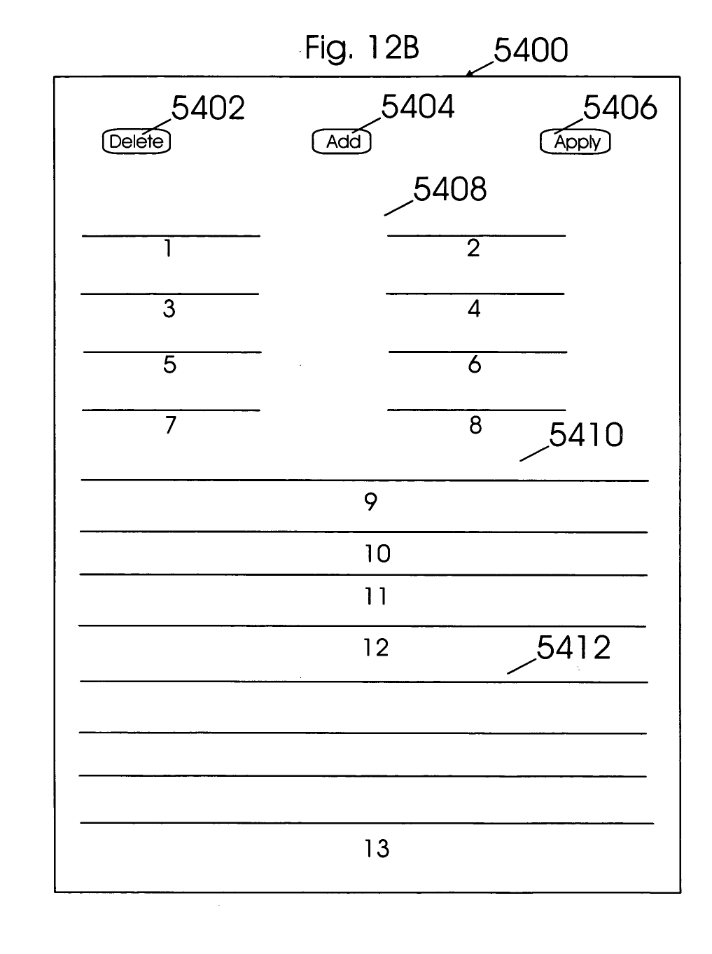

FIG. 12A shows an image 5300 which can be displayed on the monitor 12 of the apparatus 1 of FIG. 1. The image 5300 may include entry areas or fields 5302, 5304, and 5306, and buttons 5308 and 5310. The image 5300 may be called the “STATNOTE” entry interface. The image 5300 may be the standard default format which would be seen when a user has selected to create a status note. The user may delete or add the desired fields of fields 5302, 5304, and 5306 by selecting the “add” or “delete” buttons (5402 and 5404 in FIG. 12B) after highlighting a field such as #1 in field or window 5408 in FIG. 12B. Generally, there are three different types of fields: short lines (in field 5302), which is for the entry of short phrases, long lines (in field 5304) which can be used for longer phrases or sentences, and paragraph section (in field 5306) for a series of sentences or a “paragraph”.

In operation, the user would first select field or button 3906a shown in FIG. 9A, which would prompt the “Edit STATNOTES” interface (which is image 2900 shown in FIG. 7C) containing fields 2704, 2708, 2710, and 2712. The user would select the category to which they would like to associate the status note (as with STATNOTE variation #1, shown in FIG. 7B) At that point, image 5400—would be seen. The user would then edit—the above interface or image 5400 (add or subtract fields) or keep this “standard” setup.

The user would then enter the desired “short phrases (using a stylus (so called “ink”) or with a keyboard (so called “text”) onto the half or short lines in area 5302, a long phrase or sentence in field or area 5304), and multiple long phrases, sentences or paragraphs onto the four lines in field 5306. When the user is finished, he or she will select the “OK” button 5310 to commit and store the entries to the associated category in memory 16. Composition of a case note using this interface would work in the following manner. When the attached “ADD STATNOTE” interface is seen (due to its selection by highlighting its STATNOTE “title” or “header” as seen in field 3106 of FIG. 7E) the associated status note selection interface (i.e. as above in field 5300 of FIG. 12A) would be seen on the monitor 12 with all of the entries (as entered in “ink” or text). The user would then add the variables into the respective fields Numbers 5308, 5310 and 512 in FIG. 12A) at this point, followed by the “tapping” (with a device such as a stylus) on the designation [number] under the field(s) which would bring all of the information contained in the fields (including the variables) to the confirm note window (field or window 3202 shown in FIG. 7F) in the order which the designation numbers were selected.

For example, if the user selected the lines in FIG. 12A in the following order first line in area or field 5304, then second half line in column one of area or field 5302, then third line in column one in area or field 5302, then second line in area or field 5304, then fourth line in column one in area or field 5302, these lines would appear in this order in window or field 3202 of FIG. 7F, along with their variables. If the variables were not entered prior to the “confirm note” interface of window 3200 in FIG. 7F they may be entered in at that point. Also, any additional information would also be able to be added to window 3200 in FIG. 7F at this point. The user would also be able to “delete” any information from window 3200 in FIG. 7F at this point. All entries would be seen as a single case note entry. The user should then select image 3204 shown in FIG. 7F to commit the content to the final “non-editable” case note and to store in the memory 16 shown in FIG. 1.

FIG. 12B shows an image 5400 which can be displayed on the monitor 12 of the apparatus 1 of FIG. 1. The image 5400 includes buttons 5402, 5404, and 5406. The image 5400 also includes field or area 5408 having a plurality of short lines. The image 5400 also includes field or area 5410 having a plurality of long lines. The image 5400 also includes field or area 5412 having a plurality of long lines. The image 5400 may be called the “EDIT” interface, and can be used to add or delete—the lines (or fields) in areas 5408, 5410, and 5412.

The feature shown by FIG. 12B can be called the Statnote interface editing feature. In order to delete a template, such as line number “1” in field 5408 window 5400—in FIG. 12B the user would initially start with the above form of FIG. 12B and be able to tap on the template line number “1” in field 5408 in window 5400—which they chose to delete, and then select delete button 5402 in FIG. 12B. This would delete that highlighted template for that STATNOTE entry window which will be associated with that STATNOTE in that category (in fields 2708, 2710, or 2712 shown in FIG. 7A), from memory 16. After a template is deleted, and the field is eliminated, the templates underneath would move up into that space. For example, if the fourth line in field 5410 was deleted, the first line of field 5412 would move up into that space. The field 5412 would typically keep it's four-line template form. By having this feature, the user would be able to create a customized entry field for every status note entry, eliminating all of the unnecessary templates which are not in use.

In order to add a template, such as line number “1” in field 5408 window 5400 in FIG. 12B the user would tap on the type of template for example, number line “1” in field 5408, window 5400 FIG. 12B which they chose to add, and then hit the add button 5404. This feature could be used in conjunction with the delete function, to customize the field with the desired template sizes.

Template fields would be organized in a “hierarchical” fashion. All half-line templates such as in area or field 5408 would be on the top, the single full-line templates, such as in area or field 5410 would be evident next, and multiple full-line template selections, such as in field 5412, would be seen in order of the time that they were created. Multiple line templates are possible with any number of full lines through the use of the add and apply buttons, 5404 and 5406, respectively.

The user would select the full line template or a full line in area 5410 of FIG. 12B, then hit the add button 5404. This would be repeated in relation to the number of lines that is desired in that template. After selecting the correct number of entry lines, the user would tap the apply button 5406 in FIG. 12B and the template would be grouped under one numeric designation (as seen with “13” in area 5412 of FIG. 12B). The apply button must be hit again after the selection of the multiple lined template, to save the entire entry platform.

Each STATNOTE interface, which is in window 12A of FIG. 5300, which is procedure-specific, may employ a unique template arrangement.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a processor;
a computer memory;
a monitor; and
an interactive device;
wherein the processor is programmed with computer software that allows an individual to enter dental information for a patient into the interactive device and to store the dental information for the patient in the computer memory;
wherein the computer software causes the processor to cause the monitor to display a plurality of teeth images corresponding to a plurality of teeth of the patient;
and wherein the computer software causes the processor to cause the monitor to display status information regarding each of the plurality of teeth images.

2. The apparatus of claim 1 wherein
the computer software causes the processor to display a plurality of forms which can be filled out by the patient using the interactive device.

3. The apparatus of claim 1 wherein
the interactive device includes the monitor and a stylus;
and wherein the processor is programmed so that the dental information for the patient can be entered by using the stylus in close proximity to the monitor.

4. The apparatus of claim 3 wherein
status information regarding a particular tooth of the plurality of teeth of the patient can be entered by using the stylus in close proximity to an image of the particular tooth.

5. The apparatus of claim 1 wherein
the computer software causes the processor to cause the monitor to display a plurality of different perspective views of each tooth of a plurality of teeth of the patient;
and wherein the plurality of teeth images include the plurality of different perspective views.

6. A method comprising:
entering dental information for a patient into a computer memory by use of an interactive device;
using the dental information to display a plurality of teeth images corresponding to a plurality of teeth of the patient; and
using the dental information to display status information regarding each of the plurality of teeth images; and
wherein the status information is displayed simultaneously with the plurality of teeth images.

7. The method of claim 6 wherein
the plurality of teeth images include a plurality of different perspective views.

8. The method of claim 6 further comprising
entering the dental information for the patient by using a stylus in close proximity to the monitor.

9. The method of claim 8 further comprising
entering status information regarding a particular tooth of the plurality of teeth of the patient by using a stylus in close proximity to an image of the particular tooth;
and displaying the status information regarding the particular tooth in close proximity to an image of the plurality of teeth images.

10. The method of claim 6 wherein
displaying a plurality of forms which can be filled out by the patient using the interactive device.

11. The apparatus of claim 1 wherein
the interactive device includes the monitor and a stylus; and
wherein the dental information includes one or more status notes and the computer program allows an individual to create a status note template and to enter the dental information by moving the stylus over the monitor in a motion simulating handwriting.

12. The apparatus of claim 11 wherein
the interactive device includes a computer keyboard;
the computer program allows an individual to enter the dental information by using the computer keyboard.

13. The apparatus of claim 1 wherein
the computer program allows an individual to enter a first code which represents a plurality of dental codes corresponding to a plurality of dental procedures.

14. The apparatus of claim 1 wherein
the interactive device includes the monitor;
wherein the computer program causes the monitor to display a procedure pad;
wherein the procedure pad includes a plurality of fields, each field pertaining to one or more dental parameters;
and wherein the computer program allows the editing of the plurality of fields by an individual by use of the interactive device.

15. The apparatus of claim 1 wherein
the computer program causes the monitor to display a plurality of images showing views of a patient's mouth.

16. The apparatus of claim 1 wherein
the computer program causes the monitor to display a treatment plan pad;
wherein the treatment plan pad includes information regarding a course of dental treatment for a patient.

17. The apparatus of claim 16 wherein
the treatment plan pad includes information regarding one or more dental pathologies or one or more dental abnormalities.

18. The apparatus of claim 1 wherein
the computer program allows an individual to enter an image using the interactive device into the computer memory,
and wherein the computer program allows the individual to link the image in the computer memory with a case note in the computer memory for a particular dental patient.

19. The apparatus of claim 1 wherein
the computer program causes the monitor to display a field which allows an individual to display images of a plurality of teeth of a dental patient which are only a portion of a dental patient's teeth;
and wherein each of the plurality of teeth of the portion of the dental patient's teeth have periodontal pocket depths at a selected depth or greater.
